(19) United States
(12) Patent Application Publication
(10) Pub. No.: US 2008/0143928 A1
(43) Pub. Date: Jun. 19, 2008

(54) Polarizing Plate and Liquid Crystal Display Device

(75) Inventor: Nobutaka Fukagawa, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/883,544

(22) PCT Filed: Jan. 25, 2006
(86) PCT No.: PCT/JP2006/301594

§ 371 Date: Aug. 2, 2007

(30) Foreign Application Priority Data
Feb. 3, 2005 (JP) 2005-027619

(51) Int. Cl. G02F 1/1335

(52) U.S. Cl. 349/96

(57) ABSTRACT

The present invention relates to a polarizing plate and a liquid crystal display device. A polarizing plate comprising a first protective film, a polarizer, and a second protective film laminated in that order, an average of the modulus of elasticity in transport and width directions of the first protective film and an average of the modulus of elasticity in transport and width directions of the second protective film satisfying the relationship (A) below, |E1 (10% RH)/E1 (80% RH)−E2 (10% RH)/E2 (80% RH)|=0.1 (A) wherein E1 (a % RH) denotes an average modulus of elasticity at a relative humidity a % RH of an (i)th protective film.

### TECHNICAL FIELD

The present invention relates to a polarizing plate and a liquid crystal display device.

### BACKGROUND ART

The application of liquid crystal display devices as space-saving image display devices having low power consumption has been widening year by year. It has conventionally been a defect of liquid crystal display devices that the image has high viewing angle dependence, but in recent years high viewing angle liquid crystal modes such as VA mode and IPS mode have been in practical use, and this has resulted in a rapid increase in the demand for liquid crystal display devices, even in the television, etc. market where high quality images are required.

Accompanying this, with regard to an optical compensation member, which is used in a liquid crystal display device in order to modify the color, contrast, and viewing angle dependence thereof, there is a desire for further improvement in optical compensation performance and durability.

A polarizing plate for use in a liquid crystal display device is generally produced by laminating, to both sides of a polarizer formed by stretching an iodine-stained polyvinyl alcohol-based film, a protective film formed by subjecting a cellulose acylate film to a saponification treatment so as to impart hydrophilicity to the surface thereof.

Cellulose acylate film has been widely used because it has a relatively high moisture permeability and it is easy to guarantee intimacy of contact with polyvinyl alcohol by means of the saponification treatment, but it has the problems that, since the water absorption is relatively high, the humidity dependence of retardation is high, and when used at high temperature and high humidity for a long period of time, unevenness tends to occur on a screen.

As a countermeasure therefor, a method has been disclosed in which a cycloolefin-based polymer film having a low water content and a low photoelasticity coefficient is used as a polarizing plate protective film.

However, since the cycloolefin-based polymer film has a low moisture permeability, when a polarizer is produced by a wet process, evaporation of moisture in a drying step subsequent to lamination of a protective film to both sides becomes insufficient, and there is the problem that the polarization performance is degraded.

As a countermeasure therefor, a method has been disclosed in JP-A-2004-309979 (JP-A denotes a Japanese unexamined patent application publication.), etc. in which one side is a cycloolefin-based film and one side uses a cellulose acylate film as a protective film, drying after production of a polarizing plate is carried out sufficiently, and the characteristics of the cycloolefin film are made use of. However, this method has the problem that, since such a polarizing plate has a large amount of curl, it is difficult to affix it to a liquid crystal cell, and when, after it has been made, a liquid crystal display device is switched on for a long period of time, light leakage due to a decrease in the degree of polarization and peripheral unevenness due to deformation of the polarizing plate easily occur.

### DISCLOSURE OF INVENTION

It is an object of the present invention to provide a liquid crystal display device that has excellent polarizing plate processing suitability and excellent liquid crystal display device production suitability, and can maintain a high quality image even when switched on under conditions of high humidity for a long period of time.

1) A polarizing plate comprising a first protective film, a polarizer, and a second protective film laminated in that order,

an average of the modulus of elasticity in transport and width directions of the first protective film and an average of the modulus of elasticity in transport and width directions of the second protective film satisfying the relationship (A) below;

|E1(10%RH)/E1(80%RH)−E2(10%RH)/E2(80%RH)|≦0.1 (A)

(here, E1 (a % RH) denotes an average modulus of elasticity at a relative humidity a % RH of an (i)th protective film),
2) the polarizing plate according to 1) above, wherein the sum of 60° C./95% RH/24 hr moisture permeabilities of the first protective film and the second protective film is at least 600 g/m² but no greater than 1,600 g/m²,
3) the polarizing plate according to either 1) or 2) above, wherein the difference in 60° C./95% RH/24 hr moisture permeabilities between the first protective film and the second protective film is at least 0 g/m² but no greater than 1,000 g/m²,

4) the polarizing plate according to any one of 1) to 3) above, wherein at least one of the protective films is a cellulose acylate film,

5) the polarizing plate according to any one of 1) to 4) above, wherein at least one of the protective films is a cycloolefin-based polymer film,
6) the polarizing plate according to any one of 1) to 5) above, wherein an F type curl value at 25° C. and 60% RH is at least −1.0 but no greater than 1.0, and the difference between an F type curl value at 25° C. and 10% RH and an F type curl value at 25° C. and 80% RH is 2.0 or less,
7) a liquid crystal display device comprising a liquid crystal cell and two polarizing plates disposed on either side of the liquid crystal cell, at least one polarizing plate being the polarizing plate according to any one of 1) to 6) above,
8) the liquid crystal display device according to 7) above, wherein a protective film on the liquid crystal cell side relative to a polarizer is a cycloolefin-based polymer film, and a protective film on the side opposite to the liquid crystal cell relative to the polarizer is a cellulose acylate film.

In accordance with the present invention, a polarizing plate having a small amount of curl regardless of the humidity of the application environment can be obtained and, furthermore, a liquid crystal display device that has excellent polarizing plate processing suitability, excellent liquid crystal display device production suitability, and a high quality image having excellent durability can be obtained.

### BRIEF DESCRIPTION OF DRAWINGS

FIG. 1 is one example of the configuration in which the polarizing plate of the present invention and a functional optical film are combined.

FIG. 2 is one example of a liquid crystal display device employing the polarizing plate of the present invention.

FIG. 3 is another example of a liquid crystal display device employing the polarizing plate of the present invention.

### BEST MODE FOR CARRYING OUT THE INVENTION

As a result of an intensive investigation by the present inventors, it has been found that curl in a polarizing plate comprising a cycloolefin-based polymer film on one side and a cellulose acylate film on the other side is caused by a difference in deformation between the front and back protective films accompanying shrinkage of stretched polyvinyl alcohol.

That is, whereas the modulus of elasticity of the cycloolefin-based polymer film is constant and has little humidity dependence, with regard to the cellulose acylate film, the lower the humidity, the smaller the modulus of elasticity; the balance of the modulus of elasticity between the front and back sides is therefore disturbed depending on the humidity of the environment, and the amount of curl of the polarizing plate shape increases.

With respect to this point, the present inventors have found that a balance in the humidity dependence of the modulus of elasticity between the front and back protective films can be obtained by a method involving imparting an appropriate degree of hydrophilicity to a monomer unit forming the cycloolefin-based polymer and/or a method involving adding a hydrophobicizing agent to the cellulose acylate film so as to increase the crystallinity, and the present invention below has thus been accomplished.

A polarizing plate comprising a first protective film, a polarizer, and a second protective film laminated in that order, an average of the modulus of elasticity in transport and width directions of the first protective film and an average of the modulus of elasticity in transport and width directions of the second protective film satisfying the relationship (A) below.

|E1(10%RH)/E1(80%RH)−E2(10%RH)/E2(80%RH)|≦0.1 (A)

(Here, Ei (a % RH) denotes an average modulus of elasticity at a relative humidity a % RH of an (i)th protective film.)

A polarizing plate protective film and a polarizer, which form the polarizing plate of the present invention, are explained below.

### <Film Physical Properties>

The film physical properties of a polarizing plate protective film that can be used in the present invention are now explained.

### (Modulus of Elasticity of Film)

With regard to two polarizing plate protective films that can be used in the present invention, an average of the modulus of elasticity in transport and width directions of a first protective film and an average of the modulus of elasticity in transport and width directions of a second protective film satisfy the relationship (A) below.

|E1(10%RH)/E1(80%RH)−E2(10%RH)/E2(80%RH)|≦0.1 (A)

The average of the modulus of elasticity in the transport and width directions of a film referred to here is the average of a value of the modulus of elasticity in the transport direction and a value of the modulus of elasticity in the width direction when producing the film.

The relationship (A) is preferably |E1 (10% RH)/E1 (80% RH)−E2 (10% RH)/E2 (80% RH)|<0.07, and more preferably |E1 (10% RH)/E1 (80% RH)−E2 (10% RH)/E2 (80% RH)|<0.04. By satisfying this relationship, the amount of curl of the polarizing plate can be made small regardless of the humidity of the application environment.

### (Moisture Permeability)

The moisture permeability of each sample is measured by a method in accordance with JIS Z 0208, and is determined as an amount of water (g) that evaporates per m² over 24 hours. The moisture permeability of the polarizing plate protective film is a film physical property that is closely related to the durability of the polarizing plate. It is known that, with regard to a polarizer formed by staining polyvinyl alcohol with iodine, degradation of the polarization performance thereof due to decoloration of iodine is accelerated by moisture. A higher moisture permeability is preferable for the removal of moisture by drying during production of a polarizing plate, whereas a lower moisture permeability is preferable during production of a polarizing plate since permeation of moisture from the outside is suppressed.

Therefore, in order to satisfy these mutually contradictory requirements, it is necessary for the polarizing plate protective film to have an appropriate moisture permeability. The sum of the 60° C./90% RH/24 hr moisture permeabilities of the first protective film and the second protective film that can be used in the present invention is preferably at least 600 g/m² but no greater than 1,600 g/m², and more preferably at least 700 g/m² but not greater than 1,300 g/m².

The difference in 60° C./90% RH/24 hr moisture permeability between the first protective film and the second protective film that can be used in the present invention is preferably at least 0 g/m² but no greater than 1,000 g/m², and more preferably at least 0 g/m² but no greater than 700 g/m². The ‘difference’ referred to here is obtained by subtracting, among the moisture permeability values, the smaller one from the larger one.

By the use of two polarizing plate protective films that satisfy the above-mentioned range for moisture permeability, a polarizing plate having a small amount of curl and excellent durability can be obtained.

### (Equilibrium Water Content)

The water content of a film can be evaluated by measuring an equilibrium water content at a predetermined temperature and humidity. The equilibrium water content is determined by measuring, using the Karl-Fisher method, an amount of water of a sample that has reached equilibrium after being allowed to stand at the above-mentioned predetermined temperature and humidity for 24 hours, and dividing the amount of water (g) by the weight of the sample (g).

The equilibrium water content at 25° C. and 80% RH of at least one polarizing plate protective film that can be used for the polarizing plate of the present invention is preferably at least 0.5 wt % but no greater than 3.0 wt %, and more preferably at least 1.0 wt % but no greater than 2.5 wt %. Furthermore, the equilibrium water content of the other polarizing plate protective film that can be used for the polarizing plate of the present invention is preferably at least 0.01 wt % but no greater than 2 wt %, and more preferably at least 0.1 wt % but no greater than 1 wt %.

### (Retardation)

The polarizing plate protective film that can be used in the present invention can also be used preferably as a retardation film that can correspond to various liquid crystal modes.

When the polarizing plate protective film that can be used in the present invention is used as the retardation film, preferred optical properties of the cellulose acylate film depend on the liquid crystal mode.

For OCB mode the Re is preferably 10 to 100 nm, and more preferably 20 to 70 nm. The Rth is preferably 50 to 300 nm, and more preferably 100 to 250 nm.

For VA mode the Re is preferably 20 to 150 nm, and more preferably 30 to 100 nm. The Rth is preferably 50 to 300 nm, and more preferably 120 to 250 nm.

Furthermore, for TN mode the Re is preferably 0 to 50 nm, and more preferably 2 to 30 nm. The Rth is preferably 10 to 200 nm, and more preferably 30 to 150 nm.

For the OCB mode and the TN mode, a polarizing plate protective film having the above-mentioned retardation value can be coated with an optically anisotropic layer and used as an optical compensation film.

In the present description, Re and Rth denote the in-plane retardation and retardation in the thickness direction respectively. Re is measured by shining light at a wavelength of 590 nm in a direction normal to the film using a KOBRA 21ADH (manufactured by Oji Scientific Instruments). Rth is calculated by the KOBRA 21ADH based on three retardation values, that is, the Re, a retardation value measured by shining light at a wavelength of 590 nm in a direction inclined at +40° relative to the normal to the film using an in-plane phase retardation, axis (determined by the KOBRA 21ADH) as the inclination axis (rotational axis), and a retardation value measured by shining light at a wavelength of 590 nm in a direction inclined at −40° relative to the normal to the film using the in-plane phase retardation axis as the inclination axis (rotational axis). Assumed average refractive index values can be obtained by referring to the Polymer Handbook (JOHN WILEY & SONS, INC) or various catalogues of optical films. When the average refractive index of a material is unknown, it can be measured using an Abbe refractometer. The average refractive indices of the main optical films are listed below: cellulose acylate (1.48), cycloolefin polymer (1.52), polycarbonate (1.59), polymethyl methacrylate (1.49), and polystyrene (1.59). By inputting the assumed average refractive index value and the film thickness, the KOBRA 21ADH calculates nx, ny, and nz.

### (Photoelasticity)

The photoelasticity coefficient of the polarizing plate protective film that can be used in the present invention is preferably 60×10⁻⁸ cm²/N or less, and more preferably 20×10⁻⁸ cm²/N or less. Furthermore, when the photoelasticity coefficients of the two protective films are different from each other, the photoelasticity coefficient of a protective film that is used on the liquid crystal cell side (hereinafter, also called a cell side protective film) is preferably smaller than the photoelasticity coefficient of a protective film on the air side (that is, a protective film on the side opposite to the liquid crystal cell relative to the polarizer. Hereinafter, also called an air interface side protective film). The photoelasticity coefficient can be obtained using an ellipsometer.

### <Polymer Material>

The protective film used in the present invention is preferably a polymer film produced from a cycloolefin-based polymer such as norbornene; polyethylene terephthalate; polyethylene naphthalate; polycarbonate; polystyrene; polyarylate; polysulfone; cellulose acylate, etc., and it is particularly preferable that one side is a cellulose acylate-based film and the other side is a cycloolefin-based polymer film.

### (Cellulose Acylate Film)<

### Cellulose Acylate>

The cellulose acylate that can be used in the present invention is now explained.

The degree of substitution of the cellulose acylate means the proportion of acylated hydroxyl groups among the three hydroxyl groups present in a cellulose-forming unit (β1→4 glycoside bonded glucose). The degree of substitution can be obtained by measuring an amount of fatty acid bonded per unit weight of cellulose-forming unit. A measurement method is carried out in accordance with ASTM-D817-91.

It is preferable that the cellulose acylate that can be used in the present invention has a degree of acetylation of at least 2.7 but no greater than 3.0 and does not have an acyl group having 3 or more carbons. The degree of acetylation is more preferably at least 2.75 but no greater than 2.95.

Moreover, another preferred cellulose acylate that can be used in the present invention has a degree of acylation of at least 1 but no greater than 2.9, more preferably at least 1.7 but no greater than 2.7, and most preferably at least 2.0 but no greater than 2.5. Furthermore, the average number of carbons of the acyl group is preferably at least 2 but no greater than 7, more preferably at least 2.05 but no greater than 5, and most preferably at least 2.6 but no greater than 4.

Furthermore, the number of carbon atoms of the acyl group is preferably 2 to 6, and it is more preferable to use an acetyl group, a propionyl group, or a butyryl group. Furthermore, when the cellulose acylate film that can be used in the present invention has an acetyl group and an acyl group other than the acetyl group, the degree of substitution with the acetyl group is preferably less than 2.5, more preferably less than 1.9, and most preferably less than 1.1.

The cellulose acylate that can be used in the present invention preferably has a degree of polymerization of 250 to 800, and more preferably a degree of polymerization of 280 to 600. The cellulose acylate that can be used in the present invention preferably has a number-average molecular weight of 70,000 to 230,000, more preferably a number-average molecular weight of 75,000 to 230,000, and most preferably a number-average molecular weight of 78,000 to 120,000.

The cellulose acylate that can be used in the present invention can be synthesized using an acid anhydride or an acid chloride as an acylating agent. When the acylating agent is an acid anhydride, as a reaction solvent an organic acid (for example, acetic acid) or methylene chloride is used. A protic catalyst such as sulfuric acid is used as a catalyst. When the acylating agent is an acid chloride, a basic compound is used as a catalyst. In an industrially most common synthetic method, cellulose is subjected to esterification by a mixed organic acid component containing an organic acid (acetic acid, propionic acid, butyric acid) corresponding to an acetyl group and another acyl group, or containing an acid anhydride thereof (acetic anhydride, propionic anhydride, butyric anhydride), to give a cellulose ester. In this method, cellulose such as cotton linter or woodpulp is often activated with an organic acid such as acetic acid and then subjected to esterification using a mixed liquid of the above-mentioned organic acid component in the presence of a sulfuric acid catalyst. The organic acid anhydride component is generally used in an excess amount relative to the amount of hydroxyl groups present in the cellulose. In this esterification, in addition to an esterification reaction, a hydrolysis reaction (depolymerization reaction) of the cellulose main chain (β1→4 glycoside bond) proceeds. When the hydrolysis reaction of the main chain proceeds, the degree of polymerization of the cellulose ester decreases, and the physical properties of the cellulose ester film so produced are degraded. Because of this, it is necessary to determine reaction conditions such as reaction temperature while taking into consideration the degree of polymerization and the molecular weight of the cellulose ester that is to be obtained.

In order to obtain a cellulose ester having a high degree of polymerization (high molecular weight), it is important to adjust the maximum temperature of the esterification reaction step to 50° C. or less. The maximum temperature is preferably adjusted to 35° C. to 50° C., and more preferably 37° C. to 47° C. When the reaction temperature is in the above-mentioned range, the esterification reaction proceeds smoothly, and the degree of polymerization of the cellulose ester does not decrease. After the esterification reaction, by stopping the reaction while suppressing any increase in temperature, it is possible to further suppress a decrease in the degree of polymerization, and a cellulose ester having a high degree of polymerization can be synthesized. That is, by adding a reaction terminator (for example, water and acetic acid) after completion of the reaction, excess acid anhydride that is not involved in the esterification reaction is hydrolyzed to give the corresponding organic acid as a by-product. Since this hydrolysis reaction is highly exothermic, the temperature within a reactor increases. If the rate of addition of the reaction terminator is high, heat that is beyond the cooling ability of the reactor is generated rapidly. Because of this, a hydrolysis reaction of the cellulose main chain proceeds rapidly, and the degree of polymerization of cellulose ester obtained decreases. Moreover, during the esterification reaction part of the catalyst is bonded to the cellulose, and a majority thereof dissociates from the cellulose during addition of the reaction terminator. However, if the rate of addition of the reaction terminator is high, there is not enough time for the catalyst to dissociate, and part of the catalyst remains bonded to the cellulose. A cellulose ester to which a strong acid catalyst is partly bonded has very poor stability, and it might easily be decomposed by heat during drying of the product, etc., thus lowering the degree of polymerization. For these reasons, it is preferable after the esterification reaction to add the reaction terminator over 4 minutes or more, and more preferably 4 to 30 minutes, to thus terminate the reaction. When the time of addition of the reaction terminator is within the above-mentioned range, the industrial productivity does not deteriorate. As the reaction terminator, water or an alcohol, which decomposes an acid anhydride, is generally used. In the present invention, in order to prevent a triester having low solubility in various types of organic solvent from precipitating, a mixture of water and an organic acid is preferably used as the reaction terminator. By carrying out an esterification reaction under the above-mentioned conditions, a high molecular weight cellulose ester having a weight-average degree of polymerization of 500 or greater can easily be synthesized.

### <Hydrophobicizing Agent>

A hydrophobicizing agent that can be used in the present invention is now explained.

As the hydrophobicizing agent that can be used in the present invention, a known agent may be used, and it is preferable to use an agent having both a functional group that has high affinity for a hydroxyl group and a highly hydrophobic partial structure in the molecule.

As the functional group that has high affinity for a hydroxyl group, a substituted or unsubstituted amino group, an acylamino group, an alkoxycarbonylamino group, an aryloxycarbonylamino group, a sulfonylamino group, a hydroxyl group, a mercapto group, or a carboxyl group is preferable, and an amino group or a hydroxyl group is more preferable.

The highly hydrophobic partial structure preferably has a functional group such as an alkyl group (preferably having 1 to 20 carbons, more preferably 1 to 12 carbons, and particularly preferably 1 to 8 carbons, examples thereof including methyl, ethyl, iso-propyl, tert-butyl, n-octyl, n-decyl, n-hexadecyl, cyclopropyl, cyclopentyl, and cyclohexyl), an alkenyl group (preferably having 2 to 20 carbons, more preferably 2 to 12 carbons, and particularly preferably 2 to 8 carbons, examples thereof including vinyl, allyl, 2-butenyl, and 3-pentenyl), an alkynyl group (preferably having 2 to 20 carbons, more preferably 2 to 12 carbons, and particularly preferably 2 to 8 carbons, examples thereof including propargyl and 3-pentynyl), or an aryl group (preferably having 6 to 30 carbons, more preferably 6 to 20 carbons, and particularly preferably 6 to 12 carbons, examples thereof including phenyl, p-methylphenyl, and naphthyl).

With regard to the hydrophobicizing agent that can be used in the present invention, compounds represented by Formulae (1) to (V) below are particularly preferable.

The compounds represented by Formulae (1) to (V) are each explained in detail below.

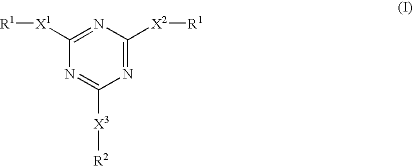

In Formula (1), R¹ denotes an aromatic ring or a hetero ring having a substituent at the ortho position and/or the meta position, and R² denotes an aromatic ring or a hetero ring having a subsistent, but when R¹ denotes an aromatic ring having a substituent at the ortho position and/or the meta position and R² denotes an aromatic ring having a substituent, the two are not identical. X¹ denotes a single bond or —NR³—, X² denotes a single bond or —NR⁴—, and X³ denotes a single bond or —NR⁵—. R³, R⁴, and R⁵ independently denote a hydrogen atom, or a substituted or unsubstituted alkyl group, alkenyl group, aryl group, or heterocyclic group.

To explain in more detail, R¹ denotes an aromatic ring or a hetero ring having a substituent at the ortho position and/or the meta position, and R² denotes an aromatic ring or a hetero ring having a substituent. The aromatic ring denoted by each of R¹ and R² is preferably phenyl or naphthyl, and particularly preferably phenyl. The aromatic ring denoted by R¹ has at least a substituent at the ortho position and/or the meta position and may have a substituent at other positions. The aromatic ring denoted by R² has at least one substituent at any substitution position. Examples of the substituent include a halogen atom, hydroxyl, cyano, nitro, carboxyl, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamide group, carbamoyl, an alkyl-substituted carbamoyl group, an alkenyl-substituted carbamoyl group, an aryl-substituted carbamoyl group, an amide group, an alkylthio group, an alkenylthio group, an arylthio group, and an acyl group.

When R¹ denotes an aromatic ring having a substituent at the ortho position and/or the meta position and R² denotes an aromatic ring having a substituent, the two are not identical. ‘Not identical’ means that the two, including their substituents, are not identical and, for example, a case in which they have an identical aromatic ring but different substituents, and a case in which, furthermore, their substituents are identical but the substitution positions are different, are included in ‘not identical’.

The heterocyclic group denoted by each of R¹ and R² preferably has aromaticity. A hetero ring having aromaticity is generally an unsaturated hetero ring, and preferably a hetero ring having the maximum number of double bonds. The hetero ring is preferably a 5-membered ring, a 6-membered ring, or a 7-membered ring, more preferably a 5-membered ring or a 6-membered ring, and most preferably a 6-membered ring. A hetero atom of the hetero ring is preferably a nitrogen atom, a sulfur atom, or an oxygen atom, and particularly preferably a nitrogen atom. The hetero ring having aromaticity is particularly preferably a pyridine ring (as a heterocyclic group, 2-pyridyl or 4-pyridyl). The heterocyclic group may have a substituent. Examples of the substituent on the heterocyclic group are the same as the above-mentioned examples of the substituent on the aryl portion.

The heterocyclic group when X¹, X², and X³ are each a single bond is preferably a heterocyclic group having a free valence on a nitrogen atom. The heterocyclic group having a free valence on the nitrogen atom is preferably a 5-membered ring, a 6-membered ring, or a 7-membered ring, more preferably a 5-membered ring or a 6-membered ring, and most preferably a 5-membered ring. The heterocyclic group may have a plurality of nitrogen atoms. Furthermore, the heterocyclic group may have a hetero atom (for example, O, S) other than a nitrogen atom. Examples of the heterocyclic group having a free valence on the nitrogen atom are illustrated below.

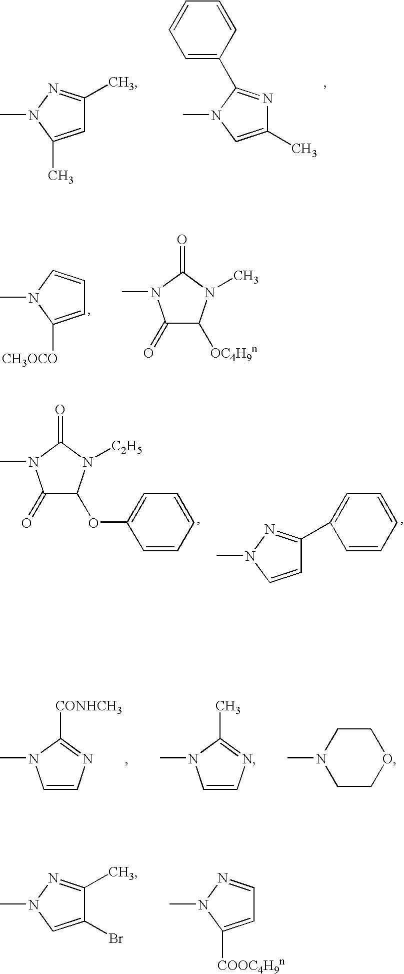

In Formula (1), X¹ denotes a single bond or —NR³—, X² denotes a single bond or —NR⁴—, and X³ denotes a single bond or —NR⁵—. R³, R⁴, and R⁵ independently denote a hydrogen atom, or a substituted or unsubstituted alkyl group, alkenyl group, aryl group, or heterocyclic group. The alkyl group denoted by each of R³, R⁴, and R⁵ may be a cyclic alkyl group or an open-chain alkyl group, and is preferably an open-chain alkyl group, a straight open-chain alkyl group being preferred to a branched open-chain alkyl group. The number of carbon atoms in the alkyl group is preferably 1 to 30, more preferably 1 to 20, yet more preferably 1 to 10, even more preferably 1 to 8, and most preferably 1 to 6. The alkyl group may have a substituent. Examples of the substituent include a halogen atom, an alkoxy group (for example, methoxy, ethoxy), and an acyloxy group (for example, acryloyloxy, methacryloyloxy).

The alkenyl group denoted by each of R³, R⁴, and R⁵ may be a cyclic alkenyl group or an open-chain alkenyl group, and is preferably an open-chain alkenyl group, a straight open-chain alkenyl group being preferred to a branched open-chain alkenyl group. The number of carbon atoms in the alkenyl group is preferably 2 to 30, more preferably 2 to 20, yet more preferably 2 to 10, yet more preferably 2 to 8, and most preferably 2 to 6. The alkenyl group may have a substituent. Examples of the substituent are the same as those on the alkyl group above.

The aromatic ring group and the heterocyclic group denoted by each of R³, R⁴, and R⁵ are the same as the aromatic ring and hetero ring denoted by each of R¹ and R², and their preferred ranges are also the same. The aromatic ring group and the heterocyclic group may further have a substituent, and examples of the substituent are the same as those on the aromatic ring and the hetero ring of R¹ and R².

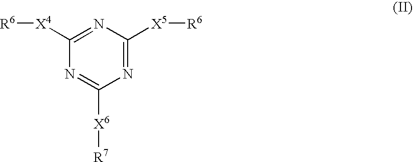

A compound of Formula (II) above is now explained in detail. In the formula, R⁶ denotes an aromatic ring or a hetero ring having a substituent at the para-position, and R⁷ denotes an aromatic ring or a hetero ring having a substituent, provided that when R⁶ denotes an aromatic ring having a substituent at the para position and R⁷ denotes aromatic ring having a substituent, the two are not identical. X⁴ denotes a single bond or —NR¹³—, X⁵ denotes a single bond or —NR¹⁴—, and X⁶ denotes a single bond or —NR¹⁵—. R¹³, R¹⁴, and R¹⁵ independently denote a hydrogen atom, or a substituted or unsubstituted alkyl group, alkenyl group, aryl group, or heterocyclic group.

The aromatic ring and the hetero ring denoted by each of R⁶ and R⁷ are the same as the aromatic ring and the hetero ring denoted by each of R¹ and R² in Formula (1) above, and their preferred ranges are also the same. Examples of the substituent thereon are also the same as those cited as examples for the substituent on the aromatic ring and the hetero ring denoted by each of R¹ and R². The aromatic ring denoted by R⁶ at least has a substituent at the para-position and may have a substituent at another position. R⁷ has at least one substituent at any position, provided that when R⁶ denotes an aromatic ring having a substituent at the para position and R⁷ denotes an aromatic ring having a substituent, the two are not identical. ‘Not identical’ means that the two, including their substituents, are not identical and, for example, a case in which they have an identical aromatic ring but different substituents, and a case in which, furthermore, their substituents are identical but the substitution positions are different, are included in ‘not identical’.

X⁴ denotes a single bond or —NR¹³—, X⁵ denotes a single bond or —NR¹⁴ and X⁶ denotes a single bond or —NR¹⁵—. R¹³, R¹⁴, and R¹⁵ independently denote a hydrogen atom, or a substituted or unsubstituted alkyl group, alkenyl group, aryl group, or heterocyclic group. The substituted or unsubstituted alkyl group, alkenyl group, aryl group, or heterocyclic group denoted by each of R¹³, R¹⁴, and R¹⁵ is the same as the group denoted by each of R³, R⁴, and R⁵ in Formula (1) above, and the preferred range is also the same.

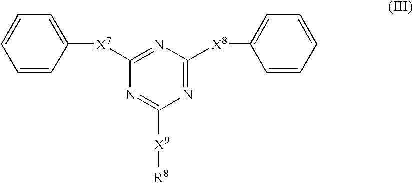

A compound of Formula (III) above is now explained in detail. In the formula, R⁸ denotes an aromatic ring or a hetero ring having a substituent at the ortho position and/or the meta position. X⁷ denotes a single bond or —NR²³—, X⁸ denotes a single bond or —NR²⁴—, and X⁹ denotes a single bond or —NR²⁵—. R²³, R²⁴, and R²⁵ independently denote a hydrogen atom, or a substituted or unsubstituted alkyl group, alkenyl group, aryl group, or heterocyclic group.

The aromatic ring and the hetero ring denoted by R⁸ are the same as the aromatic ring and the hetero ring denoted by each of R¹ and R² in Formula (1) above, and their preferred ranges are also the same. Examples of the substituent thereon are also the same as those cited as examples for the substituent on the aromatic ring and the hetero ring denoted by each of R¹ and R². The aromatic ring denoted by R⁸ has at least a substituent at the ortho position and/or the meta position, and may have a substituent at another position.

X⁷ denotes a single bond or —NR²³—, X⁸ denotes a single bond or —NR²⁴—, and X⁹ denotes a single bond or —NR²⁵—. R²³, R²⁴, and R²⁵ independently denote a hydrogen atom, or a substituted or unsubstituted alkyl group, alkenyl group, aryl group, or heterocyclic group. The substituted or unsubstituted alkyl group, alkenyl group, aryl group, or heterocyclic group denoted by each of R²³, R²⁴, and R²⁵ is the same as the group denoted by each of R³, R⁴, and R⁵ in Formula (1) above, and the preferred range is also the same.

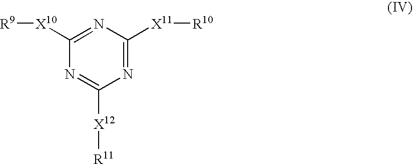

A compound of Formula (IV) above is now explained in detail.

In the formula, R⁹, R¹⁰, and R¹¹ denote different aromatic rings or hetero rings. X¹⁰ denotes a single bond or —NR³³—, X¹¹ denotes a single bond or —NR³⁴—, and X¹² denotes a single bond or —NR³⁵—. R³³, R³⁴, and R³⁵ independently denote a hydrogen atom or a substituted or unsubstituted alkyl group, alkenyl group, aryl group, or heterocyclic group.

The aromatic ring or hetero ring denoted by each of R⁹, R¹⁰, and R¹¹ is the same as the aromatic ring and hetero ring denoted by each of R¹ and R² in Formula (1) above, and the preferred range is also the same. Examples of the substituent thereon are also the same as those cited as examples for the substituent on the aromatic ring and the hetero ring denoted by each of R¹ and R². ‘Different aromatic rings or hetero rings’ means that the aromatic rings and the hetero rings, including their substituents, are not identical and, for example, a case in which they have an identical aromatic ring or hetero ring but different substituents, and a case in which, furthermore, their substituents are identical but the substitution positions are different, are included in ‘different aromatic rings or hetero rings’.

X¹⁰ denotes a single bond or —NR³³—, X¹¹ denotes a single bond or —NR³⁴—, and X¹² denotes a single bond or —NR³⁵—. R³³, R³⁴, and R³⁵ independently denote a hydrogen atom, or a substituted or unsubstituted alkyl group, alkenyl group, aryl group, or heterocyclic group. The substituted or unsubstituted alkyl group, alkenyl group, aryl group, or heterocyclic group denoted by each of R³³, R³⁴, and R³⁵ is the same as the group denoted by each of R³, R⁴, and R⁵ in Formula (1) above, and the preferred range is also the same.

Specific examples of compounds having a 1,3,5-triazine ring that can be used in the present invention are illustrated below.

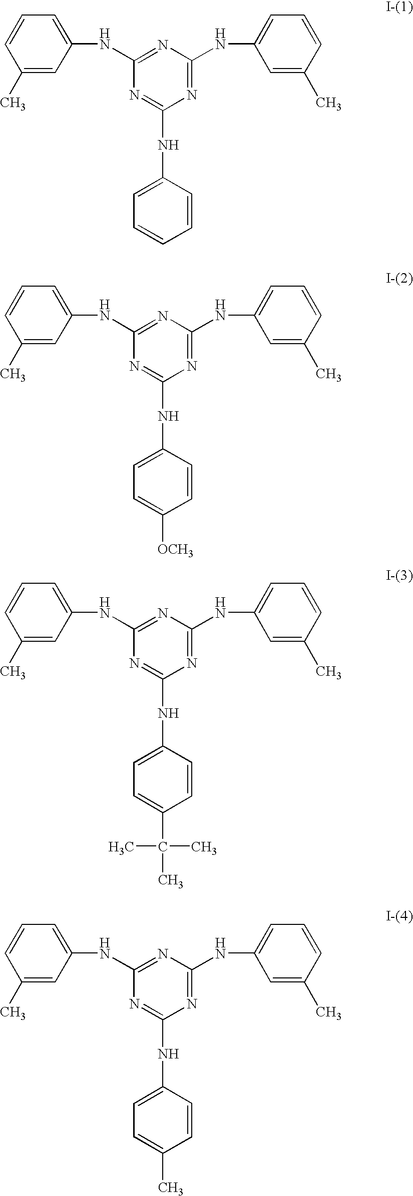

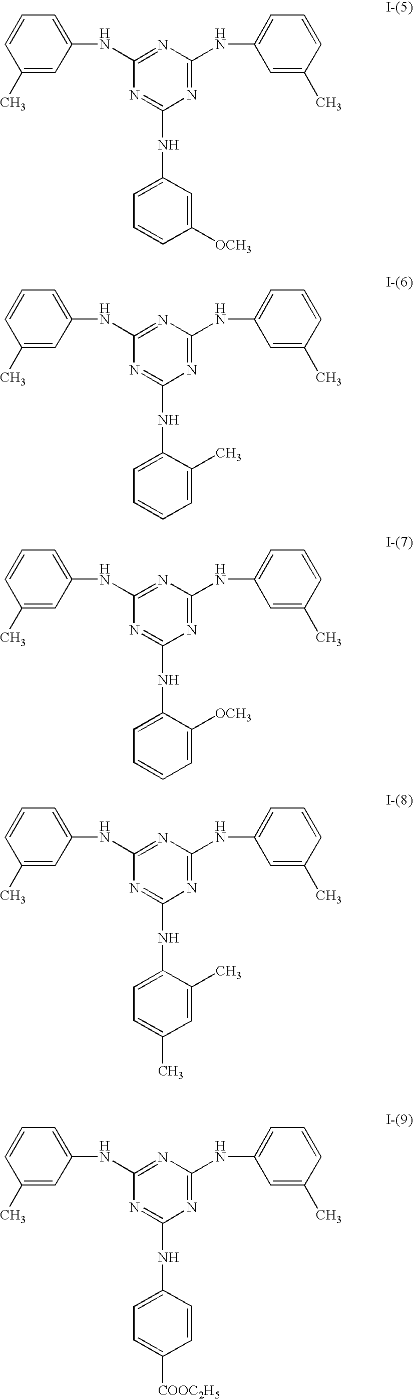

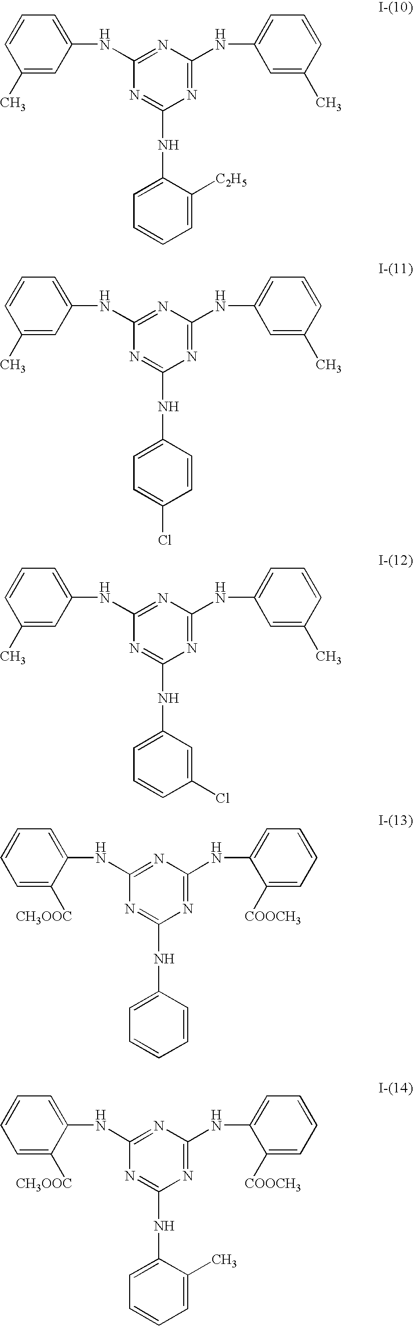

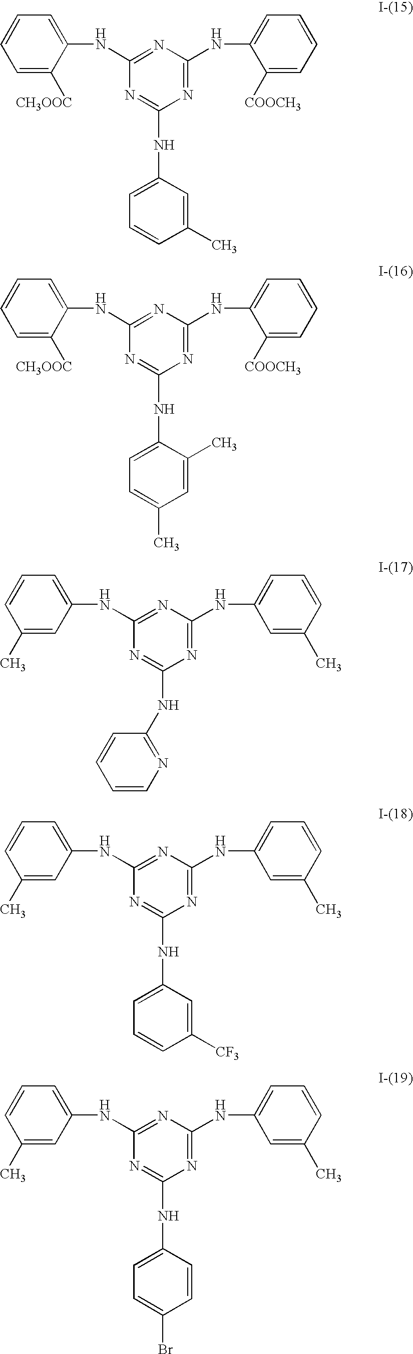

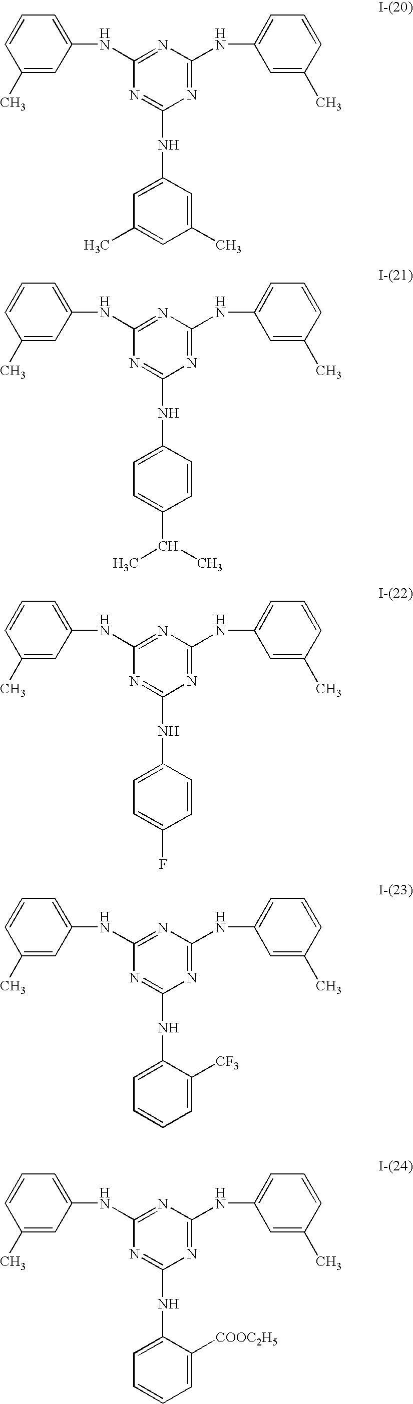

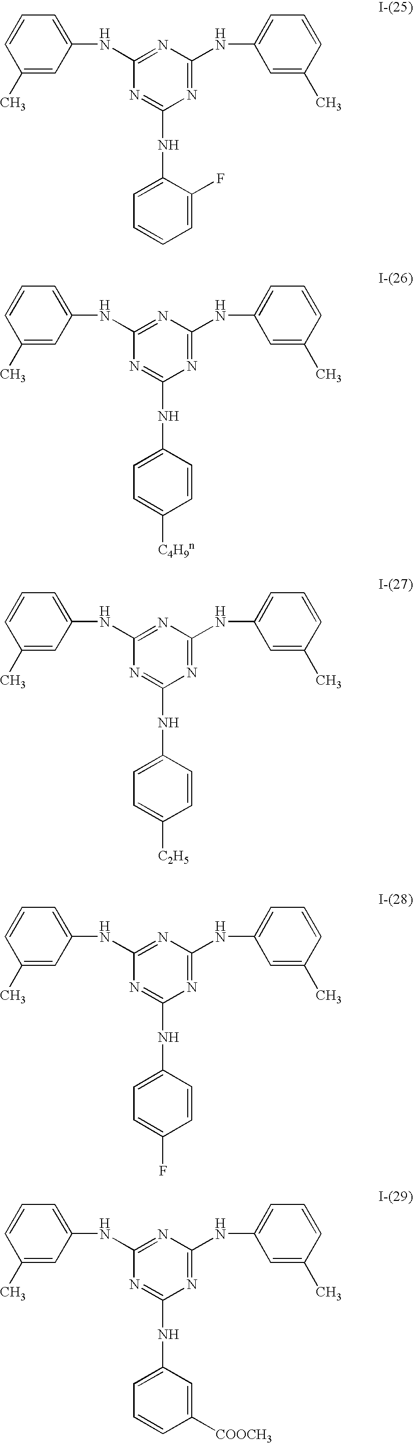

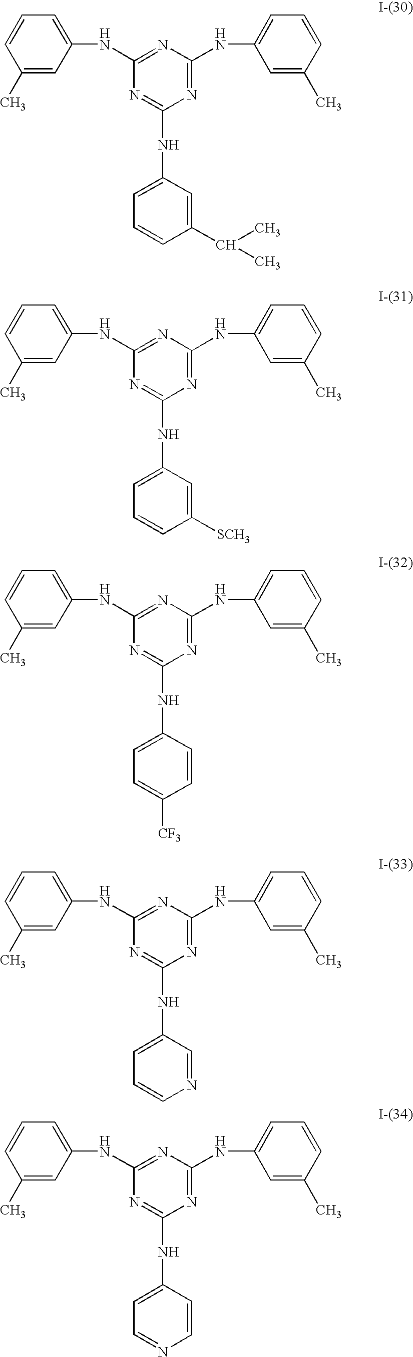

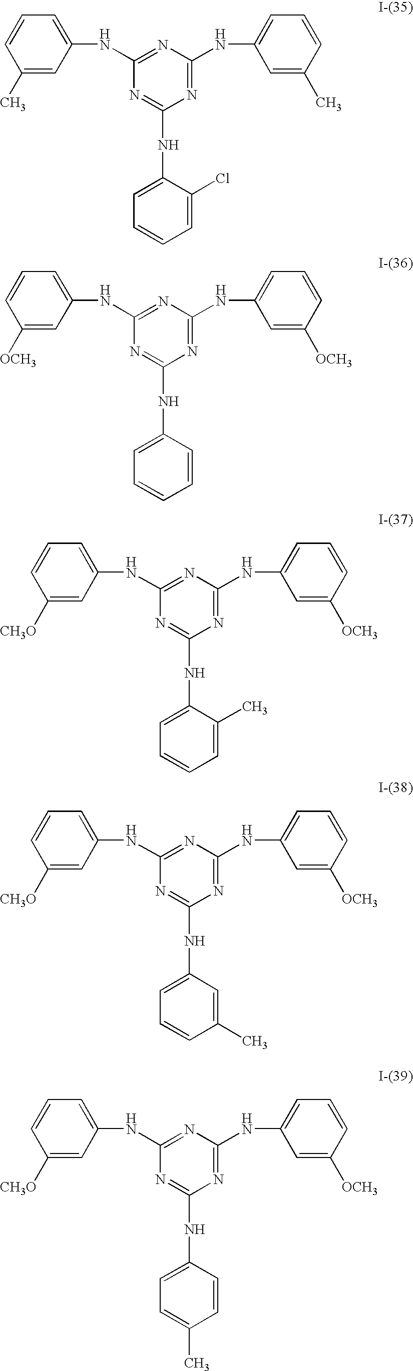

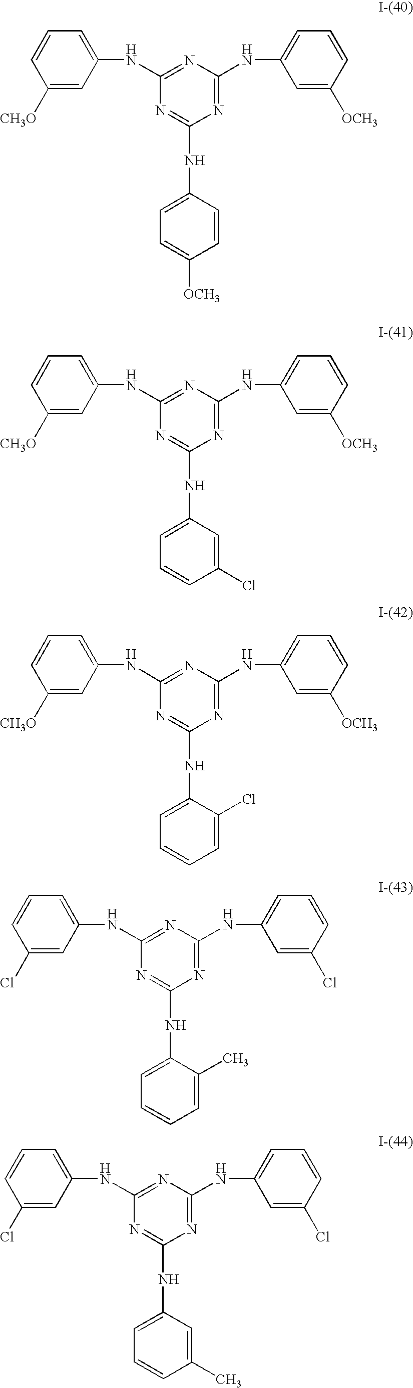

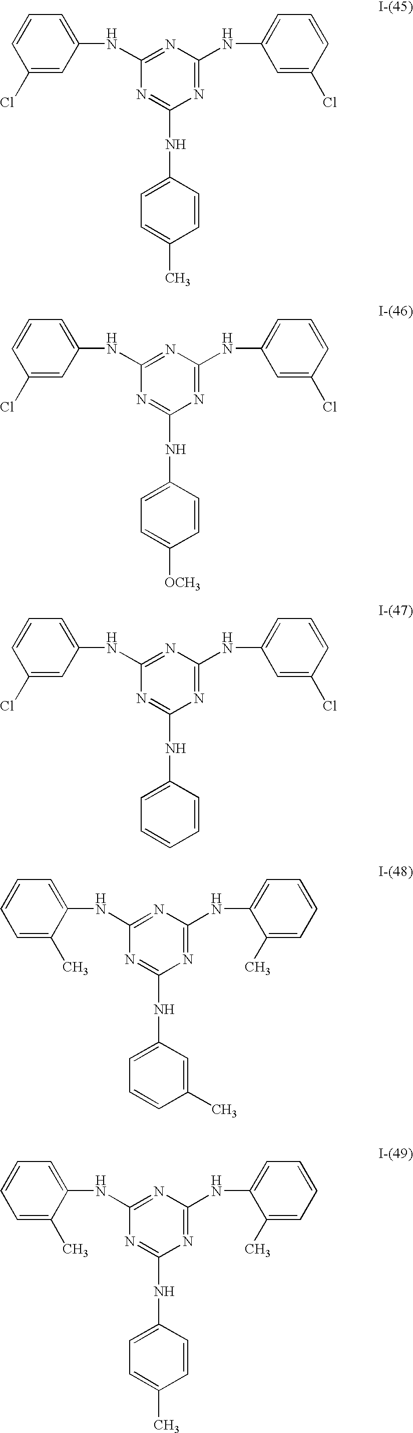

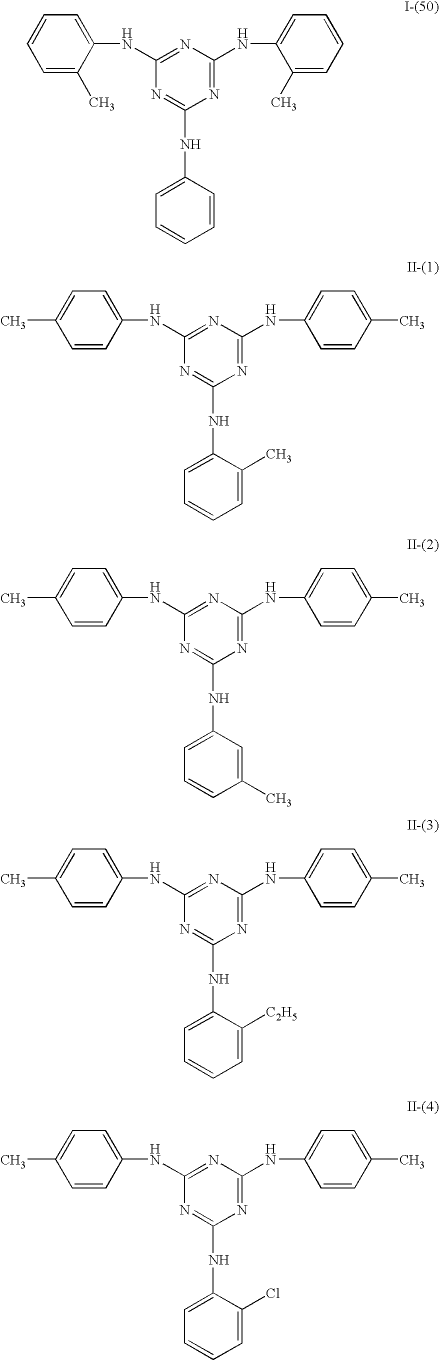

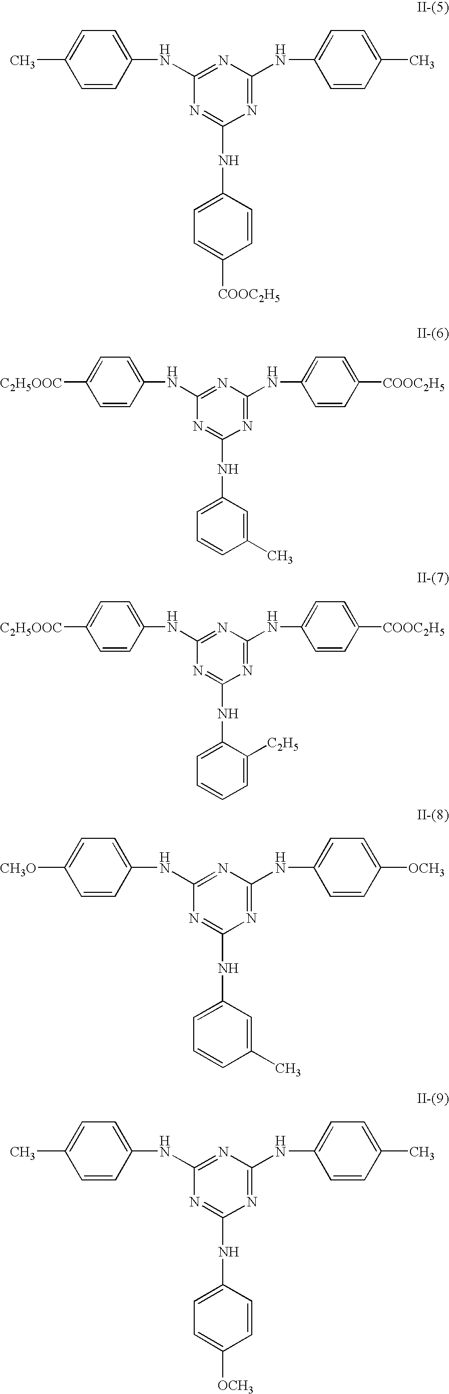

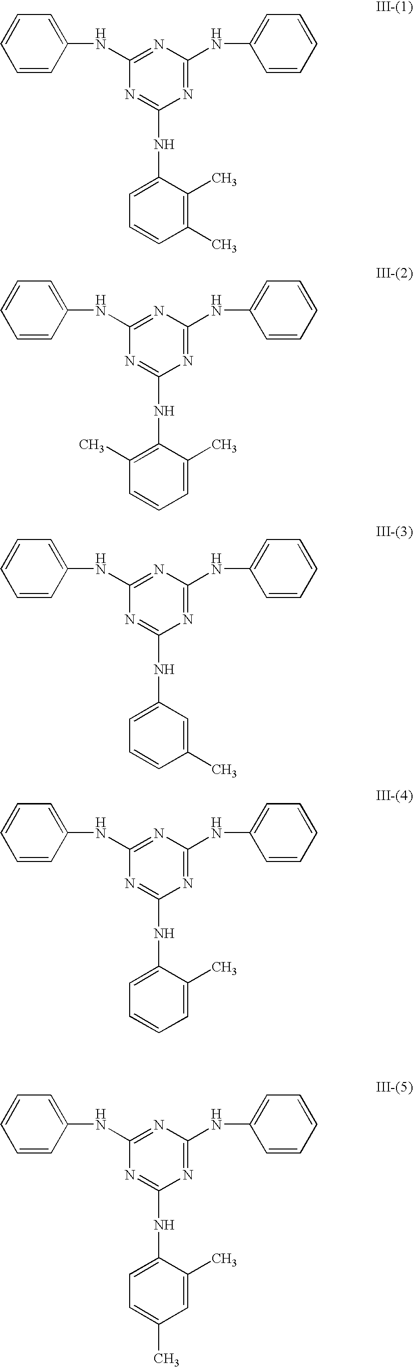

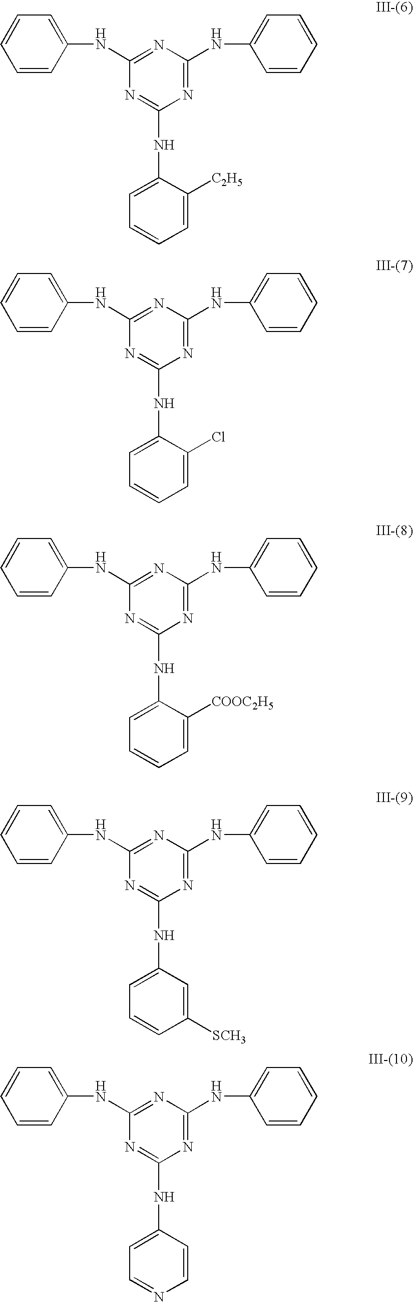

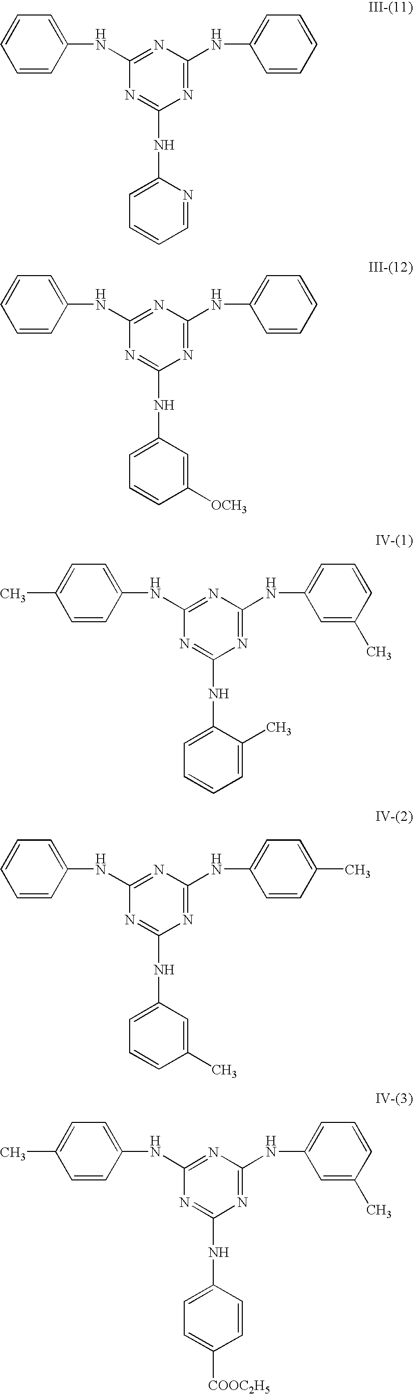

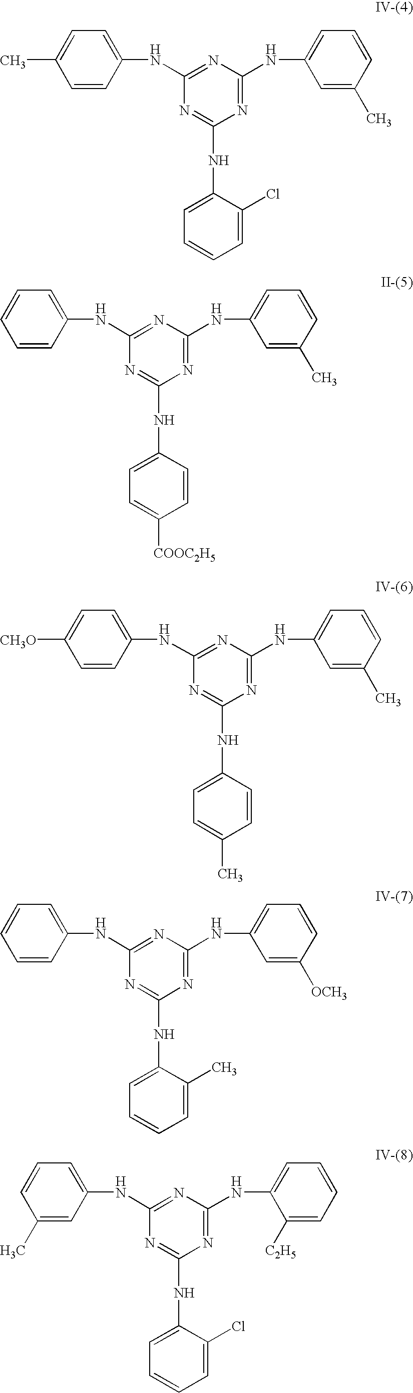

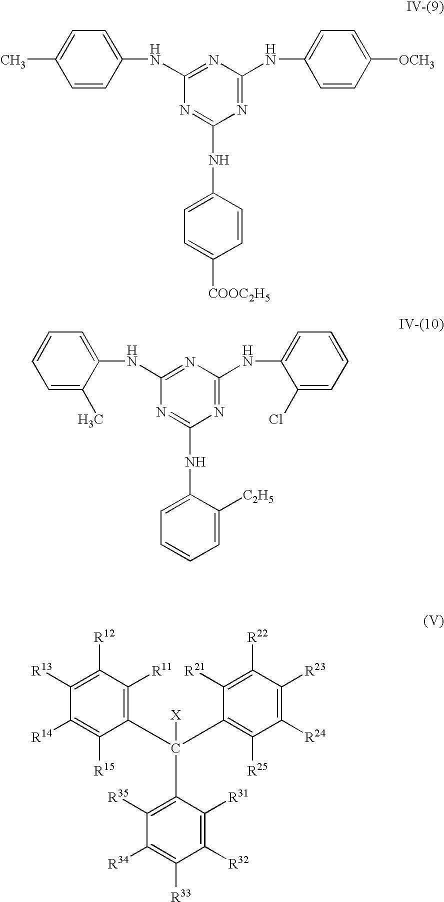

A compound of Formula (V) above is now explained in detail.

In Formula (V), X denotes a substituted or unsubstituted amino group, an acylamino group, an alkoxycarbonylamino group, an aryloxycarbonylamino group, a sulfonylamino group, a hydroxyl group, a mercapto group, or a carboxyl group, more preferably an amino group or a hydroxyl group, and particularly preferably a hydroxyl group.

In Formula (V), R¹¹, R¹², R¹³, R¹⁴, R¹⁵, R²¹, R²², R²³, R²⁴, R²⁵, R³¹, R³², R³³, R³⁴ and R³⁵ denote a hydrogen atom or a substituent, and as the substituent a substituent T below can be employed.

The substituent T is, for example, an alkyl group (preferably having 1 to 20 carbons, more preferably 1 to 12 carbons, and particularly preferably 1 to 8 carbons, examples thereof including methyl, ethyl, iso-propyl, tert-butyl, n-octyl, n-decyl, n-hexadecyl, cyclopropyl, cyclopentyl, and cyclohexyl), an alkenyl group (preferably having 2 to 20 carbons, more preferably 2 to 12 carbons, and particularly preferably 2 to 8 carbons, examples thereof including vinyl, allyl, 2-butenyl, and 3-pentenyl), an alkynyl group (preferably having 2 to 20 carbons, more preferably 2 to 12 carbons, and particularly preferably 2 to 8 carbons, examples thereof including propargyl and 3-pentynyl), an aryl group (preferably having 6 to 30 carbons, more preferably 6 to 20 carbons, and particularly preferably 6 to 12 carbons, examples thereof including phenyl, p-methylphenyl, and naphthyl), a substituted or unsubstituted amino group (preferably having 0 to 20 carbons, more preferably 0 to 10 carbons, and particularly preferably 0 to 6 carbons, examples thereof including amino, methylamino, dimethylamino, diethylamino, and dibenzylamino), an alkoxy group (preferably having 1 to 20 carbons, more preferably 1 to 12 carbons, and particularly preferably 1 to 8 carbons, examples thereof including methoxy, ethoxy, and butoxy), an aryloxy group (preferably having 6 to 20 carbons, more preferably 6 to 16 carbons, and particularly preferably 6 to 12 carbons, examples thereof including phenyloxy and 2-naphthyloxy), an acyl group (preferably having 1 to 20 carbons, more preferably 1 to 16 carbons, and particularly preferably 1 to 12 carbons, examples thereof including acetyl, benzoyl, formyl, and pivaloyl), an alkoxycarbonyl group (preferably having 2 to 20 carbons, more preferably 2 to 16 carbons, and particularly preferably 2 to 12 carbons, examples thereof including methoxycarbonyl and ethoxycarbonyl), an aryloxycarbonyl group (preferably having 7 to 20 carbons, more preferably 7 to 16 carbons, and particularly preferably 7 to 10 carbons, examples thereof including phenyloxycarbonyl), an acyloxy group (preferably having 2 to 20 carbons, more preferably 2 to 16 carbons, and particularly preferably 2 to 10 carbons, examples thereof including acetoxy and benzoyloxy), an acylamino group (preferably having 2 to 20 carbons, more preferably 2 to 16 carbons, and particularly preferably 2 to 10 carbons, examples thereof including acetylamino and benzoylamino), an alkoxycarbonylamino group (preferably having 2 to 20 carbons, more preferably 2 to 16 carbons, and particularly preferably 2 to 12 carbons, examples thereof including methoxycarbonylamino),

an aryloxycarbonylamino group (preferably having 7 to 20 carbons, more preferably 7 to 16 carbons, and particularly preferably 7 to 12 carbons, examples thereof including phenyloxycarbonylamino), a sulfonylamino group (preferably having 1 to 20 carbons, more preferably 1 to 16 carbons, and particularly preferably 1 to 12 carbons, examples thereof including methanesulfonylamino and benzenesulfonylamino), a sulfamoyl group (preferably having 0 to 20 carbons, more preferably 0 to 16 carbons, and particularly preferably 0 to 12 carbons, examples thereof including sulfamoyl, methylsulfamoyl, dimethylsulfamoyl, and phenylsulfamoyl), a carbamoyl group (preferably having 1 to 20 carbons, more preferably 1 to 16 carbons, and particularly preferably 1 to 12 carbons, examples thereof including carbamoyl, methylcarbamoyl, diethylcarbamoyl, and phenylcarbamoyl), an alkylthio group (preferably having 1 to 20 carbons, more preferably 1 to 16 carbons, and particularly preferably 1 to 12 carbons, examples thereof including methylthio and ethylthio), an arylthio group (preferably having 6 to 20 carbons, more preferably 6 to 16 carbons, and particularly preferably 6 to 12 carbons, examples thereof including phenylthio), a sulfonyl group (preferably having 1 to 20 carbons, more preferably 1 to 16 carbons, and particularly preferably 1 to 12 carbons, examples thereof including mesyl and tosyl), a sulfinyl group (preferably having 1 to 20 carbons, more preferably 1 to 16 carbons, and particularly preferably 1 to 12 carbons, examples thereof including methanesulfinyl and benzenesulfinyl), a ureido group (preferably having 1 to 20 carbons, more preferably 1 to 16 carbons, and particularly preferably 1 to 12 carbons, examples thereof including ureido, methylureido, and phenylureido), a phosphoric acid amide group (preferably having 1 to 20 carbons, more preferably 1 to 16 carbons, and particularly preferably 1 to 12 carbons, examples thereof including diethylphosphoric acid amide and phenylphosphoric acid amide), a hydroxyl group, a mercapto group, a halogen atom (for example, a fluorine atom, a chlorine atom, a bromine atom, or an iodine atom), a cyano group, a sulfo group, a carboxyl group, a nitro group, a hydroxamic acid group, a sulfino group, a hydrazino group, an imino group, a heterocyclic group (preferably having 1 to 30 carbons, and more preferably 1 to 12, examples of the hetero atom including a nitrogen atom, an oxygen atom, and a sulfur atom, and specific examples including imidazolyl, pyridyl, quinolyl, furyl, piperidyl, morpholino, benzoxazolyl, benzimidazolyl, and benzothiazolyl), or a silyl group (preferably having 3 to 40 carbons, more preferably 3 to 30 carbons, and particularly preferably 3 to 24 carbons, examples thereof including trimethylsilyl and triphenylsilyl). Among these, an alkyl group, an aryl group, a substituted or unsubstituted amino group, an alkoxy group, and an aryloxy group are more preferable, and an alkyl group, an aryl group, and an alkoxy group are yet more preferable.

These substituents may be further substituted with the substituent T. When there are two or more substituents, they may be identical to or different from each other. When it is possible, they may be bonded together to form a ring.

The compound represented by Formula (V) is explained in detail below by reference to specific examples, but the present invention is not limited by the following specific examples.

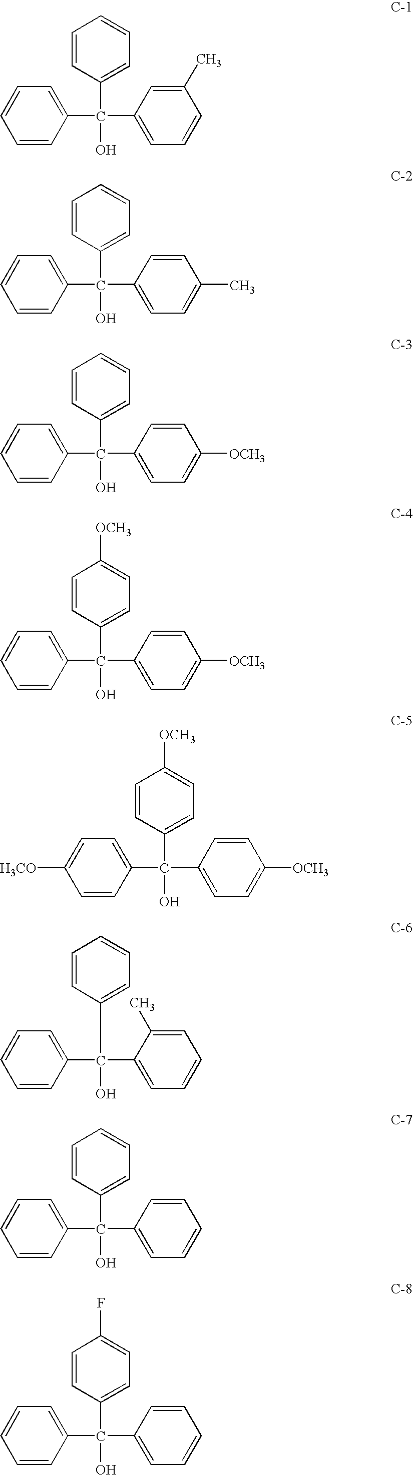

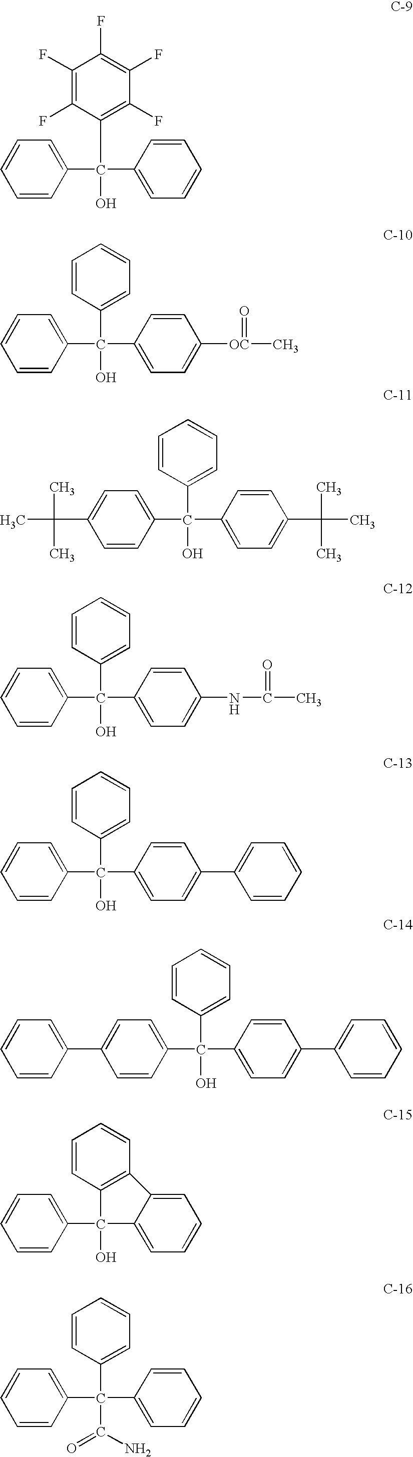

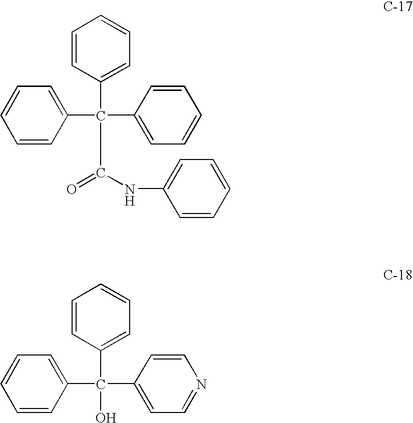

The molecular weight of the hydrophobicizing agent that can be used in the present invention is preferably at least 200 but no greater than 1,000, and more preferably at least 300 but no greater than 850. If it is in this range, a balance can be achieved between solubility in a solvent and retention during film formation. The boiling point of the compound of the present invention is preferably 260° C. or higher. The boiling point can be measured using commercial measurement equipment (for example, a TG/DTA100, manufactured by Seiko Electronic Industry Co., Ltd.).

The compounds represented by Formulae (1) to (V) may be used singly or in a combination of two or more types. In the present invention, the combined use of the compounds represented by Formulae (1) to (V) is also preferable. The amount added of the hydrophobicizing agent that can be used in the present invention is preferably 2 to 30 wt % relative to 100 parts by weight of the cellulose acylate, and more preferably 3 to 25 wt %. By using the compound in this range, the degree of water permeation can be reduced without causing bleed-out.

The hydrophobicizing agent that can be used in the present invention may have another function as a retardation adjusting agent, a plasticizer, etc.

The hydrophobicizing agent that can be used in the present invention may be added to the cellulose acylate solution (dope) after being dissolved in an organic solvent such as an alcohol, methylene chloride, or dioxolane, or directly added to a dope composition.

### <Production of Cellulose Acylate Film>

The cellulose acylate film of the present invention may be produced by a solvent casting method. In the solvent casting method, a film is produced using a solution (dope) in which a cellulose acylate is dissolved in an organic solvent.

The organic solvent preferably contains a solvent selected from an ether having 3 to 12 carbon atoms, a ketone having 3 to 12 carbon atoms, an ester having 3 to 12 carbon atoms, and a halohydrocarbon having 1 to 6 carbon atoms.

The ether, the ketone, and the ester may have a cyclic structure. A compound having two or more functional groups such as ether, ketone, or ester (that is, —O—, —CO—, or —COO—) can also be used as an organic solvent. The organic solvent may have another functional group such as an alcoholic hydroxyl group. In the case of an organic solvent having two or more types of functional groups, the number of carbon atoms thereof is preferably in the above-mentioned preferred range of the number of carbon atoms of the solvents having any of the functional groups.

Examples of the ether having 3 to 12 carbon atoms include diisopropyl ether, dimethoxymethane, dimethoxyethane, 1,4-dioxane, 1,3-dioxolane, tetrahydrofuran, anisole, and phenetole.

Examples of the ketone having 3 to 12 carbon atoms include acetone, methyl ethyl ketone, diethyl ketone, diisobutyl ketone, cyclohexanone, and methylcyclohexanone.

Examples of the ester having 3 to 12 carbon atoms include ethyl formate, propyl formate, pentyl formate, methyl acetate, ethyl acetate, and pentyl acetate.

Examples of the organic solvent having two or more types of functional groups include 2-ethoxyethyl acetate, 2-methoxyethanol, and 2-butoxyethanol.

The number of carbon atoms of the halohydrocarbon is preferably 1 or 2, and most preferably 1. The halogen of the halohydrocarbon is preferably chlorine. The proportion of hydrogen atoms of the halohydrocarbon replaced by a halogen is preferably 25 to 75 mol %, more preferably 30 to 70 mol %, yet more preferably 35 to 65 mol %, and most preferably 40 to 60 mol %. Methylene chloride is a representative halohydrocarbon.

Two or more types of organic solvents may be used as a mixture.

A cellulose acylate solution can be prepared by a standard method involving treatment at a temperature of 0° C. or higher (normal temperature or high temperature). Preparation of the solution may be carried out using a preparation method and equipment that are used for a dope in a normal solvent casting method. In the case of a standard method, it is preferable to use, as the organic solvent, a halohydrocarbon (particularly methylene chloride).

The amount of cellulose acylate is adjusted so that it is contained at 10 to 40 wt % in the solution so obtained. The amount of cellulose acylate is more preferably 10 to 30 wt %. The organic solvent (main solvent) may contain any of the additives that are described later.

The solution can be prepared by stirring the cellulose acylate and the organic solvent at normal temperature (0° C. to 40° C.). A high concentration solution may be stirred under conditions of increased pressure and temperature. Specifically, the cellulose acylate and the organic solvent are placed in a pressure vessel, which is then hermetically sealed, and stirred while heating under pressure at a temperature that is not less than the boiling point of the solvent at atomospheric pressure and less than the temperature at which the solvent boils.

The heating temperature is normally 40° C. or greater, preferably 60° C. to 200° C., and yet more preferably 80° C. to 110° C.

The components may be roughly mixed before being placed in the vessel. They may be added to the vessel in sequence. It is necessary for the vessel to be arranged so that stirring is possible. The vessel may be pressurized by injecting an inert gas such as nitrogen gas. It may utilize an increase in the vapor pressure of the solvent by heating. Alternatively, after the vessel is hermetically sealed, the components may be added under pressure.

When heating, it is preferable to heat the vessel externally. For example, jacket type heating equipment may be used. It is also possible to heat the entire vessel by providing a plate heater on the outside of the vessel and piping and circulating a liquid.

It is preferable to provide a stirring blade within the vessel, and carry out stirring using this. The stirring blade preferably has a length that reaches the vicinity of the wall of the vessel. The stirring blade preferably has a scraping blade at its extremity in order to renew a liquid coating on the wall of the vessel.

The vessel may be equipped with a measuring instrument such as a pressure gauge or a thermometer. Each component is dissolved in the solvent within the vessel. The dope thus prepared is taken out of the vessel after cooling, or taken out and then cooled using a heat exchanger, etc.

It is also possible to prepare the solution by a cooling dissolution method. In the cooling dissolution method, it is possible to dissolve the cellulose acylate in an organic solvent for which dissolution is difficult by a normal dissolution method. Even for a solvent for which dissolution of cellulose acylate is possible by the normal dissolution method, the cooling dissolution method has an effect in giving a uniform solution quickly.

In the cooling dissolution method, cellulose acylate is first gradually added to an organic solvent while stirring at room temperature. The amount of cellulose acylate is preferably adjusted so that it is contained in the mixture at 10 to 40 wt %. The amount of cellulose acylate is more preferably 10 to 30 wt %. The mixture may further contain any of the additives that will be described later.

Subsequently, the mixture is cooled to −100° C. to −10° C. (preferably −80° C. to −10° C., more preferably −50° C. to −20° C., and most preferably −50° C. to −30° C.). Cooling can be carried out, for example, in a dry ice/methanol bath (−75° C.) or a cooled diethylene glycol solution (−30° C. to −20° C.). Cooling allows the mixture of the cellulose acylate and the organic solvent to solidify.

The cooling rate is preferably 4° C./min or greater, more preferably 8° C./min or greater, and most preferably 12° C./min or greater. The higher the cooling rate, the more preferable it is, but the theoretical upper limit is 10,000° C./sec, the technical upper limit is 1,000° C./sec, and the practical upper limit is 100° C./sec. The cooling rate is a value obtained by dividing the difference between the temperature when starting cooling and the final cooling temperature by the time taken to reach the final cooling temperature after starting cooling.

Furthermore, by heating this mixture to 0° C. to 200° C. (preferably 0° C. to 150° C., more preferably 0° C. to 120° C., and most preferably 0° C. to 50° C.), the cellulose acylate is dissolved in the organic solvent. Heating may be carried out merely by allowing it to stand at room temperature, or by a hot bath.

The heating rate is preferably 4° C./min or greater, more preferably 8° C./min or greater, and most preferably 12° C./min or greater. The higher the heating rate, the more preferable it is, but the theoretical upper limit is 10,000° C./sec, the technical upper limit is 1,000° C./sec, and the practical upper limit is 100° C./sec. The heating rate is a value obtained by dividing the difference between the temperature when starting heating and the final heating temperature by the time taken to reach the final heating temperature after starting heating.

By so doing, a uniform solution can be obtained. When dissolution is insufficient, the cooling and heating operations may be repeated. Whether or not dissolution is sufficient can be judged merely by visual observation of the appearance of the solution.

In the cooling dissolution method, in order to prevent contamination from moisture due to condensation during cooling, it is desirable to use a vessel that can be hermetically sealed. During the cooling and heating operations, by pressurizing during cooling and evacuating during heating, the dissolution time can be reduced. In order to carry out pressurizing and evacuating, it is desirable to use a pressure-resistant vessel.

A 20 wt % solution in which a cellulose acetate (degree of acetylation: 60.9%, viscosity-average degree of polymerization: 299) is dissolved in methyl acetate by the cooling dissolution method has a pseudo phase transition point between a sol state and a gel state in the vicinity of 33° C. when measured by a differential scanning calorimeter (DSC), and at this temperature or below it attains a uniform gel state. It is therefore necessary to store this solution at the pseudo phase transition temperature or higher, and preferably at a temperature that is higher than the gel phase transition temperature by about 10° C. This pseudo phase transition temperature varies depending on the degree of acetylation, the viscosity-average degree of polymerization, and the solution concentration of the cellulose acetate, and on the organic solvent used.

A cellulose acylate film is produced by the solvent casting method using the cellulose acylate solution (dope) thus prepared. The dope is cast on a drum or band, and the solvent is evaporated to form a film. The concentration of the dope prior to casting is preferably adjusted so that the solids content is 18% to 35%. The surface of the drum or the band is preferably mirror-finished. It is preferable that the surface temperature of the drum or the band on which the dope is cast is 10° C. or less.

Drying methods in the solvent casting method are described in the specifications of U.S. Pat. Nos. 2,336,310, 2,367,603, 2,492,078, 2,492,977, 2,492,978, 2,607,704, 2,739,069, and 2739070, GB Pat. Nos. 640731 and 736892, and JP-B-45-4554 (JP-B denotes a Japanese examined patent application publication), JP-B-49-5614, JP-A-60-176834, JP-A-60-203430, and JP-A-62-115035. Drying on the band or the drum can be carried out by feeding a gas such as air or an inert gas such as nitrogen.

The film thus obtained is peeled off from the drum or the band, and may be further dried by hot blowing at a temperature that is sequentially changed from 1000° to 160° C. so as to evaporate residual solvent. This method is described in JP-B-5-17844. In accordance with this method, it is possible to reduce the time taken from casting until peeling off. In order to carry out this method, it is necessary for the dope to become a gel at the surface temperature of the drum or the band during casting.

In order to obtain a cellulose acylate film having a high crystallinity, it is preferable for the cellulose acylate film of the present invention to be produced via a step in which it is exposed to a high temperature in a state in which a large amount of residual solvent is present immediately after peeling off.

A film may be formed by casting two or more layers using the adjusted cellulose acylate solution (dope). In this case, it is preferable to form the cellulose acylate film by the solvent casting method. The dope is cast on the drum or the band, and the solvent is evaporated to give a film. The concentration of the dope prior to casting is preferably adjusted so that the solids content is 10% to 40%. The surface of the drum or the band is preferably mirror-finished.

When the cellulose acylate solution is cast for a plurality of layers, that is, two or more, it is possible to cast a plurality of cellulose acylate solutions, and a film may be formed by casting and layering solutions containing cellulose acylate via a plurality of casting apertures provided at intervals in the direction of travel of a support. For example, methods described in JP-A-61-158414, JP-A-1-122419, and JP-A-11-198285 may be employed. A film can also be formed by casting the cellulose acylate solution via two casting apertures. For example, methods described in JP-B-60-27562, JP-A-61-94724, JP-A-61-94725, JP-A-61-104813, JP-A-61-158413, and JP-A-6-134933 may be employed. It is also possible to employ a casting method for a cellulose acylate film described in JP-A-56-162617 in which a flow of a high viscosity cellulose acylate solution is enclosed by a low viscosity cellulose acylate solution, and the high and low viscosity cellulose acylate solutions are simultaneously extruded.

It is also possible to form a film using two casting apertures by peeling off a film molded on a support via a first casting aperture and carrying out a second casting on the side of the film that was in contact with the support. For example, a method described in JP-B-44-20235 can be referred to.

The cellulose acylate solutions to be cast may be identical to each other, or different cellulose acylate solutions may be used. In order to impart functionality to a plurality of cellulose acylate layers, a cellulose acylate solution according to the functionality may be extruded via each casting aperture. Furthermore, the cellulose acylate solution that can be used in the present invention may be cast at the same time as another functional layer (for example, an adhesive layer, a dye layer, an antistatic layer, an antihalation layer, an ultraviolet absorbing layer, a polarizing layer, etc.).

For the conventional single layer solution, in order to obtain a required film thickness, it is necessary to extrude a high viscosity cellulose acylate solution at a high concentration. In this case, the problem of the stability of the cellulose acylate solution becoming poor and solids forming often occurs, thus giving particulate faults and degrading the planarity. As a method of solving this problem, by casting a plurality of cellulose acylate solutions via casting apertures, high viscosity solutions can be extruded simultaneously onto a support, and not only does the planarity improve, thus enabling a film having an excellent surface shape to be obtained, but also the drying burden can be reduced by use of a concentrated cellulose acylate solution, thus increasing the speed of production of the film.

### <Matting Agent>

It is preferable to add particles as a matting agent to the cellulose acylate film of the present invention. Examples of the particles used in the present invention include silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate, and calcium phosphate. With regard to the particles, those containing silicon are preferable since the turbidity is low, and silicon dioxide is particularly preferable. The silicon dioxide particles preferably have an average primary particle size of 20 nm or less and an apparent specific gravity of 70 g/L or greater. Those having an average primary particle size of 5 to 16 nm are more preferable since the haze of the film can be reduced. The apparent specific gravity is preferably 90 to 200 g/L or greater, and more preferably 100 to 200 g/L or greater. The higher the apparent specific gravity, the higher the concentration of a dispersion that can be prepared, and the haze and the aggregates improve.

These particles usually form secondary particles having an average particle size of 0.1 to 3.0 μm, and these particles are present as aggregates of the primary particles in the film, thus forming irregularities of 0.1 to 3.0 μm on the film surface. The average secondary particle size is preferably at least 0.2 μm but no greater than 1.5 μm, more preferably at least 0.4 μm but no greater than 1.2 μm, and most preferably at least 0.6 μm but no greater than 1.1 μm. The primary and secondary particle sizes are defined as the diameter of a circle that circumscribes a particle when observing particles in the film using a scanning electron microscope. 200 particles from different areas are examined, and the average value thereof is defined as the average particle size.

The silicon dioxide particles may employ a commercial product such as, for example, Aerosil R972, R972V, R974, R812, 200, 200V, 300, R202, OX50, or TT600 (all manufactured by Nippon Aerosil Co., Ltd.). The zirconium oxide particles are commercially available as, for example, the product names Aerosil R976 and R811 (both manufactured by Nippon Aerosil Co., Ltd.), and may be used here.

Among these, Aerosil 200V and Aerosil R972V, which are silicon dioxide particles having an average primary particle size of 20 nm or less and an apparent specific gravity of 7.0 g/L or greater, are particularly preferable since they have a large effect in lowering the coefficient of friction while maintaining the turbidity of the optical film at a low level.

In the present invention, in order to obtain a cellulose acylate film containing particles having a small average secondary particle size, several techniques may be considered when preparing a dispersion of particles. For example, there is a method in which a particulate dispersion in which a solvent and particles are mixed by stirring is prepared in advance, this particulate dispersion is added to a small amount of a separately prepared cellulose acylate solution and dissolved by stirring, and further mixed with a main cellulose acylate dope solution. This method is a preferred preparation method from the viewpoint of the dispersibility of silicon dioxide particles being good and the silicon dioxide particles being more resistant to reaggregation. In addition, there is a method in which a small amount of a cellulose ester is added to a solvent and dissolved by stirring, and particles are added thereto and dispersed in a disperser; this is a solution to which particles have been added. This solution to which particles have been added is then mixed well with a dope solution in an in-line mixer. Although the present invention is not limited to these methods, the concentration of silicon dioxide when silicon dioxide particles are mixed with and dispersed in a solvent, etc. is preferably 5 to 30 wt %, more preferably 10 to 25 wt %, and most preferably 15 to 20 wt %. It is preferable for the dispersion concentration to be high since the solution turbidity relative to the amount added is low and the haze and the aggregates improve. The amount of added matting agent in the final cellulose acylate dope solution is preferably 0.01 to 1.0 g per m², more preferably 0.03 to 0.3 g per m², and most preferably 0.08 to 0.16 g per m².

Preferred examples of the solvent used include lower alcohols such as methyl alcohol, ethyl alcohol, propyl alcohol, isopropyl alcohol, and butyl alcohol. Solvents other than lower alcohols are not particularly limited, but it is preferable to use a solvent that is used for film formation of a cellulose ester.

### <Ultraviolet Absorbing Agent>

The cellulose acylate film that can be used in the present invention may contain an ultraviolet absorbing agent.

Examples of the ultraviolet absorbing agent include oxybenzophenone-based compounds, benzotriazole-based compounds, salicylic acid ester-based compounds, benzophenone-based compounds, cyanoacrylate-based compounds, and nickel complex salt-based compounds, and benzotriazole-based compounds are preferable since there is little coloration. Furthermore, ultraviolet absorbing agents described in JP-A-10-182621 and JP-A-8-337574, and a macromolecular ultraviolet absorbing agent described in JP-A-6-148430 are also used preferably. When the cellulose acylate film that can be used in the present invention is used as a protective film of a polarizing plate, those ultraviolet absorbing agent having excellent absorption for ultraviolet rays at wavelengths of 370 nm or less are preferable from the viewpoint of preventing degradation of a polarizer or a liquid crystal, and those having little absorption for visible light at wavelengths of 400 nm or greater are preferable from the viewpoint of liquid crystal display performance.

Specific examples of the benzotriazole-based ultraviolet absorbing agent that is useful for the present invention include 2-(2′-hydroxy-5′-methyl phenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethyl butyl)-6-(2H-benzotriazol-2-yl)phenol), 2-(2′-hydroxy-3′-tert-butyl-5′-methylphenyl)-5-chlorobenzotriazole, 2-(2H-benzotriazole-2-yl)-6-(straight-chain and side-chain dodecyl)-4-methyl phenol, and a mixture of octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate, but are not limited thereto. As a commercial product, TINUVIN 109, TINUVIN 171, TINUVIN 326, or TINUVIN 328 (all manufactured by Ciba Specialty Chemicals) may be used preferably.

A degradation inhibitor (for example, an antioxidant, a peroxide decomposing agent, a radical inhibitor, a metal deactivating agent, an acid scavenger, or an amine) may be added to the cellulose acylate film. The degradation inhibitor is described in JP-A-3-199201, JP-A-5-197073, JP-A-5-194789, JP-A-5-271471, and JP-A-6-107854. The amount of degradation inhibitor added is preferably adjusted to 0.01 to 1 wt % of the solution (dope) prepared, and more preferably 0.01 to 0.2 wt %. If the amount of degradation inhibitor added is in the above-mentioned range, the effect of the degradation inhibitor can be obtained sufficiently, and bleed-out (exudation) of the degradation inhibitor onto the film surface does not occur. Particularly preferred examples of the degradation inhibitor include butylated hydroxy toluene (BHT) and tribenzylamine (TBA).

These steps involving casting to post-drying may be carried out under an atmosphere of air or of an inert gas such as nitrogen gas. A winding machine used for production of a cellulose acylate film used in the present invention may be one generally used, and winding may be carried out by a winding method such as a constant tension method, a constant torque method, a taper tension method, or a constant internal stress programmed tension control method.

### <Modulus of Elasticity of Cellulose Acylate Film>

The average of the modulus of elasticity in the transport and width directions of the cellulose acylate film that can be used in the present invention preferably satisfies the relationships below.

300<E(80%RH)<800 (B)

1.00<E(10%RH)/E(80%RH)≦1.10 (C)

Relationship (B) is preferably 400<E (80% RH)<750, and more preferably 500<E (80% RH)<700.

Relationship (C) is preferably 1.00<E (10% RH)/E (80% RH)<1.08, and more preferably 1.00<E (10% RH)/E (80% RH)≦1.05.

If the modulus of elasticity is in the above-mentioned range, the brittleness of the film does not deteriorate, the problem of the film easily breaking during stamping out a polarizing plate, etc. does not occur, and unevenness due to shrinkage of a polarizer does not occur.

With regard to a method for obtaining a cellulose acylate film having the above-mentioned modulus of elasticity, increasing the crystallinity of the film, improving the degree of molecular chain alignment by a stretching treatment, addition of a certain type of hydrophobicizing agent, cross-linking, etc. can be cited. These methods are explained below.

### <Crystallinity of Cellulose Acylate Film>

When the crystallinity of the film is high, the modulus of elasticity increases. A method for crystallizing the film is not particularly limited, and there is, for example, a method in which the film is subjected to heating at a temperature that is equal to or higher than the crystallization temperature.

Since, in a state in which the film contains a solvent, the crystallization temperature is lower than when it is in a dry state, crystallization can be carried out at a lower temperature. The crystallization temperature of the film can be measured using a differential scanning calorimeter. If the crystallization proceeds excessively, the film becomes too hard, and factors related to brittleness, such as tear strength, are degraded.

The crystallinity referred to in the present invention means the sum of values obtained by subtracting the diffraction intensity at a Bragg angle 2θ=14° from a peak diffraction intensity detected in X-ray diffractometry. The scanning range is 2θ=50 to 35°. The crystallinity is preferably 2,500 to 9,000, more preferably 3,000 to 8,000, and most preferably 4,000 to 7,500.

### <Stretching Treatment>

A stretching treatment can increase the degree of alignment of molecular chains and enhance the modulus of elasticity. The direction of stretching the cellulose acylate film may be either the width direction or the longitudinal direction.

Methods for stretching in the width direction are described in, for example, JP-A-62-115035, JP-A-4-152125, JP-A-4-284211, JP-A-4-298310, and JP-A-11-48271. Stretching of the film is carried out at normal temperature or under conditions of heating. The heating temperature is preferably not greater than the glass transition temperature of the film. The film can be stretched during a drying process, and this is particularly effective when there is residual solvent. In the case of stretching in the longitudinal direction, the film is stretched by adjusting the speed of feed rollers for the film so that the speed at which the film is wound up is higher than the speed at which the film is peeled off. In the case of stretching in the width direction, the film is fed while holding it in the width direction of the film by means of a tenter, and by gradually increasing the width of the tenter the film can be stretched. After the film is dried, it may be stretched using a stretching machine (preferably uniaxial stretching using a long stretching machine). The stretching ratio of the film is preferably 1.04 to 2.00 times, more preferably 1.05 to 2.00 times, and yet more preferably 1.10 to 1.80 times.

### <Hydrophobicizing Agent>

The modulus of elasticity of the cellulose acylate film that can be used in the present invention can be increased by the addition of a certain type of hydrophobicizing agent. A compound having a functional group that has high affinity for a hydroxyl group and a highly hydrophobic partial structure in the molecule, as represented by Formulae (1) to (V) above, is particularly preferable.

### <Retardation Increasing Agent>

As a retardation increasing agent that can be used in the present invention, a known compound may be used, and a compound cited above as the hydrophobicizing agent or a compound represented by Formula (VI) below is preferable.

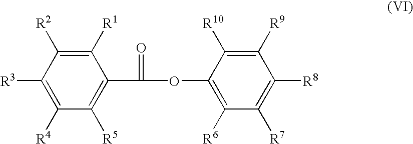

In Formula (VI), R¹ to R⁷, R⁹, and R¹⁰ independently denote a hydrogen atom or a substituent, and the substituent may employ the substituent T described above.

Among R¹ to R⁵, at least one denotes an electron-donating group. It is preferable that one of R¹, R³, and R⁵ is an electron-donating group, and it is more preferable that R³ is an electron-donating group.

The electron-donating group referred to here means a group having a Hammet σₚ value of 0 or less, and it is preferable to use those described in Chem. Rev., 91, 165 (1991) and having a Hammet σₚ value of 0 or less, and more preferably −0.85 to 0. Examples thereof include an alkyl group, an alkoxy group, an amino group, and a hydroxyl group.

As the electron-donating group, an alkyl group or an alkoxy group is preferable, and an alkoxy group (preferably having 1 to 12 carbons, more preferably 1 to 8 carbons, yet more preferably 1 to 6 carbons, and particularly preferably 1 to 4 carbons) is more preferable.

R¹ is preferably a hydrogen atom or an electron-donating group, more preferably an alkyl group, an alkoxy group, an amino group, or a hydroxyl group, yet more preferably an alkyl group having 1 to 4 carbons or an alkoxy group having 1 to 12 carbons, particularly preferably an alkoxy group (preferably having 1 to 12 carbons, more preferably 1 to 8 carbons, yet more preferably 1 to 6 carbons, and particularly preferably 1 to 4 carbons), and most preferably a methoxy group.

R² is preferably a hydrogen atom, an alkyl group, an alkoxy group, an amino group, or a hydroxyl group, more preferably a hydrogen atom, an alkyl group, or an alkoxy group, and yet more preferably a hydrogen atom, an alkyl group (preferably having 1 to 4 carbons, and more preferably a methyl group), or an alkoxy group (preferably having 1 to 12 carbons, more preferably 1 to 8 carbons, yet more preferably 1 to 6 carbons, and particularly preferably 1 to 4 carbons). A hydrogen atom, a methyl group, and a methoxy group are particularly preferable.

R³ is preferably a hydrogen atom or an electron-donating group, more preferably a hydrogen atom, an alkyl group, an alkoxy group, an amino group, or a hydroxyl group, yet more preferably an alkyl group or an alkoxy group, and particularly preferably an alkoxy group (preferably having 1 to 12 carbons, more preferably 1 to 8 carbons, yet more preferably 1 to 6 carbons, and particularly preferably 1 to 4 carbons). A n-propoxy group, an ethoxy group, and a methoxy group are most preferable.

R⁴ is preferably a hydrogen atom or an electron-donating group, more preferably a hydrogen atom, an alkyl group, an alkoxy group, an amino group, or a hydroxyl group, yet more preferably a hydrogen atom, an alkyl group having 1 to 4 carbons, or an alkoxy group having 1 to 12 carbons (preferably having 1 to 12 carbons, more preferably 1 to 8 carbons, yet more preferably 1 to 6 carbons, and particularly preferably 1 to 4 carbons), particularly preferably a hydrogen atom, an alkyl group having 1 to 4 carbons, or an alkoxy group having 1 to 4 carbons, and most preferably a hydrogen atom, a methyl group, or a methoxy group.

Preferred groups as R⁵ are the same as the groups cited for R².

R⁶, R⁷, R⁹, and R¹⁰ are preferably hydrogen atoms, alkyl groups having 1 to 12 carbons, alkoxy groups having 1 to 12 carbons, or halogen atoms, more preferably hydrogen atoms or halogen atoms, and yet more preferably hydrogen atoms.

R⁸ denotes a hydrogen atom, an alkyl group having 1 to 4 carbons, an alkenyl group having 2 to 6 carbons, an alkynyl group having 2 to 6 carbons, an aryl group having 6 to 12 carbons, an alkoxy group having 1 to 12 carbons, an aryloxy group having 6 to 12 carbons, an alkoxycarbonyl group having 2 to 12 carbons, an acylamino group having 2 to 12 carbons, a cyano group, or a halogen atom, it may have a substituent when this is possible, and the substituent may employ the substituent T described above.

R⁸ is preferably an alkyl group having 1 to 4 carbons, an alkynyl group having 2 to 6 carbons, an aryl group having 6 to 12 carbons, an alkoxy group having 1 to 12 carbons, or an aryloxy group having 6 to 12 carbons, more preferably an aryl group having 6 to 12 carbons, an alkoxy group having 1 to 12 carbons, or an aryloxy group having 6 to 12 carbons, yet more preferably an alkoxy group having 1 to 12 carbons (preferably having 1 to 12 carbons, more preferably 1 to 8 carbons, yet more preferably 1 to 6 carbons, and particularly preferably 1 to 4 carbons), and particularly preferably a methoxy group, an ethoxy group, a n-propoxy group, an iso-propoxy group, or a n-butoxy group.

### <Crosslinking Treatment>

When the cellulose acylate is crosslinked, the modulus of elasticity increases, but when the crosslinking is excessive, the cellulose acylate film becomes too hard and brittle. Means for crosslinking the cellulose acylate is not particularly limited, but an isocyanate-based crosslinking agent may preferably be used. Preferred examples of the isocyanate-based crosslinking agent include isocyanates having an aromatic ring such as 2,4-tolylene diisocyanate (TDI), 4,4′-diphenylmethane diisocyanate (MDI), and xylylene diisocyanate, aliphatic isocyanates such as n-butyl diisocyanate and hexamethylene diisocyanate, and isocyanates having a hydrogenated aromatic ring such as hydrogenated TDI and hydrogenated MDI.

Furthermore, a polyisocyanate obtained by reacting these isocyanate compounds with an active hydrogen-containing compound may be used. By the use of an isocyanate having an aromatic ring such as TDI or MDI, the water absorption modulus of elasticity improves by a small amount, and the moisture permeability improves, but by increasing the amount thereof added the light fastness is degraded, and the tear strength deteriorates. By the use of an aliphatic isocyanate or an isocyanate having a hydrogenated aromatic ring, the light fastness improves compared with an isocyanate having an aromatic ring, and the aliphatic isocyanate can suppress the deterioration in the tear strength.

### <Thickness of Cellulose Acylate Film>

The thickness of the cellulose acylate film that can be used in the present invention is preferably at least 10 μm but no greater than 200 μm, more preferably at least 20 μm but no greater than 150 μm, and most preferably at least 30 μm but no greater than 100 μm.

Other physical properties of the cellulose acylate film that can be used in the present invention are now explained.

### <Moisture Permeability of Cellulose Acylate Film>

Moisture permeability is measured in accordance with a method described in JIS Z 0208 for each sample, and calculated as the amount of water (g) that evaporates per area of 1 m² in 24 hours. The moisture permeability is a film physical property that is closely related to the durability of the polarizing plate, and by decreasing the moisture permeability the polarizing plate durability can be improved. The cellulose acylate film that can be used in the present invention preferably has a 60° C./95% RH/24 hr moisture permeability of at least 500 g/m² but no greater than 1,100 g/m². It is more preferably at least 500 g/m² but no greater than 1,000 g/m².

### <Water Content of Cellulose Acylate Film>

The water content of the cellulose acylate film can be evaluated by measuring an equilibrium water content at a predetermined temperature and humidity. The equilibrium water content is calculated by measuring, using the Karl-Fisher method, an amount of water of a sample that has reached equilibrium after being allowed to stand at the above-mentioned temperature and humidity for 24 hours, and dividing the amount of water (g) by the weight of the sample (g).

The water content at 25° C. and 80% RH of the cellulose acylate film that can be used in the present invention is preferably 3.5 wt % or less, more preferably 2.7 wt % or less, and most preferably 2.0 wt % or less.

### <Glass Transition Temperature>

The glass transition temperature of the cellulose acylate film that can be used in the present invention is preferably at least 120° C., and more preferably at least 140° C. The glass transition temperature is obtained as the average value of a temperature at which the baseline starts to change due to a glass transition of the film when measured using a differential scanning calorimeter (DSC) at a rate of temperature increase of 10° C./min, and a temperature at which it returns to the baseline.

### <Cycloolefin-Based Polymer Film>

The cycloolefin-based polymer used in the polarizing plate protective film of the present invention is now explained in detail.

### (Cycloolefin-Based Addition Polymer)

The cycloolefin-based polymer used in the polarizing plate protective film of the present invention is preferably a cyclic olefin-based addition polymer containing, at an appropriate ratio, a structural unit (a) represented by Formula (1) below and a structural unit (b) represented by Formula (2) below.

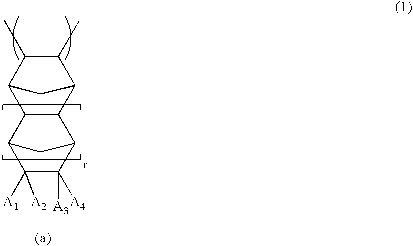

A₁, A₂, A₃, and A₄ of Formula (1) independently denote a hydrogen atom, an alkyl group having 1 to 10 carbons, an aryl group, a cycloalkyl group having 4 to 15 carbons, or a halogen atom. A₁ to A₄ also include an alkylene group formed from A₁ and A₂, A₁ and A³, or A₂ and A₄. r denotes an integer of 0 to 2.

Such a structural unit (a) is formed by addition polymerization of a cyclic olefin compound represented by Formula (3) below (hereinafter, called ‘particular monomer (1)’).

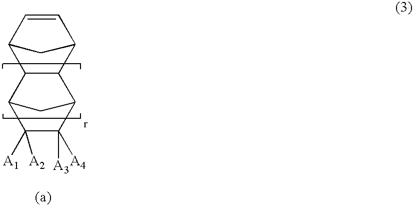

(A₁, A₂, A₃, and A₄ of Formula (3) independently denote a hydrogen atom, an alkyl group having 1 to 10 carbons, an aryl group, a cycloalkyl group having 4 to 15 carbons, or a halogen atom. A₁ to A₄ also include an alkylene group and an alkylidene group formed from A₁ and A₂, A₁ and A₃, or A₂ and A₄. r denotes an integer of 0 to 2.)

Specific examples of the ‘particular monomer (1)’ represented by Formula (3) include bicyclo[2.2.1]hept-2-ene, 5-methyl-bicyclo[2.2.1]hept-2-ene, 5-ethyl-bicyclo[2.2.1]hept-2-ene, 5-propyl-bicyclo[2.2.1]hept-2-ene, 5-butyl-bicyclo[2.2.1]hept-2-ene, 5-pentyl-bicyclo[2.2.1]hept-2-ene, 5-hexyl-bicyclo[2.2.1]hept-2-ene, 5-heptyl-bicyclo[2.2.1]hept-2-ene, 5-octyl-bicyclo[2.2.1]hept-2-ene, 5-decyl-bicyclo[2.2.1]hept-2-ene, 5-dodecyl-bicyclo[2.2.1]hept-2-ene, 5,6-dimethyl-bicyclo[2.2.1]hept-2-ene, 5-methyl-5-ethyl-bicyclo[2.2.1]hept-2-ene, 5-phenyl-bicyclo[2.2.1]hept-2-ene, 5-cyclohexyl-bicyclo[2.2.1]hept-2-ene, 5-cyclooctyl-bicyclo[2.2.1]hept-2-ene, 5-fluoro-bicyclo[2.2.1]hept-2-ene, 5-chloro-bicyclo[2.2.1]hept-2-ene, tricyclo[4.2.0.1^{5,8}]non-2-ene, 1-methyltricyclo[4.2.0.1^{5,8}]non-2-ene, 6-methyltricyclo[4.2.0.1^{5,8}]non-2-ene, tricyclo[5.2.1.0^{2,6}]dec-8-ene, 3-methyltricyclo[5.2.1.0^{2,6}]dec-8-ene, 4-methyltricyclo[5.2.1.0^{2,6}]dec-8-ene, tricyclo[6.2.1.0^{2,7}]undec-9-ene, 1-methyltricyclo[6.2.1.0^{2,7}]undec-9-ene, 3-methyltricyclo[6.2.1.0^{2,7}]undec-9-ene, 1-ethyltricyclo[6.2.1.0^{2,7}]undec-9-ene, 3-ethyltricyclo[6.2.1.0^{2,7}]undec-9-ene, tricyclo[8.2.1.0^{2,9}]tridec-11-ene, 1-methyltricyclo[8.2.1.0^{2,9}]tridec-11-ene, 5-methyltricyclo[8.2.1.0^{2,9}]tridec-11-ene, tetracyclo[4.4.0.1^{2,5}.1^{7,10}]dodec-3-ene, 8-methyl-tetracyclo[4.4.0.1^{2,5}.1^{7,10}]dodec-3-ene, and 8-ethyl-tetracyclo[4.4.0.1^{2,5}.1^{7,10}]dodec-3-ene.

Furthermore, the structural unit (a) may be formed by addition-polymerizing a cyclic diolefin-based compound such as 5-vinyl-bicyclo[2.2.1]hept-2-ene, 5-(1-butenyl)-bicyclo[2.2.1]hept-2-ene, tricyclo[5.2.1.0^{2,6}]deca-3,8-diene, 1-methyltricyclo[5.2.1.0^{2,6}]deca-3,8-diene, or 1-ethyltricyclo[5.2.1.0^{2,6}]deca-3,8-diene, and subsequently hydrogenating a cyclic olefinic unsaturated bond present in a side chain.

Among these ‘particular monomers (1)’, bicyclo[2.2.1]hept-2-ene and tricyclo[5.2.1.0^{2,6}]dec-8-ene are preferable. Tricyclo[5.2.1.0^{2,6}]dec-8-ene has endo and exo stereoisomers; in the present invention the endo isomer is preferably used since the film that is finally obtained has higher toughness, and it is preferable to use tricyclo[5.2.1.0^{2,6}]dec-8-ene having an endo isomer content of at least 80%. A method in which endo-isomer tricyclo[5.2.1.0^{2,6}]deca-3,8-diene is addition-polymerized and a remaining cyclic olefinic unsaturated bond in the side chain is then hydrogenated is also preferable. In this case, the endo isomer content is preferably at least 80%. The cyclic olefin-based polymer obtained using the above is a polymer having not only excellent transparency and heat resistance but also low water absorption, a low dielectric constant, and high toughness. With regard to the ‘particular monomer (1)’, one type or two or more types may be used.

The structural unit (b) represented by Formula (2) below is formed by addition polymerization of a cyclic olefin represented by Formula (4) below (hereinafter, called ‘particular monomer (2)’).

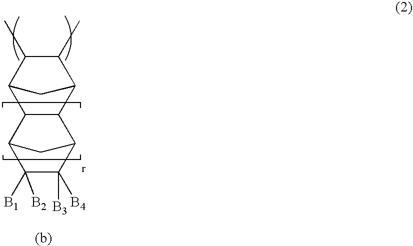

(In Formula (2), B₁ to B₄ independently denote a hydrogen atom, an alkyl group, a cycloalkyl group, an aryl group, a halogenated alkyl group, a hydrolyzable silyl group, or a polar group represented by —(CH₂)ⱼX, and at least one of B₁ to B₄ contains a hydrolyzable silyl group or a polar group represented by —(CH₂)ⱼX. Here, X is —C(O)OR¹ or —OC(O)R², R¹ and R² are substituents selected from the group consisting of an alkyl group, an alkenyl group, a cycloalkyl group, and an aryl group, those having 1 to 10 carbons, or halogen substituted derivatives thereof, and j is an integer of 0 to 3. Furthermore, B₁ to B₄ include an alkylene group formed by B₁ and B₃ or B₂ and B₄, and an alkylidenyl group formed by B₁ and B₂ or B₃ and B₄. p is an integer of 0 to 2.)

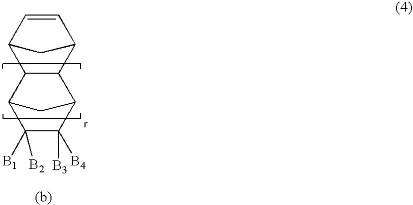

(In Formula (4), B₁ to B₄ are the same as in Formula (2). p denotes an integer of 0 to 2.)

Specific examples of such a ‘particular monomer (2)’ include the compounds below, but the present invention is not limited to these specific examples. 5-methoxycarbonyl-bicyclo[2.2.1]hept-2-ene, 5-ethoxycarbonyl-bicyclo[2.2.1]hept-2-ene, 5-butoxycarbonyl-bicyclo[2.2.1]hept-2-ene, 5-methyl-5-methoxycarbonyl-bicyclo[2.2.1]hept-2-ene, 5-methyl-5-ethoxycarbonyl-bicyclo[2.2.1]hept-2-ene, 5-methyl-5-propoxycarbonyl-bicyclo[2.2.1]hept-2-ene, 5-methyl-5-butoxycarbonyl-bicyclo[2.2.1]hept-2-ene, 5-ethyl-5-methoxycarbonyl-bicyclo[2.2.1]hept-2-ene, 5-methyl-5-trifluoromethoxycarbonyl-bicyclo[2.2.1]hept-2-ene, ethyl 5-methyl-bicyclo[2.2.1]hept-2-en-5-ylmethylcarboxylate, acrylic acid-1-methyl-bicyclo[2.2.1]hept-3-ene, methacrylic acid-1-methyl-bicyclo[2.2.1]hept-3-ene, 5,6-di(methoxycarbonyl)-bicyclo[2.2.1]hept-2-ene, 8-methyl-8-methoxycarbonyl-tetracyclo[4.4.0.1^{2,5}.1^{7,10}]dodec-3-ene, 8-methyl-8-ethoxycarbonyl-tetracyclo[4.4.0.1^{2,5}.1^{7,10}]dodec-3-ene, 5-trimethoxysilyl-bicyclo[2.2.1]hept-2-ene, 5-dimethoxychlorosilyl-bicyclo[2.2.1]hept-2-ene, 5-methoxychloromethylsilyl-bicyclo[2.2.1]hept-2-ene, 5-dimethoxychlorosilyl-bicyclo[2.2.1]hept-2-ene, 5-methoxyhydridomethylsilyl-bicyclo[2.2.1]hept-2-ene, 5-dimethoxyhydridosilyl-bicyclo[2.2.1]hept-2-ene, 5-methoxydimethylsilyl-bicyclo[2.2.1]hept-2-ene, 5-triethoxysilyl-bicyclo[2.2.1]hept-2-ene, 5-diethoxychlorosilyl-bicyclo[2.2.1]hept-2-ene, 5-ethoxychloromethylsilyl-bicyclo[2.2.1]hept-2-ene, 5-diethoxyhydridosilyl-bicyclo[2.2.1]hept-2-ene, 5-ethoxydimethylsilyl-bicyclo[2.2.1]hept-2-ene, 5-ethoxydiethylsilyl-bicyclo[2.2.1]hept-2-ene, 5-propoxydimethylsilyl-bicyclo[2.2.1]hept-2-ene, 5-tripropoxysilyl-bicyclo[2.2.1]hept-2-ene, 5-triphenoxysilyl-bicyclo[2.2.1]hept-2-ene, 5-trimethoxysilylmethyl-bicyclo[2.2.1]hept-2-ene, 5-dimethylchlorosilyl-bicyclo[2.2.1]hept-2-ene, 5-methyldichlorosilyl-bicyclo[2.2.1]hept-2-ene, 5-trichlorosilyl-bicyclo[2.2.1]hept-2-ene-5-diethylchlorosilyl-bicyclo[2.2.1]hept-2-ene, 5-ethyldichlorosilyl-bicyclo[2.2.1]hept-2-ene, 5-(2-trimethoxysilyl)ethyl-bicyclo[2.2.1]hept-2-ene, 5-(2-dimethoxychlorosilyl)ethyl-bicyclo[2.2.1]hept-2-ene, 5-(1-trimethoxysilyl)ethyl-bicyclo[2.2.1]hept-2-ene, 5-(2-trimethoxysilyl)propyl-bicyclo[2.2.1]hept-2-ene, 5-(1-trimethoxysilyl)propyl-bicyclo[2.2.1]hept-2-ene, 5-triethoxysilylethyl-bicyclo[2.2.1]hept-2-ene, 5-dimethoxymethylsilylmethyl-bicyclo[2.2.1]hept-2-ene, 5-trimethoxypropylsilyl-bicyclo[2.2.1]hept-2-ene, 5-methyl-5-(3-triethoxysilyl)propoxycarbonyl-bicyclo[2.2.1]hept-2-ene, 8-triethoxysilyl-tetracyclo[4.4.0.1^{2,5}.1^{7,10}]dodec-3-ene, 8-methyldimethoxysilyl-tetracyclo[4.4.0.1^{2,5}.1^{7,10}]dodec-3-ene, 5-[1′-methyl-2′,5′-dioxa-1′-silacyclopentyl]-bicyclo[2.2.1]hept-2-ene, 5-[1′-methyl-3′, 3′,4′,4′-tetraphenyl-2′,5′-dioxa-1′-silacyclopentyl]-bicyclo[2.2.1]hept-2-ene, 5-[1′-methyl-3′, 3′,4′,4′-tetramethyl-2′,5-dioxa-1′-silacyclopentyl]-bicyclo[2.2.1]hept-2-ene, 5-[1′-phenyl-2′,5′-dioxa-1′-silacyclopentyl]-bicyclo[2.2.1]hept-2-ene, 5-[1′-ethyl-2′,5′-dioxa-1′-silacyclopentyl]-bicyclo[2.2.1]hept-2-ene, 5-[1′,3′-dimethyl-2′,5′-dioxa-1′-silacyclopentyl]-bicyclo[2.2.1]hept-2-ene, 5-[1′-methyl-3′,4′-dimethyl-2′,5′-dioxa-1′-silacyclopentyl]-bicyclo[2.2.1]hept-2-ene, 5-[1′-methyl-2′,6′-dioxa-1′-silacyclohexyl]-bicyclo[2.2.1]hept-2-ene, 5-[1′-ethyl-2′,6′-dioxa-1′-silacyclohexyl]-bicyclo[2.2.1]hept-2-ene, 5-[1′,3′-dimethyl-2′,6′-dioxa-1′-silacyclohexyl]-bicyclo[2.2.1]hept-2-ene, 5-[1′-methyl-4′,4′-dimethyl-2′,6′-dioxa-1′-silacyclohexyl]-bicyclo[2.2.1]hept-2-ene, 5-[1′-methyl-4′,4′-dimethyl-2′,6′-dioxa-1′-silacyclohexyl]methyl-bicyclo[2.2.1]hept-2-ene, 5-[1′-methyl-4′,4′-dimethyl-2′,6′-dioxa-1′-silacyclohexyl]ethyl-bicyclo[2.2.1]hept-2-ene, 5-[1′-phenyl-4′,4′-dimethyl-2′,6′-dioxa-1′-silacyclohexyl]-bicyclo[2.2.1]hept-2-ene, 5-[1′-methyl-4′-phenyl-2′,6′-dioxa-1′-silacyclohexyl]-bicyclo[2.2.1]hept-2-ene, 5-[1′-methyl-4′-spiro-cyclohexyl-2′,6′-dioxa-1′-silacyclohexyl]-bicyclo[2.2.1]hept-2-ene, 5-[1′-methyl-4′-ethyl-4′-butyl-2′,6′-dioxa-1′-silacyclohexyl]-bicyclo[2.2.1]hept-2-ene, 5-[1′-methyl-3′,3′-dimethyl-5′methylene-2′,6-dioxa-1′-silacyclohexyl]-bicyclo[2.2.1]hept-2-ene, 5-[1′-phenyl-2′,6′-dioxa-1′-silacyclohexyl]-bicyclo[2.2.1]hept-2-ene, 5-[1′-methyl-3′-phenyl-2′,6-dioxa-1′-silacyclohexyl]-bicyclo[2.2.1]hept-2-ene, 5-[1′-methyl-4′,4′-dimethyl-2′,6-dioxa-1′-silacyclohexyl]-7-oxa-bicyclo[2.2.1]hept-2-ene, 5-[1′-methyl-2′,6′-dioxa-1′-silacyclohexyl]-7-oxa-bicyclo[2.2.1]hept-2-ene, 5-[1′-methyl-2′,7′-dioxa-1′-silacycloheptyl]-bicyclo[2.2.1]hept-2-ene, 8-[1′-methyl-4′,4′-dimethyl-2′,6′-dioxa-1′-silacyclohexyl]-tetracyclo[4.4.0.1^{2,5}.1^{7,10}]dodec-3-ene, 8-[1′-methyl-2′,6′-dioxa-1′-silacyclohexyl]-tetracyclo[4.4.0.1^{2,5}.1^{7,10}]dodec-3-ene, and 8-methyl-8-methoxycarbonyl-9-methoxycarbonyl tetracyclo[4.4.0.1^{2,5}.1^{7,10}]-3-dodecene. These ‘particular monomers (2)’ may be used singly or in a combination of two or more types.

The proportion of the structural unit (b) contained in the cyclic olefin-based polymer that can be used in the present invention is 30 to 99 mol % of the entire structural units, preferably 40 to 95 mol %, and more preferably 50 to 90 mol %. When the proportion of the structural unit (b) of the cyclic olefin-based polymer is in the above-mentioned range, the adhesion and intimacy of contact with polyvinyl alcohol used in the polarizer are good, the hygroscopicity does not increase, and the dimensional stability is excellent. The arrangement of the structural unit (b) in the cyclic olefin-based polymer is not limited and can be a random form, a block form, etc., and the random form is preferable. Furthermore, a cyclic olefin-based addition polymer containing a structural unit (b) having, as a side chain substituent, a reactive substituent such as a hydrolyzable silyl group, an ester group, an acryloyl group, or a methacryloyl group enables a crosslinked film of the cyclic olefin-based polymer of the present invention to be made by using a crosslinking agent, which will be described later.

The cyclic olefin-based polymer that can be used in the present invention may further contain a structural unit (c) that can be obtained by addition polymerization of a ‘particular α-olefin compound’.

Specific examples of such a ‘particular α-olefin compound’ include ethylene, propylene, 1-butene, 1-hexene, 1-octene, trimethylsilylethylene, triethylsilylethylene, and styrene, and ethylene is preferable.

By introducing the repeating unit (c) derived from the ‘particular α-olefin compound’ into the polymer, the glass transition temperature of the cyclic olefin-based polymer that can be used in the present invention can be controlled. The proportion of the repeating unit (c) contained in the cyclic olefin-based polymer that can be used in the present invention is 0 to 30 mol %, and preferably 0 to 20 mol %. It is preferable if the proportion of the repeating unit (c) is in the above-mentioned range, since the glass transition temperature of the cyclic olefin-based polymer that can be used in the present invention is then greater than 170° C., and the heat resistance does not deteriorate.

The molecular weight of the cyclic olefin-based polymer that can be used in the present invention can be expressed on a polystyrene basis; the number-average molecular weight is preferably 10,000 to 300,000, the weight-average molecular weight is preferably 20,000 to 700,000, the number-average molecular weight is more preferably 20,000 to 200,000, the weight-average molecular weight is more preferably 50,000 to 500,000, the number-average molecular weight is yet more preferably 50,000 to 150,000, and the weight-average molecular weight is yet more preferably 100,000 to 300,000. If the number-average molecular weight and the weight-average molecular weight are in the above-mentioned ranges, when a film is made, the toughness is excellent, it is resistant to breaking, the solution viscosity does not increase, the workability of film formation by the solution casting method is good, and the film surface properties are good.

The glass transition temperature of the cyclic olefin-based polymer that can be used in the present invention is preferably 180° C. to 450° C. when in an uncrosslinked state, and more preferably 200° C. to 400° C. If the glass transition temperature of the polymer is in the above-mentioned range, the heat resistance is sufficient, the toughness of the film is excellent, and it is resistant to breaking.

The cyclic olefin-based polymer that can be used in the present invention is produced by mainly using the ‘particular monomer (1)’, using the ‘particular monomer (2)’ as necessary in order to form crosslinking or impart adhesion and intimacy of contact, and further using the ‘particular α-olefin compound’ as necessary in order to control the glass transition temperature. The production method therefor is explained below.

With regard to a polymerization catalyst, a single complex catalyst or a multicomponent catalyst of palladium, nickel, cobalt, titanium, zirconium, etc. shown in [1], [2], and [3] below can be cited, but the present invention is not limited thereto.

[1] Single complex catalysts of Pd, Ni, etc.: [Pd(CH₃CN)₄][BF₄]₂, [Pd(PhCN)₄][SbF₆], [(η³-crotyl) Pd (cyclooctadiene)][PF₆], [(η³-crotyl)Ni(cycloocta-1,5-diene)][B(3,5-(CF₃)₂C₆F₃)₄], [(η³-crotyl)Ni(cycloocta-1,5-diene)][PF₆], [(η³-allyl)Ni(cycloocta-1,5-diene)][B(C₆F₅)₄], [(η³-crotyl)Ni(cycloocta-1,5-diene)][SbF₆], a Ni(C₆F₅)₂.toluene complex, a Ni(C₆F₅)₂.benzene complex, a Ni(C₆F₅)₂.mesitylene complex, and a Ni(C₆F₅)₂.diethyl ether complex,

[2] Multicomponent catalysts having a combination of a palladium complex having a σ bond or σ and π bonds and an organoaluminum or a superacid salt: a combination of di-μ-chloro-bis(6-methoxybicyclo[2.2.1]hept-2-ene-endo-5σ,2π) Pd and a compound selected from methylalumoxane (abbreviated to MAO), AgSbF₆, and AgBF₄, a combination of [(η³-allyl)PdCl]₂ and AgSbF₆ or AgBF₄, and a combination of [(1,5-cyclooctadiene)Pd(CH₃)Cl], PPh₃, and NaB[3,5-(CF₃)₂C₆H₃]₄.

[3] Multicomponent-based catalysts containing 1) a transition metal compound selected from a nickel compound, a cobalt compound, a titanium compound, and a zirconium compound, 2) a compound selected from a superacid, a Lewis acid, and an ionic boron compound, and 3) an organoaluminum compound.

### 1) Transition Metal Compound

### 1)-1 Nickel Compound, Cobalt Compound:

At least one type of compound selected from the groups below, compounds selected from a nickel or cobalt organic carboxylic acid salt, organic phosphorous acid salt, organic phosphoric acid salt, organic sulfonic acid salt, β-diketone compound, etc. Examples thereof include nickel 2-ethylhexanoate, nickel naphthenate, cobalt naphthenate, nickel oleate, nickel dodecanoate, cobalt dodecanoate, cobalt neodecanoate, nickel dodecylbenzenesulfonate, bis(acetylacetonate)nickel, and bis(ethylacetoacetate)nickel. A compound obtained by modifying the above-mentioned organic carboxylic acid salts of nickel with a superacid such as hexafluoroantimonic acid, tetrafluoroboronic acid, trifluoroacetic acid, or hexafluoroacetone, a diene or triene coordination complex of nickel, that is, nickel complexes such as, for example, dichloro(1,5-cyclooctadiene)nickel, [(η³-crotyl)(1,5-cyclooctadiene)nickel]hexafluorophosphate, and its tetrafluoroborate, a tetrakis[3,5-bis(trifluoromethyl)]borate complex, (5,9-cyclododecatriene)nickel, bis(norbornadiene)nickel, and bis(1,5-cyclooctadiene)nickel, complexes in which a ligand having an atom such as P, N, or O coordinates to nickel or cobalt, that is, nickel or cobalt complexes such as, for example, bis(triphenylphosphine)nickel dichloride, bis(triphenylphosphine)nickel dibromide, bis(triphenylphosphine)cobalt dibromide, bis[N-(3-t-butylsalicylidene)phenylaminate]nickel, Ni[PhC(O)CH](Ph), Ni(OC(C₆H₄)PPh)(H)(PCy₃), Ni[OC(O)(C₆H₄)P](H)(PPh₃), a reaction product between bis(1,5-cyclooctadiene)nickel and PhC(O)CH═PPh₃, and 6-(i-Pr)₂C₆H₃N═CHC₆H₃(O)(Anth)](Ph)(PPh₃)Ni (here, Anth denotes 9-anthracenyl, Ph denotes phenyl, and Cy denotes cyclohexyl).

### 1)-2 Titanium Compound, Zirconium Compound:

Examples include [t-BuNSiMe(Me₄ Cp)]TiCl₂, (Me₄ Cp)(o-iPr₂C₆H₃)₂TiCl, (Me₄ Cp)TiCl₃, (Me₄ Cp)Ti(OBu)₃, [t-BuNSiMeFlu]TiMe₂, [t-BuNSiMeFlu]TiCl₂, Et(Ind)₂ZrCl₂, Ph₂C(Ind) (Cp)ZrCl₂, iPr(Cp) (Flu)ZrCl₂, iPr(3-t-BuCp) (Ind)ZrCl₂, iPr(Cp)(Ind)ZrCl₂, Me₂Si(Ind)₂ZrCl₂, and Cp₂ZrCl₂, [Bu denotes butyl, Me denotes methyl, Et denotes ethylene-brigded, Cp denotes cyclopentadienyl, iPr denotes isopropyl, Ind denotes indenyl, and Flu denotes fluorenyl].

2) Compound Selected from Superacid, Lewis Acid Compound, and Ionic Boron Compound:

Examples of the superacid include hexafluoroantimonic acid, hexafluorophosphoric acid, hexafluoroarsenic acid, trifluoroacetic acid, fluorosulfuric acid, trifluoromethanesulfonic acid, tetrafluoroboric acid, tetrakis(pentafluorophenyl)boric acid, tetrakis[3,5-bis(trifluoromethyl)phenyl]boric acid, p-toluenesulfonic acid, and pentafluoropropionic acid.

Examples of the Lewis acid compound include a complex of boron trifluoride with an ether, an amine, a phenol, etc., a complex of aluminum trifluoride with an ether, an amine, a phenol, etc., a boron compound such as tris(pentafluorophenyl)borane or tris[3,5-bis(trifluoromethyl)phenyl]borane, an aluminum compound such as aluminum trichloride, aluminum tribromide, ethylaluminum dichloride, ethylaluminum sesquichloride, diethylaluminum fluoride, or tri(pentafluorophenyl)aluminum, an organohalogen compound exhibiting Lewis acidity such as hexafluoroacetone, hexachloroacetone, chloranil, or hexafluoro methyl ethyl ketone, and a compound exhibiting Lewis acidity such as titanium tetrachloride or pentafluoroantimony.

Examples of the ionic boron compound include triphenylcarbenium tetrakis(pentafluorophenyl)borate, triphenylcarbenium tetrakis[3,5-bis(trifluoromethyl)phenyl]borate, triphenylcarbenium tetrakis(2,4,6-trifluorophenyl)borate, triphenylcarbenium tetraphenylborate, tributylammonium tetrakis(pentafluorophenyl)borate, N,N-dimethylanilinium tetrakis(pentafluorophenyl)borate, N,N-diethylanilinium tetrakis(pentafluorophenyl)borate, and N,N-diphenylanilinium tetrakis(pentafluorophenyl)borate.

3) Examples of the organoaluminum compound include alkylalumoxane compounds such as methylalumoxane, ethylalumoxane, and butylalumoxane, alkylaluminum compounds such as trimethylaluminum, triethylaluminum, triisobutylaluminum, diisobutylaluminum hydride, diethylaluminum chloride, diethylaluminum fluoride, ethylaluminum sesquichloride, and ethylaluminum dichloride, haloalkylaluminum compounds, and mixtures of the above-mentioned alkylalumoxane compound and the above-mentioned alkylaluminum compound.

These single complex catalyst or multicomponent catalyst components are preferably used in the range of amounts below. With regard to transition metal compounds such as a nickel compound, a palladium compound, a cobalt compound, a titanium compound, and a zirconium compound, it is preferably 0.02 to 100 mmol atom per mole of the monomer, with regard to the organoaluminum compound, it is preferably 1 to 5,000 mole per mole atom of the transition metal compound, and with regard to the superacid, the Lewis acid, and the ionic boron compound, it is preferably 0 to 100 mole per mole atom of the transition metal compound.

The cyclic olefin-based polymer that can be used in the present invention can be obtained by carrying out polymerization using a single complex catalyst or a multicomponent catalyst comprising the above-mentioned components in one or more types of solvent selected from an alicyclic hydrocarbon solvent such as cyclohexane, cyclopentane, or methylcyclopentane, an aliphatic hydrocarbon solvent such as hexane, heptane, or octane, an aromatic hydrocarbon solvent such as toluene, benzene, xylene, or mesitylene, and a halohydrocarbon solvent such as dichloromethane, 1,2-dichloroethane, 1,1-dichloroethane, tetrachloroethane, chlorobenzene, or dichlorobenzene in a temperature range of −20° C. to 120° C.

### (Cycloolefin-Based Ring-Opened Polymer)

As the cycloolefin-based polymer that can be used in the present invention, a ring-opened polymer having a monomer unit of Formulae (5) and (6) below may preferably be used.

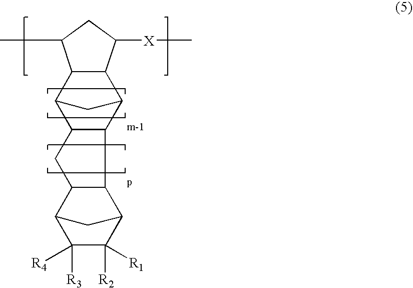

(In Formula (5), m is an integer of 1 or greater, p is an integer of 0 or 1 or greater, X denotes a vinylene group (—CH═CH—) or an ethylene group (—CH₂CH₂—), R₁ to R₄ independently denote a hydrogen atom; a halogen atom; a substituted or unsubstituted hydrocarbon group having 1 to 30 carbon atoms, which may have a linking group including an oxygen atom, a nitrogen atom, a sulfur atom, or a silicon atom; or a polar group.

Furthermore, R₁ and R₂, R₃ and R₄, or R₂ and R₃ may be bonded to each other to form a carbon ring or a hetero ring having a monocyclic structure or a polycyclic structure in which another ring is condensed, and the carbon ring or the hetero ring thus formed may be an aromatic ring or a non-aromatic ring.)

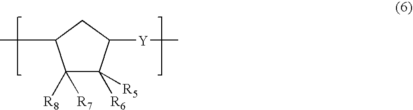

(In Formula (6), Y denotes a vinylene group (—CH═CH—) or an ethylene group (—CH₂CH₂—), R₅ to R₈ independently denote a hydrogen atom; a halogen atom; a substituted or unsubstituted hydrocarbon group having 1 to 30 carbon atoms, which may have a linking group including an oxygen atom, a nitrogen atom, a sulfur atom, or a silicon atom; or a polar group. Furthermore, R₅ and R₆, R₇ and R₈, or R₆ and R₇ may be bonded to each other to form a carbon ring or a hetero ring having a monocyclic structure or a polycyclic structure in which another ring is condensed (however, the structure represented by Formula (5) is excluded), and the carbon ring or the hetero ring thus formed may be an aromatic ring or a non-aromatic ring.)

The polymer of Formulae (5) and (6) above may be synthesized as a (co)polymer (hereinafter, also called ‘particular polymer’) of monomers represented by (A) to (D) below.

(A) a ring-opened polymer of a compound represented by Formula (7) below (hereinafter, also called ‘particular monomer d’).
(B) a ring-opened polymer of the particular monomer d and a compound that can be copolymerized with the particular monomer d (hereinafter, also called a ‘copolymerizable monomer’).
(C) a hydrogenated product of the ring-opened polymer of (A) above or the ring-opened polymer of (B) above.
(D) a compound obtained by cyclization of the ring-opened polymer of (A) above or the ring-opened polymer of (B) above by a Friedel-Crafts reaction, or a hydrogenated product thereof.

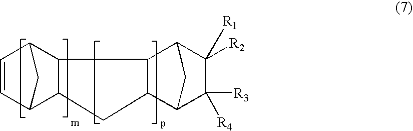

(In Formula (7), m is an integer of 1 or greater, p is an integer of 0 or 1 or greater, R₁ to R₄ independently denote a hydrogen atom; a halogen atom; a substituted or unsubstituted hydrocarbon group having 1 to 30 carbon atoms, which may have a linking group including an oxygen atom, a nitrogen atom, a sulfur atom, or a silicon atom; or a polar group. Furthermore, R₁ and R₂, R₃ and R₄, or R₂ and R₃ may be bonded to each other to form a carbon ring or a hetero ring having a monocyclic structure or a polycyclic structure in which another ring is condensed, and the carbon ring or the hetero ring thus formed may be an aromatic ring or a non-aromatic ring.)

The particular polymer is preferably one obtained by copolymerization of the particular monomer d and the particular monomer e using, as the copolymerizable monomer, a compound represented by Formula (8) below (hereinafter, also called ‘particular monomer e’). In accordance with the particular polymer having such a constitution, the particular retardation film finally obtained has yet further excellent mechanical properties such as toughness, and a desired phase difference necessary for the particular retardation film can easily be obtained by stretching processing.

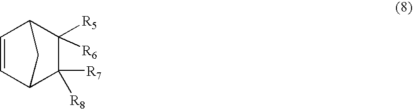

(In Formula (8), R₁ to R₄ independently denote a hydrogen atom; a halogen atom; a substituted or unsubstituted hydrocarbon group having 1 to 30 carbon atoms, which may have a linking group including an oxygen atom, a nitrogen atom, a sulfur atom, or a silicon atom; or a polar group. Furthermore, R₁ and R₂, R₃ and R₄, or R₂ and R₃ may be bonded to each other to form a carbon ring or a hetero ring having a monocyclic structure or a polycyclic structure in which another ring is condensed (however, the structure represented by Formula (5) is excluded), and the carbon ring or the hetero ring thus formed may be an aromatic ring or a non-aromatic ring.)

Furthermore, the particular polymer is preferably a ring-opened polymer of the particular monomer d and the particular monomer e, and has a structural unit, derived from the particular monomer d, represented by Formula (5) above (hereinafter, also called ‘structural unit d’) and a structural unit, derived from the particular monomer e, represented by Formula (6) above (hereinafter, also called ‘structural unit e’). The particular polymer having such a constitution is preferable in terms of the balance between heat resistance and thermal processability such as stretching processing.

Examples of the halogen atom of Formula (5) to Formula (8) include a fluorine atom, a chlorine atom, and a bromine atom.

Examples of the hydrocarbon group having 1 to 30 carbon atoms include an alkyl group such as a methyl group, an ethyl group, or a propyl group; a cycloalkyl group such as a cyclopentyl group or a cyclohexyl group; and an alkenyl group such as a vinyl group, an allyl group, or a propenyl group.

Furthermore, the substituted or unsubstituted hydrocarbon group in Formula (5) to Formula (8) may be bonded to a cyclic structure directly or via a linking group (linkage).

Examples of the linking group include a divalent hydrocarbon group having 1 to 10 carbon atoms (for example, an alkylene group represented by —(CH₂)_{q}— (in the formula, q is an integer of 1 to 10)); a linking group containing an oxygen atom, a nitrogen atom, a sulfur atom, or a silicon atom (for example, a carbonyl group (—CO—), an oxycarbonyl group (—O(CO)—), a sulfone group (—SO₂—), an ether bond (—O—), a thioether bond (—S—), an imino group (—NH—), an amide bond (—NHCO—, —CONH—), or a siloxane bond (—OSi(R9)₂— (in the formula, R₉ is an alkyl group such as a methyl group or an ethyl group))), and those in which two or more of the above types are bonded.

Examples of the polar group include a hydroxyl group, an alkoxy group having 1 to 10 carbon atoms, an alkoxycarbonyl group, an aryloxy carbonyl group, a cyano group, an amide group, an imide ring-containing group, a triorganosiloxy group, a triorganosilyl group, an amino group, an acyl group, an alkoxysilyl group, a sulfonyl-containing group, and a carboxyl group. More specifically, examples of the alkoxy group include a methoxy group and an ethoxy group; examples of the alkoxycarbonyl group include a methoxycarbonyl group and an ethoxycarbonyl group; examples of the aryloxycarbonyl group include a phenoxycarbonyl group, a naphthyloxycarbonyl group, a fluorenyloxycarbonyl group, and a biphenylyloxycarbonyl group; examples of the triorganosiloxy group include a trimethylsiloxy group and a triethylsiloxy group; examples of the triorganosilyl group include a trimethylsilyl group and a triethylsilyl group; examples of the amino group include a primary amino group; and examples of the alkoxysilyl group include a trimethoxysilyl group and a triethoxysilyl group.

Specific examples of the particular monomer d include tetracyclo[4.4.0.1^{2,5}.1^{7,10}]-3-dodecene, pentacyclo[9.2.1.1^{3,9}.0^{2,10}.0^{4,8}]-12-pentadecene, pentacyclo[9.2.1.1^{5,8}.0^{2,10}.0^{4,9}]-12-pentadecene, 8-methoxycarbonyltetracyclo[4.4.0.1^{2,5}.1^{7,10}]-3-dodecene, 8-ethoxycarbonyltetracyclo[4.4.0.1^{2,5}.1^{7,10}]-3-dodecene, 8-n-propoxycarbonyltetracyclo[4.4.0.1^{2,5}.1^{7,10}]-3-dodecene, 8-isopropoxycarbonyltetracyclo[4.4.0.1^{2,5}.1^{7,10}]-3-dodecene, 8-n-butoxycarbonyltetracyclo[4.4.0.1^{2,5}.1^{7,10}]-3-dodecene, 8-phenoxycarbonyltetracyclo[4.4.0.1^{2,5}.1^{7,10}]-3-dodecene, 8-methyl-8-methoxycarbonyltetracyclo[4.4.0.1^{2,5}.1^{7,10}]-3-dodecene, 8-methyl-8-ethoxycarbonyltetracyclo[4.4.0.1^{2,5}.1^{7,10}]-3-dodecene, 8-methyl-8-n-propoxycarbonyltetracyclo[4.4.0.1^{2,5}.1^{7,10}]-3-dodecene, 8-methyl-8-isopropoxycarbonyltetracyclo[4.4.0.1^{2,5}.1^{7,10}]-3-dodecene, 8-fluoro-8-pentafluoroethyl-9,9-bis(trifluoromethyl)tetracyclo[4.4.0.1^{2,5}.1^{7,10}]-3-dodecene, 8,9-difluoro-8-heptafluoro-iso-propyl-9-trifluoromethyltetracyclo[4.4.0.1^{2,5}.1^{7,10}]-3-dodecene, 8-chloro-8,9,9-trifluorotetracyclo[4.4.0.1^{2,5}.1^{7,10}]-3-dodecene, 8,9-dichloro-8,9-bis(trifluoromethyl)tetracyclo[4.4.0.1^{2,5}.1^{7,10}]-3-dodecene, 8-(2,2,2-trifluoroethoxycarbonyl)tetracyclo[4.4.0.1^{2,5}.1^{7,10}]-3-dodecene, 8-methyl-8-(2,2,2-trifluoroethoxycarbonyl)tetracyclo[4.4.0.1^{2,5}.1^{7,10}]-3-dodecene, 8-(4-biphenylcarbonyloxymethyl)tetracyclo[4.4.0.1^{2,5}.1^{7,10}]-3-dodecene, 8-(4-biphenylcarbonyloxyethyl)tetracyclo[4.4.0.1^{2,5}.1^{7,10}]-3-dodecene, 8-methyl-8-(4-biphenylcarbonyloxymethyl)tetracyclo[4.4.0.1^{2,5}.1^{7,10}]-3-dodecene, 8-(2-biphenylcarbonyloxymethyl)tetracyclo[4.4.0.1^{2,5}.1^{7,10}]-3-dodecene, 8-methyl-8-(2-biphenylcarbonyloxymethyl)tetracyclo[4.4.0.1^{2,5}1^{7,10}]-3-dodecene, 8-(3-biphenylcarbonyloxymethyl)tetracyclo[4.4.0.1^{2,5}.1^{7,10}]-3-dodecene, 8-methyl-8-(3-biphenylcarbonyloxymethyl)tetracyclo[4.4.0.1^{2,5}.1^{7,10}]-3-dodecene, 8-(1-naphthylcarbonyloxymethyl)tetracyclo[4.4.0.1^{2,5}.1^{7,10}]-3-dodecene, 8-methyl-8-(3-naphthylcarbonyloxymethyl)tetracyclo[4.4.0.1^{2,5}.1^{7,10}]-3-dodecene, 8-(2-naphthylcarbonyloxymethyl)tetracyclo[4.4.0.1^{2,5}.1^{7,10}]-3-dodecene, 8-methyl-8-(2-naphthylcarbonyloxymethyl)tetracyclo[4.4.0.1^{2,5}.1^{7,10}]-3-dodecene, 8-(9-anthracenylcarbonyloxymethyl)tetracyclo[4.4.0.1^{2,5}. 1^{7,10}]-3-dodecene, 8-methyl-8-(9-anthracenylcarbonyloxymethyl)tetracyclo[4.4.0.1^{2,5}.1^{7,10}]-3-dodecene, and a Diels-Alder addition product of 1,2-(2H,3H-[1,3]epicyclopenta)-1,2-dihydroacenaphthylene and cyclopentadiene, but the particular monomer d is not limited to these compounds. These compounds may be used singly or in a combination of two or more types as the particular monomer d.

Among these, a compound having at least one polar group in the molecule is preferable and, in particular, one represented by Formula (7) in which R₁ and R₃ are each a hydrogen atom or a hydrocarbon group having 1 to 10 carbon atoms, and R₂ and R₄ are each a hydrogen atom or one corresponding to a monovalent organic group, at least one of R₂ and R₄ being a polar group other than a hydrogen atom and a hydrocarbon group, is preferable since the intimacy of contact and adhesion with another material are enhanced.

The content of the polar group in the particular polymer obtained is determined according to a desired function, etc. required for a particular retardation film finally obtained and is not particularly limited, but in the entire structural units derived from the particular monomers d, the structural unit derived from the particular monomer d having a polar group is usually 1 mol % or greater, preferably 5 mol % or greater, and yet more preferably 10 mol % or greater, and all of the structural units derived from the particular monomers d may have a polar group.

It is preferable for the particular monomer d to be one represented by Formula (7) in which at least one of R₂ and R₄ has a polar group represented by Formula (9), since it is easy to control the glass transition temperature and the water absorption of the particular polymer obtained.

—(CH₂)ₙCOOR₁₀ (9)

(In Formula (9), n is an integer of 0 to 5 and R₁₀ is a monovalent organic group.)

Specific examples of the monovalent organic group denoted by R₁₀ in Formula (9) include an alkyl group such as a methyl group, an ethyl group, or a propyl group; an aryl group such as a phenyl group, a naphthyl group, an anthracenyl group, or a biphenylyl group; and, furthermore, a monovalent group having an aromatic ring such as a diphenyl sulfone or a fluorene such as tetrahydrofluorene, or having a hetero ring such as a furan ring or an imide ring.

Furthermore, in Formula (9), n is an integer of 0 to 5, preferably an integer of 0 to 2, and more preferably 0, Since the smaller the value of n, the higher the glass transition temperature of the particular polymer obtained, this is preferable and, in particular, the particular monomer d having a value of n of 0 is preferable from the viewpoint of ease of synthesis.

Moreover, the particular monomer d is preferably one represented by Formula (7) in which an alkyl group is further bonded to the carbon atom to which the polar group represented by Formula (9) is bonded, and this enables a balance to be achieved between the heat resistance and the water absorption of the particular polymer obtained. Here, the number of carbon atoms of the alkyl group is preferably 1 to 5, more preferably 1 to 2, and particularly preferably 1.

It is preferable for the particular monomer d to be one represented by Formula (7) in which m is 1 and p is 0, since a particular polymer having a high glass transition temperature can be obtained.

Specific examples of the particular monomer e include bicyclo[2.2.1]hept-2-ene, tricyclo[5.2.1.0^{2,6}]dec-8-ene, tricyclo[6.2.1.0^{2,7}]undec-9-ene, 5-methylbicyclo[2.2.1]hept-2-ene, 5-ethylbicyclo[2.2.1]hept-2-ene, 5-methoxycarbonylbicyclo[2.2.1]hept-2-ene, 5-methyl-5-methoxycarbonylbicyclo[2.2.1]hept-2-ene, 5-phenoxycarbonylbicyclo[2.2.1]hept-2-ene, 5-methyl-5-phenoxycarbonylbicyclo[2.2.1]hept-2-ene, 5-cyanobicyclo[2.2.1]hept-2-ene, 5-ethylidenebicyclo[2.2.1]hept-2-ene, 5-phenylbicyclo[2.2.1]hept-2-ene, 5-(2-naphthyl)bicyclo[2.2.1]hept-2-ene (a form and form), 5-fluorobicyclo[2.2.1]hept-2-ene, 5-fluoromethylbicyclo[2.2.1]hept-2-ene, 5-trifluoromethylbicyclo[2.2.1]hept-2-ene, 5-pentafluoroethylbicyclo[2.2.1]hept-2-ene, 5,5-difluorobicyclo[2.2.1]hept-2-ene, 5,6-difluorobicyclo[2.2.1]hept-2-ene, 5,5-bis(trifluoromethyl)bicyclo[2.2.1]hept-2-ene, 5,6-bis(trifluoromethyl)bicyclo[2.2.1]hept-2-ene, 5-methyl-5-trifluoromethylbicyclo[2.2.1]hept-2-ene, 5,5,6-trifluorobicyclo[2.2.1]hept-2-ene, 5,5,6-tris(fluoromethyl)bicyclo[2.2.1]hept-2-ene, 5,5,6,6-tetrafluorobicyclo[2.2.1]hept-2-ene, 5,5,6,6-tetrakis(trifluoromethyl)bicyclo[2.2.1]hept-2-ene, 5,5-difluoro-6,6-bis(trifluoromethyl)bicyclo[2.2.1]hept-2-ene, 5,6-difluoro-5,6-bis(trifluoromethyl)bicyclo[2.2.1]hept-2-ene, 5,5,6-trifluoro-5-trifluoromethyl bicyclo[2.2.1]hept-2-ene, 5-fluoro-5-pentafluoroethyl-6,6-bis(trifluoromethyl)bicyclo[2.2.1]hept-2-ene, 5,6-difluoro-5-heptafluoro-iso-propyl-6-trifluoromethyl bicyclo[2.2.1]hept-2-ene, 5-chloro-5,6,6-trifluorobicyclo[2.2.1]hept-2-ene, 5,6-dichloro-5,6-bis(trifluoromethyl)bicyclo[2.2.1]hept-2-ene, 5,5,6-trifluoro-6-trifluoromethoxybicyclo[2.2.1]hept-2-ene, 5,5,6-trifluoro-6-heptafluoropropoxybicyclo[2.2.1]hept-2-ene, 5-(4-phenylphenyl)bicyclo[2.2.1]hept-2-ene, 4-(bicyclo[2.2.1]hept-5-en-2-yl)phenylsulfonylbenzene, 5-(4-biphenylcarbonyloxymethyl)bicyclo[2.2.1]hept-2-ene, 5-(4-biphenylcarbonyloxyethyl)bicyclo[2.2.1]hept-2-ene, 5-(4-biphenylcarbonyloxypropyl)bicyclo[2.2.1]hept-2-ene, 5-methyl-5-(4-biphenylcarbonyloxymethyl)bicyclo[2.2.1]hept-2-ene, 5-(2-biphenylcarbonyloxymethyl)bicyclo[2.2.1]hept-2-ene, 5-(2-biphenylcarbonyloxyethyl)bicyclo[2.2.1]hept-2-ene, 5-methyl-5-(2-biphenylcarbonyloxymethyl)bicyclo[2.2.1]hept-2-ene, 5-(3-biphenylcarbonyloxymethyl)bicyclo[2.2.1]hept-2-ene, 5-(3-biphenylcarbonyloxyethyl)bicyclo[2.2.1]hept-2-ene, 5-(1-naphthylcarbonyloxymethyl)bicyclo[2.2.1]hept-2-ene, 5-(1-naphthylcarbonyloxyethyl)bicyclo[2.2.1]hept-2-ene, 5-methyl-5-(1-naphthylcarbonyloxymethyl)bicyclo[2.2.1]hept-2-ene, 5-(2-naphthylcarbonyloxymethyl)bicyclo[2.2.1]hept-2-ene, 5-(2-naphthylcarbonyloxyethyl)bicyclo[2.2.1]hept-2-ene, 5-methyl-5-(2-naphthylcarbonyloxymethyl)methylbicyclo[2.2.1]hept-2-ene, 5-(9-anthracenylcarbonyloxymethyl)bicyclo[2.2.1]hept-2-ene, 5-(9-anthracenylcarbonyloxyethyl)bicyclo[2.2.1]hept-2-ene, 5-methyl-5-(9-anthracenylcarbonyloxymethyl)bicyclo[2.2.1]hept-2-ene, and a Diels-Alder addition product of acenaphthylene and cyclopentadiene, but the particular monomer e is not limited to these compounds. These compounds may be used singly or in a combination of two or more types as the particular monomer e.

The particular polymer obtained by copolymerization of the particular monomer d and the particular monomer e may be a copolymer obtained by copolymerization with an additional copolymerizable monomer other than the particular monomer d and the particular monomer e.

Examples of the additional copolymerizable monomer include cycloolefins such as cyclobutene, cyclopentene, cycloheptene, cyclooctene, and dicyclopentadiene. The number of carbon atoms of the cycloolefin is preferably 4 to 20, and more preferably 5 to 12. Furthermore, the particular monomer d, and the particular monomer e as necessary, may be polymerized in the presence of an unsaturated hydrocarbon-based polymer, etc. having an olefinically unsaturated bond in the main chain such as polybutadiene, polyisoprene, a styrene-butadiene copolymer, an ethylene-nonconjugated diene copolymer, or polynorbornene, and the particular polymer thus obtained is useful as a starting material for a resin having high impact resistance.

The inherent viscosity (ηᵢₙₕ) of the particular polymer measured in chloroform at 30° C. is preferably 0.2 to 5 dl/g. It is more preferably 0.3 to 4 dl/g, and particularly preferably 0.5 to 3 dl/g. If it is in the above-mentioned range, since the solution viscosity is not high, the processability is good, and the film strength is sufficient.

With regard to the molecular weight of the particular polymer, the number-average molecular weight (Mn) measured by polystyrene-calibrated gel permeation chromatography (GPC) is usually 8,000 to 1,000,000, preferably 10,000 to 500,000, more preferably 20,000 to 100,000, and particularly preferably 30,000 to 100,000, and the weight-average molecular weight (Mw) is usually 20,000 to 3,000,000, preferably 30,000 to 1,000,000, more preferably 40,000 to 500,000, and particularly preferably 40,000 to 300,000.

Furthermore, the molecular weight distribution of the particular polymer is usually 1.5 to 10 for the Mw/Mn ratio, preferably 2 to 8, more preferably 2.5 to 5, and particularly preferably 2.5 to 4.5.

The glass transition temperature (Tg) of the particular polymer can be changed appropriately by, for example, adjusting the types of structural unit d and structural unit e of the particular polymer or the ratio of the structural unit d and the structural unit e, or by the addition of an additive, etc., but it is usually 100° C. to 250° C., preferably 110° C. to 200° C., and more preferably 120° C. to 180° C. When the Tg is 100° C. or greater, the thermal deformation temperature does not become low, no problem might occur with the heat resistance, and the optical properties of the finally obtained film might be little affected by temperature. If the Tg is 250° C. or less, when it is processed by heating in the vicinity of the Tg during stretching processing, etc., the possibility that a thermoplastic cyclic olefin-based resin, preferably norbornene-based resin, might be thermally degraded becomes low.

With regard to the particular polymer having the structural unit d and the structural unit e, the ratio (d/e) of the structural unit d to the structural unit e is preferably d/e=95/5 to 5/95 as a molar ratio, and more preferably 95/5 to 60/40. If the proportion of the structural unit d is in the above-mentioned range, there are cases in which the effect in improving the toughness and the desired optical properties can be sufficiently expected, and there are cases in which the glass transition temperature does not decrease and no problem might occur with the heat resistance.

Furthermore, with regard to the particular polymer having the structural unit d and the structural unit e, it is preferable that variation of the ratio of the structural unit d and the structural unit e in this polymer (composition ratio) over the entire molecular weight distribution range is small. Specifically, by confining variation of the composition ratio at a given molecular weight in terms of the ratio of the particular monomer d and the particular monomer e supplied to a polymerization reaction to within ±50%, preferably within ±30%, and more preferably within ±20%, a still more uniform particular retardation film can be obtained. By confining it within such a range, when carrying out stretching and aligning, the phase difference can be made yet more uniform.

Conditions for producing a particular polymer by ring-opening copolymerization of the particular monomer d, and as necessary the particular monomer e or an additional copolymerizable monomer, or by ring-opening copolymerization of these monomers followed by hydrogenation of the ring-opened copolymer obtained, are explained below.

### Ring-Opening Polymerization Catalyst:

A ring-opening polymerization reaction of monomers is carried out in the presence of a metathesis catalyst.

This metathesis catalyst is a catalyst combining (a) at least one type selected from compounds of W, Mo, and Re, and (b) at least one type selected from compounds of an element of group IA in the Deming periodic table (for example, Li, Na, K, etc.), an element of group IIA (for example, Mg, Ca, etc.), an element of group IIB (for example, Zn, Cd, Hg, etc.), an element of group IIIB (for example, B, Al, etc.), an element of group IVA (for example, Ti, Zr, etc.), and an element of group IVB (for example, Si, Sn, Pb, etc.), and having at least one bond between said element and carbon or between said element and hydrogen. In this case, in order to enhance the activity of the catalyst, an additive (c), which will be described later, may be added.

Representative examples of the appropriate compound of W, Mo, or Re as the component (a) include compounds described in JP-A-1-240517 such as WCl₆, MoCl₅, and ReOCl₃.

Specific examples of the component (b) include compounds described in JP-A-1-240517 such as n-C₄H₉Li, (C₂H₅)₃ Al, (C₂H₅)₂AlCl, (C₂H₅)_{1.5}AlCl_{1.5}, (C₂H₅)AlCl₂, methylalumoxane, and LiH.

Suitably usable representative examples of the component (c) include alcohols, aldehydes, ketones, and amines and, furthermore, compounds described in JP-A-1-240517 may be used.

The amount of metathesis catalyst used is usually in the range of 1:500 to 1:50,000, and preferably in the range of 1:1,000 to 1:10,000, expressed as component (a): particular monomer, that is, molar ratio of the component (a) to the particular monomer d and the particular monomer e (hereinafter, the two are together called ‘particular monomer’).

The ratio of the component (a) to the component (b) is in the range of 1:1 to 1:50, and preferably 1:2 to 1:30, expressed as a metal atom ratio ‘(a):(b)’.

The ratio of the component (a) to the component (c) is in the range of 0.005:1 to 15:1, and preferably 0.05:1 to 7:1, expressed as a molar ratio ‘(c):(a)’.

### Molecular Weight Adjusting Agent:

The molecular weight of the particular polymer can be adjusted by the polymerization temperature, the type of catalyst, and the type of solvent, and in the present invention it is preferable to carry out the adjustment by adding a molecular weight adjusting agent to a reaction system. Preferred examples of the molecular weight adjusting agent include α-olefins such as ethylene, propene, 1-butene, 1-pentene, 1-hexene, 1-heptene, 1-octene, 1-nonene, and 1-decene, and styrene, and among these 1-butene and 1-hexene are preferable.

These molecular weight adjusting agents may be used singly or in a combination of two or more types.

The amount of molecular weight adjusting agent used is 0.005 to 0.6 mole per mole of the particular monomer supplied to a polymerization reaction, and preferably 0.02 to 0.5 mole.

### Solvent for Ring-Opening Polymerization Reaction:

Examples of the solvent used in the ring-opening polymerization reaction include alkanes such as pentane, hexane, heptane, octane, nonane, and decane; cycloalkanes such as cyclohexane, cycloheptane, cyclooctane, decalin, and norbornane; aromatic hydrocarbons such as benzene, toluene, xylene, ethylbenzene, and cumene; halohydrocarbon compounds such as chlorobutane, bromohexane, methylene chloride, dichloroethane, hexamethylene dibromide, chlorobenzene, chloroform, and tetrachloroethylene; saturated carboxylic acid esters such as ethyl acetate, n-butyl acetate, iso-butyl acetate, and methyl propionate; and ethers such as dimethoxyethane, dibutyl ether, and tetrahydrofuran, and these may be used singly or in a combination of two or more types. Among these, the above-mentioned aromatic hydrocarbons are preferable.

The amount of solvent used is an amount such that the solvent: particular monomer (ratio by weight) is usually 1:1 to 10:1, and preferably 1:1 to 5:1.

### Hydrogenation:

The ring-opened copolymer obtained by the ring-opening polymerization above may be used as the particular polymer without further treatment, but it is preferable to hydrogenate the remaining olefinically unsaturated bond in the ring-opened copolymer to give a hydrogenated product.

This hydrogenated product has excellent thermal stability, and the properties thereof are resistant to degradation by heating during film formation processing and stretching processing, or during actual application as a final product. In such a hydrogenated product, the degree of hydrogenation of the olefinically unsaturated bond is 50% or greater, preferably 70% or greater, more preferably 90% or greater, and particularly preferably 98% or greater. Furthermore, when the ring-opened copolymer that is to be hydrogenated has an aromatic ring in the molecule, it is preferable that there is substantially no hydrogenation of this aromatic ring by the hydrogenation.

A hydrogenation reaction is carried out by a standard method, that is, by adding a hydrogenation catalyst to a solution of the ring-opened copolymer, and carrying out a reaction with hydrogen gas at normal pressure to 300 atm, and preferably 3 to 200 atm, at 0° C. to 200° C., and preferably 20° C. to 180° C.

As the hydrogenation catalyst, those usually used in a hydrogenation reaction of an olefinic compound may be used. With regard to this hydrogenation catalyst, heterogeneous catalysts and homogeneous catalysts are known. When a ring-opened polymer having a substituent with an aromatic ring in the molecule is hydrogenated, it is preferable to select conditions under which there is substantially no hydrogenation of unsaturated bonds of the aromatic ring. Examples of the heterogeneous catalyst include solid catalysts in which a precious metal such as palladium, platinum, nickel, rhodium, or ruthenium is supported on a support such as carbon, silica, alumina, or titania. Examples of the homogeneous catalyst include nickel naphthenate/triethylaluminum, nickel acetylacetonate/triethylaluminum, cobalt octenate/n-butyllithium, titanocene dichloride/diethylaluminum monochloride, rhodium acetate, chlorotris(triphenyl phosphine)rhodium, dichlorotris(triphenylphosphine) ruthenium, chlorohydrocarbonyltris(tri phenylphosphine)ruthenium, and dichlorocarbonyltris(triphenylphosphine)ruthenium. The catalyst may be in the form of a powder or granules.

These hydrogenation catalysts are used so that the ring-opened polymer:hydrogenation catalyst (ratio by weight) is 1:1×10⁻⁶ to 1:2.

### (Average Log P of Monomer Unit)

Furthermore, the humidity dependence of the modulus of elasticity of the cycloolefin-based polymer film of the present invention can be adjusted by making the hydrophilicity of the monomer unit be in the range of Formula (G) below.

0≦log P(i)'Mi≦4.5 (G)

Here, log P(i) is an octanol/water partition coefficient of an (i)th structural unit, and Mi is a molar fraction of the (i)th structural unit. The octanol/water partition coefficient can be determined by actual measurement or by calculation.

It is more preferable that 1≦log P(i)×Mi≦4, and most preferable that 2≦log P(i)×Mi≦3.5.

If ‘logP (i)×Mi’ is in the above-mentioned range, the change in optical properties and the change in dimensions due to water absorption can be suppressed, and the intimacy of contact with the polyvinyl alcohol of the polarizer is sufficient.

### (Film Production)

In the present invention, a thermoplastic cyclic olefin-based resin, preferably norbornene-based resin, comprising the particular polymer can be molded into a film by a melt molding method, a solution casting method (solvent casting method), etc., but it is preferable to employ the solvent casting method since an unprocessed film has highly uniform thickness and good surface smoothness. With regard to the solvent casting method, for example, a method in which a thermoplastic cyclic olefin-based resin is dissolved or dispersed in a solvent so as to give a film-forming liquid containing an appropriate concentration of the thermoplastic cyclic olefin-based resin, this film-forming liquid is poured onto or applied to an appropriate carrier, dried, and then peeled off from the carrier can be cited.

When the thermoplastic cyclic olefin-based resin is dissolved or dispersed in the solvent, the concentration of the thermoplastic cyclic olefin-based resin is usually adjusted to 0.1 to 90 wt %, preferably 1 to 50 wt %, and more preferably 10 to 35 wt %. If this concentration is in the above-mentioned range, an unprocessed film having a required thickness can be obtained, and when the solvent is removed by drying, it is possible to suppress foaming, etc. accompanying evaporation of the solvent, an unprocessed film having good surface smoothness can be obtained and, furthermore, since the solution viscosity of the film-forming liquid does not become high, a film having uniform thickness and surface state can be obtained.

The viscosity of the film-forming liquid is usually 1 to 1,000,000 (mPa·s) at room temperature, preferably 10 to 100,000 (mPa·s), more preferably 100 to 50,000 (mPa·s), and particularly preferably 1,000 to 40,000 (mPa·s).

Examples of the solvent used for preparation of the film-forming liquid include aromatic-based solvents such as benzene, toluene, and xylene, cellosolve-based solvents such as methyl cellosolve, ethyl cellosolve, and 1-methoxy-2-propanol, ketone-based solvents such as diacetone alcohol, acetone, cyclohexanone, methyl ethyl ketone, 4-methyl-2-pentanone, and ethyl cyclohexanone, ester-based solvents such as methyl lactate and ethyl lactate, halogen-containing solvents such as 2,2,3,3-tetrafluoro-1-propanol, methylene chloride, and chloroform, ether-based solvents such as tetrahydrofuran and dioxane, alcohol-based solvents such as 1-pentanol and 1-butanol, and 1,2-dimethylcyclohexane.

Other than the above-mentioned solvents, if a solvent having an SP value (solubility parameter) usually in the range of 10 to 30 (MPa^{1/2}), preferably 10 to 25 (MPa¹¹²), more preferably 15 to 25 (MPa^{1/2}), and particularly preferably 15 to 20 (MPa¹²) is used, a processed film having good surface uniformity and optical properties can be obtained.

The above-mentioned solvents may be used singly or in a combination of two or more types. When two or more types of solvents are used in combination, it is preferable that the SP value of the mixed solvent obtained is within the above-mentioned range. Here, the SP value of the mixed solvent can be determined from a ratio by weight of the solvents forming the mixed solvent; for example, for a mixed solvent obtained from two types of solvents, if the weight fractions of each solvent are W1 and W2, and the SP values thereof are SP1 and SP2, the SP value of the mixed solvent can be calculated from the equation: SP value=W1·SP1+W2·SP2.

When a mixed solvent is used as the solvent for the film-forming liquid, by combining a good solvent and a poor solvent with respect to the thermoplastic cyclic olefin-based resin, preferably norbornene-based resin, an unprocessed film having a light diffusion function can be obtained. Specifically, when the SP value of the thermoplastic cyclic olefin-based resin is denoted by SPx, the SP value of the good solvent for the thermoplastic cyclic olefin-based resin is denoted by SPy, and the SP value of the poor solvent for the thermoplastic cyclic olefin-based resin is denoted by SPz, by setting the difference between SPx and Spy so that it is preferably 7 or less, more preferably 5 or less, and particularly preferably 3 or less, the difference between SPx and SPz so that it is preferably 7 or greater, more preferably 8 or greater, and particularly preferably 9 or greater, and the difference between Spy and SPz so that it is preferably 3 or greater, more preferably 5 or greater, and yet more preferably 7 or greater, it is possible to impart the light diffusion function to an unprocessed film so obtained, and as a result a finally obtained particular retardation film is made to have the light diffusion function.

The proportion of the poor solvent contained in the mixed solvent is preferably 50 wt % or less, more preferably 30 wt % or less, particularly preferably 15 wt % or less, and most preferably 10 wt % or less. Furthermore, the difference between the boiling point of the poor solvent and the boiling point of the good solvent is preferably 1° C. or greater, more preferably 5° C. or greater, particularly preferably 10° C. or greater, and most preferably 20° C. or greater and, in particular, it is preferable that the boiling point of the poor solvent is higher than the boiling point of the good solvent.

The temperature at which the thermoplastic cyclic olefin-based resin, preferably norbornene-based resin, is dissolved or dispersed in a solvent may be room temperature or a high temperature, and by stirring well, a film-forming liquid in which the thermoplastic cyclic olefin-based resin is uniformly dissolved or dispersed can be obtained.

Furthermore, as necessary, a colorant such as a dye or a pigment may be added to the film-forming liquid as appropriate, and this can give a colored unprocessed film.

For the purpose of improving the surface smoothness of an unprocessed film that is to be obtained, a leveling agent may be added to the film-forming liquid. As such a leveling agent, various types may be used as long as they are generally used, and specific examples thereof include a fluorine-based nonionic surfactant, a special acrylic resin-based leveling agent, and a silicone-based leveling agent.

With regard to a carrier for forming a liquid layer of the film-forming liquid, a metal drum, a steel belt, a polyester film formed from polyethylene terephthalate (PET), polyethylene naphthalate (PEN), etc., a polytetrafluoroethylene belt, etc. can be used. As a method for applying the film-forming liquid, a method employing a die or a coater, a spray method, a brushing method, a roll coating method, a spin coating method, a dipping method, etc. may be employed.

Moreover, by repeatedly applying the film-forming liquid it is possible to control the thickness or the surface smoothness of an unprocessed film thus obtained.

Furthermore, when a polyester film is used as the carrier, a surface-treated film may be used.

Examples of the surface treatment method include a standard hydrophilization method such as, for example, a method in which an acrylic-based resin or a sulfonic acid salt group-containing resin is layered by coating or laminating or a method in which the hydrophilicity of the film surface is improved by a corona discharge treatment, etc.

In the solvent casting method, a specific method for removing the solvent from the liquid layer is not particularly limited, and a standard drying method such as, for example, a method in which it is passed through a drying oven using a large number of rollers can be used, but if air bubbles are generated accompanying evaporation of the solvent in the drying step, since the properties of the finally obtained particular retardation film are greatly degraded it is preferable in order to avoid this to divide the drying step into a plurality, that is, two or more steps, and control the temperature or the blowing rate for each step.

The amount of residual solvent in the unprocessed film thus obtained is usually 10 wt % or less, preferably 5 wt % or less, more preferably 1 wt % or less, and particularly preferably 0.5 wt % or less. It is preferable if the amount of residual solvent in the unprocessed film is in the above-mentioned range since the change in dimensions over time is small when a particular retardation film obtained by stretching the unprocessed film is put into practical use. Furthermore, the glass transition temperature is not lowered by the residual solvent, and the heat resistance is not degraded either.

In order to appropriately carry out stretching processing, which will be described later, it is sometimes necessary to adjust the amount of residual solvent in the unprocessed film as appropriate so as to be in the above-mentioned range. Specifically, in order to achieve the film retardation in a stable and uniform manner by a stretching alignment treatment, the amount of residual solvent in the unprocessed film is usually set at 10 to 0.1 wt %, preferably 5 to 0.1 wt %, and more preferably 1 to 0.1 wt %. There are cases in which, by leaving a trace amount of solvent in the unprocessed film, the stretching alignment treatment becomes easy, or control of the retardation becomes easy.

In the present invention, the thickness of the unprocessed film is usually 1 to 500 μm (1,000 to 500,000 nm), preferably 1 to 300 μm (1,000 to 300,000 nm), more preferably 1 to 200 μm (1,000 to 200,000), and most preferably 1 to 100 μm (1,000 to 100,000 nm). If this thickness is in the above-mentioned range, it is easy to handle the unprocessed film, and when the unprocessed film is wound up in the form of a roll, the so-called ‘curling tendency’ is not imparted, and it is easy to handle during post-processing, etc.

Distribution of the thickness of the unprocessed film is usually within ±90% relative to an average value, preferably within ±10%, more preferably within ±5%, and particularly preferably within ±3%. The variation in thickness per cm is usually 10% or less, preferably 5% or less, more preferably 1% or less, and particularly preferably 0.5% or less. By controlling the thickness distribution of the unprocessed film within the above-mentioned range, when the unprocessed film is subjected to the stretching alignment treatment, it is possible to prevent uneven retardation from occurring.

With regard to a specific method for stretching when producing the particular retardation film, a known uniaxial stretching method or biaxial stretching method can be specifically cited.

That is, a sideways uniaxial stretching method employing a tenter method, a compression between rolls and stretching method, a lengthwise uniaxial stretching method employing a combination of two pairs of rolls having different circumferences, a biaxial stretching method employing a combination of sideways uniaxial and lengthwise uniaxial, a stretching method employing an inflation method, etc. may be used.

In the case of the uniaxial stretching method, the stretching speed is usually 1 to 5,000%/min, preferably 50 to 1,000%/min, more preferably 100 to 1,000%/min, and particularly preferably 100 to 500%/min.

In the case of the biaxial stretching method, there is a case in which stretching is carried out simultaneously in two directions and a case in which, after uniaxial stretching, a stretching treatment is carried out in a direction that is different from the first stretching direction. During this process, the angle between two stretching axes for controlling the shape of a refractive index ellipsoid of the stretched film is determined according to desired properties and is not particularly limited, but it is usually in the range of 120 to 60 degrees. The stretching speed may be identical or different in each stretching direction, and it is usually 1 to 5,000%/min, preferably 50 to 1,000%/min, more preferably 100 to 1,000%/min, and particularly preferably 100 to 500%/min.

The treatment temperature in the stretching alignment treatment is not particularly limited, but it is usually Tg±30° C., preferably Tg±15° C., and more preferably in the range of Tg−5° C. to Tg+15° C., on the basis of the glass transition temperature Tg of the thermoplastic cyclic olefin-based resin, preferably norbornene-based resin, used. By controlling the treatment temperature within the above-mentioned range, it becomes possible to suppress the occurrence of uneven retardation and it also becomes easy to control the refractive index ellipsoid, which is preferable.

The stretching ratio is determined according to desired properties and is not particularly limited, but it is usually 1.01 to 10 times, preferably 1.03 to 5 times, and more preferably 1.03 to 3 times. If the stretching ratio is in the above-mentioned range, it is easy to control the retardation.

The stretched film may be cooled as it is, but it is preferable to carry out heat setting by maintaining the film under an atmosphere at a temperature of Tg−20° C. to Tg for at least 10 sec, preferably 30 sec to 60 min, and more preferably 1 min to 60 min. This results in a stable retardation film in which change in retardation of transmitted light over time is suppressed.

When the particular retardation film is heated at 100° C. for 500 hours, the dimensional shrinkage due to the heating is usually 10% or less, preferably 5% or less, more preferably 3% or less, and particularly preferably 1% or less.

In order to control the dimensional shrinkage within the above-mentioned range, it is possible to carry out such control by selecting, for example, the particular monomer a, the particular monomer b, and the other copolymerizable monomer, which are starting materials for the thermoplastic cyclic olefin-based resin, as well as by controlling the casting method or the stretching method.

The dimensional shrinkage due to heating of the unprocessed film in a state in which it has not been subjected to a stretching alignment treatment is usually 5% or less, preferably 3% or less, more preferably 1% or less, and particularly preferably 0.5% or less, when heating is carried out at 100° C. for 500 hours.

The film thus stretched has molecules aligned by stretching and therefore gives retardation to transmitted light, and this retardation can be controlled by adjusting the type of thermoplastic cyclic olefin-based resin, preferably norbornene-based resin, used as a starting material, the stretching ratio, the stretching temperature, the film thickness prior to stretching (unprocessed film), etc. For example, with regard to the stretching ratio, for films having the same thickness prior to stretching, the greater the stretching ratio, the greater the absolute value of the retardation of transmitted light, and by changing the stretching ratio it is possible to obtain a film that can give a desired retardation to transmitted light. With regard to the thickness of the film prior to stretching (unprocessed film), for the same stretching ratio, the greater the thickness of the film prior to stretching, the greater the absolute value of the retardation of transmitted light, and by changing the thickness of the film prior to stretching it is possible to obtain a retardation film that can give a desired retardation to transmitted light. With regard to the stretching temperature, the lower the stretching temperature, the greater the absolute value of the retardation of transmitted light, and by changing the stretching temperature it is possible to obtain a retardation film that can give a desired retardation to transmitted light.

In order to adjust the thickness of the particular retardation film, it can be controlled by adjusting the thickness of the unprocessed film, the stretching ratio, etc. Specifically, for example, by reducing the thickness of the unprocessed film or increasing the stretching ratio, the thickness of the retardation film can be made small.

In such a particular retardation film, the number of bright points on the film surface, converted to the number per m², is 10 or less, preferably 7 or less, more preferably 5 or less, particularly preferably 3 or less, and most preferably 0 or 1.

The ‘bright points’ referred to here means partial light leakage visually observed when examining the particular retardation film sandwiched between polarizing plates in a crossed Nicol state, and those having an outer diameter of 1 μm or greater (the diameter for a circular shape, and the length in the longitudinal direction for other shapes) are usually counted. There is of course a case in which those smaller than the above are counted as bright points, depending on the required performance. It is surmised that such bright points are caused by partial unevenness of the retardation in a micro region. That is, it is surmised that, when a foreign body, a bubble, etc. is present in the unprocessed film, even if it is too small to be visually observed, when the film is subjected to stretching processing, stress is concentrated in a portion where the foreign body, bubble, etc. is present, the retardation of the portion where stress is concentrated might become different from the retardation of a portion around it, and such a difference in the retardation causes light to leak.

Furthermore, in the particular retardation film, the number of foreign bodies on the film surface, converted to the number per m², is preferably 10 or less, more preferably 5 or less, particularly preferably 3 or less, and most preferably 0 or 1.

The ‘foreign body’ referred to here means one that substantially prevents light from being transmitted when light is made to pass through the particular retardation film. When such a foreign body is present in the particular retardation film, the strength of the transmitted light is affected, and when the film is used for a liquid crystal display device, etc., pixel dropouts or degradation in properties might be caused.

The size of a foreign body that is counted is usually 1 μm or greater for the outer diameter (the diameter for a circular shape, and the length in the longitudinal direction for other shapes), but there is a case in which those with a smaller diameter than the above are counted as foreign bodies, depending on the required performance.

### <Film Surface Treatment>

The polarizing plate protective film of the present invention preferably has at least one surface thereof subjected to hydrophilization in order to guarantee intimacy of contact with a polarizer.

With regard to the surface treatment method, for example, there are methods in which an adhesive layer is provided, described in JP-A-2000-24167, JP-A-10-130402, JP-A-2002-148436, JP-A-2002-90546, and JP-A-2001-350017, or hydrophilicity can be imparted by a surface treatment such as a corona discharge treatment described in JP-A-2001-350018.

### <Polarizer>

The polarizer used in the polarizing plate of the present invention is now explained.

The polarizer of the present invention is preferably formed from polyvinyl alcohol (PVA) and a dichroic molecule, but as described in JP-A-11-248937a polyvinylene-based polarizer obtained by forming a polyene structure by dehydrating or dechlorinating PVA or polyvinyl chloride and aligning it can also be used.

PVA is a polymer material obtained by saponifying polyvinyl acetate, but it may contain a component that can copolymerize with vinyl acetate, such as, for example, an unsaturated carboxylic acid, an unsaturated sulfonic acid, an olefin, or a vinyl ether. It is also possible to use a modified PVA containing an acetoacetyl group, a sulfonic acid group, a carboxyl group, an oxyalkylene group, etc.

The degree of saponification of PVA is not particularly limited, but from the viewpoint of solubility, etc. it is preferably 80 to 100 mol %, and particularly preferably 90 to 100 mol %. Furthermore, the degree of polymerization of the PVA is not particularly limited, but it is preferably 1,000 to 10,000, and particularly preferably 1,500 to 5,000.

The syndiotacticity of PVA is preferably at least 55% in order to improve the durability as described in Japanese Registered Patent No. 2978219, but 45% to 52.5%, which is described in Japanese Registered Patent No. 3317494, can also be preferably employed.

It is preferable that, after the PVA is made into a film, a dichroic molecule is incorporated so as to form a polarizer. With regard to a process for producing a PVA film, a method in which a stock solution formed by dissolving a PVA-based resin in water or an organic solvent is cast to give a film is generally preferably used. The concentration of the polyvinyl alcohol-based resin in the stock solution is usually 5 to 20 wt %, and by forming a film using this stock solution by a casting method, a PVA film having a film thickness of 10 to 200 μm can be produced. The production of PVA film can be referred to in Japanese Registered Patent No. 3342516, JP-A-09-328593, JP-A-2001-302817, and JP-A-2002-144401.

The crystallinity of the PVA film is not particularly limited, but a PVA film having an average crystallinity (Xc) of 50 to 75 wt % described in Japanese Registered Patent No. 3251073 or a PVA film having a crystallinity of 38% or less described in JP-A-2002-236214 in order to suppress variation in hue in the in-plane direction can be used.

It is preferable for the PVA film to have a low birefringence (Δn), and a PVA film having a birefringence of 1.0×10⁻³ or less, described in Japanese Registered Patent No. 3342516, can be used preferably. However, as described in JP-A-2002-228835, in order to obtain high degree of polarization while avoiding breakage of a PVA film during stretching, the birefringence of the PVA film may be at least 0.002 but no greater than 0.01, or as described in JP-A-2002-060505 the value (nx+ny)/2−nz may be at least 0.0003 but no greater than 0.01. The retardation Re (in-plane) of the PVA film is preferably at least 0 nm but no greater than 100 nm, and more preferably at least 0 nm but no greater than 50 nm. Furthermore, the Rth (film thickness direction) of the PVA film is preferably at least 0 nm but no greater than 500 nm, and more preferably at least 0 nm but no greater than 300 nm.

Moreover, the polarizing plate of the present invention can preferably employ a PVA film, described in Japanese Registered Patent No. 3021494, having a 1,2-glycol bond content of 1.5 mol % or less, a PVA film, described in JP-A-2001-316492, containing a number of optical foreign bodies with a size of 5 μm or greater of 500 or less per 100 cm², a PVA film, described in JP-A-2002-030163, having a hot water breakage temperature unevenness of 1.5° C. or less in the film TD direction, and a PVA film formed from a solution into which is mixed 1 to 100 parts by weight of a tri- to hexa-hydric polyhydric alcohol such as glycerol or 15 wt % or greater of a plasticizer described in JP-A-06-289225.

The thickness of the PVA film prior to stretching is not particularly limited, but from the viewpoint of stability of film retention and uniformity of stretching, it is preferably 1 μm to 1 mm, and particularly preferably 20 to 200 μm. As described in JP-A-2002-236212, a thin PVA film for which the stress generated when stretching by 4 times to 6 times in water is 10 N or less may be used.

With regard to the dichroic molecule, a higher order iodine ion such as I₃⁻ or I₅⁻ or a dichroic dye can preferably be used. In the present invention, the higher order iodine ion is particularly preferably used. The higher order iodine ion can be formed, as described in ‘Henkoban no Oyou’ (Applications of Polarizing Plates) Ed. by R. Nagata, CMC Publishing or ‘Kogyo Zairyo’ (Industrial Materials), Vol. 28, No. 7, p. 39 to p. 45, by immersing PVA in an aqueous solution of potassium iodide in which iodine has been dissolved and/or an aqueous solution of boric acid in which iodine has been dissolved so as to form an adsorbed and aligned state on the PVA.

When a dichroic dye is used as the dichroic molecule, an azo type dye is preferable, and a bisazo type and a trisazo type dye are particularly preferable. Sinbe it is preferable for the dichroic dye to be water-soluble, a hydrophilic substituent such as a sulfonic acid group, an amino group, or a hydroxyl group is incorporated into the dichroic molecule, and it is preferably used as a free acid, an alkali metal salt, an ammonium salt, or an amine salt.

Specific examples of such a dichroic dye include benzidine types such as Cl Direct Red 37, Congo Red (Cl Direct Red 28), Cl Direct Violet 12, Cl Direct Blue 90, Cl Direct Blue 22, Cl Direct Blue 1, Cl Direct Blue 151, and Cl Direct Green 1, diphenylurea types such as Cl Direct Yellow 44, Cl Direct Red 23, and Cl Direct Red 79, stilbene types such as Cl Direct Yellow 12, dinaphthylamine types such as Cl Direct Red 31, and J acid types such as Cl Direct Red 81, Cl Direct Violet 9, and Cl Direct Blue 78.

In addition to the above, there can also preferably be used Cl Direct Yellow 8, Cl Direct Yellow 28, Cl Direct Yellow 86, Cl Direct Yellow 87, Cl Direct Yellow 142, Cl Direct Orange 26, Cl Direct Orange 39, Cl Direct Orange 72, Cl Direct Orange 106, Cl Direct Orange 107, Cl Direct Red 2, Cl Direct Red 39, Cl Direct Red 83, Cl Direct Red 89, Cl Direct Red 240, Cl Direct Red 242, Cl Direct Red 247, Cl Direct Violet 48, Cl Direct Violet 51, Cl Direct Violet 98, Cl Direct Blue 15, Cl Direct Blue 67, Cl Direct Blue 71, Cl Direct Blue 98, Cl Direct Blue 168, Cl Direct Blue 202, Cl Direct Blue 236, Cl Direct Blue 249, Cl Direct Blue 270, Cl Direct Green 59, Cl Direct Green 85, Cl Direct Brown 44, Cl Direct Brown 106, Cl Direct Brown 195, Cl Direct Brown 210, Cl Direct Brown 223, Cl Direct Brown 224, Cl Direct Black 1, Cl Direct Black 17, Cl Direct Black 19, Cl Direct Black 54, etc. and, furthermore, dichroic dyes described in JP-A-62-70802, JP-A-1-161202, JP-A-1-172906, JP-A-1-172907, JP-A-1-183602, JP-A-1-248105, JP-A-1-265205, and JP-A-7-261024. In order to produce dichroic molecules having various types of hue, two or more types of these dichroic dyes may be mixed. When a dichroic dye is used, as described in JP-A-2002-082222 the adsorption thickness may be 4 μm or greater.

If the content of the dichroic molecule in the film is too small, the degree of polarization is low, and if the content is too large, the single plate transmittance is degraded; the content is therefore adjusted so as to be usually in the range of 0.01 wt % to 5 wt % relative to the polyvinyl alcohol-based polymer forming a film matrix.

With regard to a preferred film thickness of the polarizer, it is preferably 5 μm to 40 μm, and more preferably 10 μm to 30 μm. It is also preferable to adjust the ratio of the thickness of the polarizer to the thickness of a protective film described above so that it satisfies the relationship 0.01<A (polarizer film thickness)/B (protective film thickness)<0.16 described in JP-A-2002-174727.

The angle of the intersection of the phase retardation axis of the protective film with the absorption axis of the polarizer may be any value, but they are preferably parallel, or there is a directional angle of 45°±20°.

### <Polarizing Plate Production Process>

A production process for the polarizing plate of the present invention is now explained.

The production process for the polarizing plate in the present invention preferably comprises a swelling step, a dyeing step, a film-hardening step, a stretching step, a drying step, a protective film laminating step, and a post-lamination drying step. The order in which the dyeing step, the film-hardening step, and the stretching step are carried out may be changed freely, and several steps may be combined and carried out simultaneously. It is also preferably possible, as described in Japanese Registered Patent No. 3331615, to carry out washing with water after the film-hardening step.

In the present invention, it is particularly preferable to carry out the swelling step, the dyeing step, the film-hardening step, the stretching step, the drying step, the protective film laminating step, and the post-laminating drying step in the order described. An on-line surface condition examination step may be provided during or after the above-mentioned steps.

The swelling step is preferably carried out using water alone, but as described in JP-A-10-153709, in order to stabilize optical performance and prevent the occurrence of creases in a polarizing plate substrate in a production line, it is also possible to make the polarizing plate substrate swell with an aqueous solution of boric acid so as to control the degree of swelling of the polarizing plate substrate.

The temperature and the time of the swelling step can be determined freely, but they are preferably at least 10° C. but no greater than 60° C. and at least 5 sec but not greater than 2,000 sec.

The dyeing step can employ a method described in JP-A-2002-86554. The dyeing method may employ not only immersion but also any means such as coating or spraying with an iodine or dye solution. Furthermore, as described in JP-A-2001-290025, it is also possible to employ a method in which dyeing is carried out while stirring a bath solution in a bath at the specific conditions of the concentration of iodine, the dyeing bath temperature, and the stretching ratio in the bath.

When a higher order iodine ion is used as the dichroic molecule, in order to obtain a high contrast polarizing plate, the dyeing step preferably employs a solution in which iodine is dissolved in an aqueous solution of potassium iodide. In this case, the iodine in the iodine-potassium iodide aqueous solution is preferably in the range of 0.05 to 20 g/L, the potassium iodide is 3 to 200 g/L, and the ratio by weight of iodine to potassium iodide is 1 to 2,000. The dyeing time is preferably 10 to 1,200 sec, and the solution temperature is preferably 10° C. to 60° C. It is more preferable that iodine is 0.5 to 2 g/L, potassium iodide is 30 to 120 g/L, the ratio by weight of iodine to potassium iodide is 30 to 120, the dyeing time is 30 to 600 sec, and the solution temperature is 20° C. to 50° C.

Furthermore, as described in Japanese Registered Patent No. 3145747, a boron-based compound such as boric acid or borax may be added to the dyeing solution.

The film-hardening step preferably involves immersion in a crosslinking agent solution or coating with the solution so as to let the crosslinking agent soak in. It is also possible, as described in JP-A-11-52130, to carry out the film hardening by dividing it into several steps.

As the crosslinking agent, one described in reissued U.S. Pat. No. 232,897 can be used, and as described in Japanese Registered Patent No. 3357109, in order to improve the dimensional stability, a polyaldehyde may be used as the crosslinking agent, but boric acid is most preferably used. When boric acid is used as the crosslinking agent used in the film-hardening step, a metal ion may be added to a boric acid-potassium iodide aqueous solution. As the metal ion, zinc chloride is preferable, but as described in JP-A-2000-35512, instead of zinc chloride, a zinc halide such as zinc iodide or a zinc salt such as zinc sulfate or zinc acetate may be used.

In the present invention, a boric acid-potassium iodide aqueous solution with added zinc chloride is prepared, and film hardening by immersing a PVA film therein is preferably carried out. It is preferable that the boric acid is 1 to 100 g/L, the potassium iodide is 1 to 120 g/L, the zinc chloride is 0.01 to 10 g/L, the film-hardening time is 10 to 1200 sec, and the solution temperature is 10° C. to 60° C. It is more preferable that the boric acid is 10 to 80 g/L, the potassium iodide is 5 to 100 g/L, the zinc chloride is 0.02 to 8 g/L, the film-hardening time is 30 to 600 sec, and the solution temperature is 20° C. to 50° C.

The stretching step may preferably employ a lengthwise uniaxial stretching system as described in U.S. Pat. No. 2,454,515, etc., or a tenter system as described in JP-A-2002-86554. A preferred stretching ratio is at least 2 times but no greater than 12 times, and more preferably at least 3 times but no greater than 10 times. Furthermore, the relationship between the stretching ratio, the starting material thickness, and the polarizer thickness is preferably adjusted so that (polarizer film thickness after protective film lamination/starting material film thickness)×(total stretching ratio)>0.17, which is described in JP-A-2002-040256, or so that the relationship between the width of the polarizer when coming out from a final bath and the width of the polarizer at a time of protective film lamination is 0.80<(width of polarizer at time of protective film lamination/width of polarizer when coming out from final bath)<0.95, which is described in JP-A-2002-040247.

The drying step may employ a known method from JP-A-2002-86554, but a preferred temperature range is 30° C. to 100° C., and a preferred drying time is 30 sec to 60 min. Furthermore, as described in Japanese Registered Patent No. 3148513, a thermal treatment so that an in-water discoloration temperature is 50° C. or higher can preferably be carried out, and as described in JP-A-07-325215 or JP-A-07-325218, aging under a temperature- and humidity-controlled atmosphere can preferably be carried out.

In the protective film laminating step, two protective films are laminated to the surfaces of the above-mentioned polarizer subsequent to the drying step. A method in which an adhesive solution is supplied immediately prior to lamination, and the polarizer and the protective film are superimposed and laminated by means of a pair of rollers is preferably used. Furthermore, as described in JP-A-2001-296426 and JP-A-2002-86554, in order to suppress record groove shaped irregularities due to stretching of the polarizer, it is preferable to adjust the water content of the polarizer during lamination. In the present invention, a water content of 0.1% to 30% is preferably used.

The adhesive for the polarizer and the protective film is not particularly limited; examples thereof include a PVA-based resin (including a PVA modified with, for example, an acetoacetyl group, a sulfonic acid group, a carboxyl group, or an oxyalkylene group) and an aqueous solution of a boron compound, and among these a PVA-based resin is preferable. The thickness of the adhesive layer is preferably 0.01 to 5 μm after drying, and particularly preferably 0.05 to 3 μm.

Furthermore, in order to improve the bond strength between the polarizer and the protective film, it is preferable to carry out bonding after subjecting the protective film to a surface treatment so as to make it hydrophilic. The method for the surface treatment is not particularly limited, and a known method such as a method in which saponification is carried out using an alkali solution, or a corona treatment method may be used. Furthermore, after the surface treatment an adhesion promotion layer such as a gelatin undercoat layer may be provided. As described in JP-A-2002-267839, the contact angle between the protective film surface and water is preferably 50° or less.

Drying conditions after lamination conform to the method described in JP-A-2002-86554; a preferred temperature range is 30° C. to 100° C., and a preferred drying time is 30 sec to 60 min. Furthermore, as described in JP-A-07-325220, aging under a temperature- and humidity-controlled atmosphere can preferably be carried out.

It is preferable that the element content in the polarizer is 0.1 to 3.0 g/m² for iodine, 0.1 to 5.0 g/m² for boron, 0.1 to 2.00 g/m² for potassium, and 0 to 2.00 g/m² for zinc. Furthermore, the potassium content may be 0.2 wt % or less as described in JP-A-2001-166143, and the zinc content in the polarizer may be 0.04 wt % to 0.5 wt %, which is described in JP-A-2000-035512.

As described in Japanese Registered Patent No. 3323255, in order to improve the dimensional stability of the polarizing plate, in any one of the dyeing step, the stretching step, and the film-hardening step, an organic titanium compound and/or an organic zirconium compound may be added so that at least one type of compound selected from an organic titanium compound and an organic zirconium compound is contained therein. Furthermore, in order to adjust the hue of the polarizing plate, a dichroic dye may be added.

### <Properties of Polarizing Plate>

### (1) Transmittance and Degree of Polarization

A preferred single plate transmittance of the polarizing plate of the present invention is at least 42.5% but no greater than 49.5%, and more preferably at least 42.8% but no greater than 49.0%. A preferred range for the degree of polarization defined by Formula (12) is at least 99.900% but no greater than 99.999%, and more preferably at least 99.940% but no greater than 99.995%. A preferred range for the parallel transmittance is at least 36% but no greater than 42%, and a preferred range for the perpendicular transmittance is at least 0.001% but no greater than 0.05%. A preferred range for the dichroic ratio defined by Formula (13), which is shown later, is at least 48 but no greater than 1,215, and more preferably at least 53 but no greater than 525.

The above-mentioned transmittance is defined by Formula (10) in accordance with JIS Z8701.

T=K∫S(λ)y(λ)τ(λ)dλ (10)

Here, K, S(λ), y(λ), and τ(λ) are as follows.

$$K = \frac{100}{\int S ( λ ) y ( λ ) d λ} \qquad ( 11 )$$

S(λ): spectral distribution of standard illuminant used for display of colors
y(λ): isochromatic function in the XYZ system
τ(λ): spectral transmittance

$$\begin{matrix}Degree of Polarization ( \% ) = 100 \times \sqrt{\frac{Parallel Transmittance - Perpendicular Transmittance}{Parallel Transmittance + Perpendicular Transmittance}} & ( 12 ) \\ Dichroic Ratio ( Rd ) = \frac{log [ \frac{Single Plate Transmittance}{100} ( 1 - \frac{Degree of Polarization}{100} ) ]}{log [ \frac{Single Plate Transmittance}{100} ( 1 + \frac{Degree of Polarization}{100} ) ]} & ( 13 )\end{matrix}$$

The iodine concentration and the single plate transmittance may be in the range described in JP-A-2002-258051.

The parallel transmittance may have little wavelength dependence as described in JP-A-2001-083328 and JP-A-2002-022950. The optical properties when the polarizing plates are arranged in the crossed Nicol configuration may be in the range described in JP-A-2001-091736, and the relationship between the parallel transmittance and the perpendicular transmittance may be in the range described in JP-A-2002-174728.

As described in JP-A-2002-221618, the standard deviation of the parallel transmittance for every 10 nm between light wavelengths of 420 to 700 nm may be 3 or less, and the minimum value of (parallel transmittance/perpendicular transmittance) for every 10 nm between light wavelengths of 420 to 700 nm is 300 or greater.

It is also preferable that the parallel transmittance and the perpendicular transmittance of the polarizing plate at a wavelength of 440 nm, the parallel transmittance and the perpendicular transmittance at a wavelength of 550 nm, and the parallel transmittance and the perpendicular transmittance at a wavelength of 610 nm are in the range described in JP-A-2002-258042 or JP-A-2002-258043.

### (2) Hue

The hue of the polarizing plate of the present invention is preferably evaluated using a psychometric lightness index L* and chromaticness indices a* and b* in the L*a*b color system recommended as a CIE equal perception space.

L*, a*, and b* are defined by Formula (14) using the above-mentioned X, Y, and Z.

$${L}^{*} = 116 {( Y / {Y}_{0} )}^{\frac{1}{3}} - 16 \\ {a}^{*} = 500 [ {( X / {X}_{0} )}^{\frac{1}{3}} - {( Y / {Y}_{0} )}^{\frac{1}{3}} ] \\ {b}^{*} = 200 [ {( Y / {Y}_{0} )}^{\frac{1}{3}} - {( Z / {Z}_{0} )}^{\frac{1}{3}} ] \qquad ( 14 )$$

Here, X₀, Y₀, and Z₀ denote tristimulus values of an illumination source; in the case of standard illuminant C, X₀=98.072, Y₀=100, and Z₀=118.225, and in the case of standard illuminant D₆₅, X₀=95.045, Y₀=100, and Z₀=108.892.

A preferred range for a of a single polarizing plate is at least −2.5 but no greater than 0.2, and more preferably at least −2.0 but no greater than 0. A preferred range for b* of a single polarizing plate is at least 1.5 but no greater than 5, and more preferably at least 2 but no greater than 4.5. A preferred range for a* of parallel transmitted light of two polarizing plates is at least −4.0 but no greater than 0, and more preferably at least −3.5 but no greater than −0.5. A preferred range for b* of parallel transmitted light of two polarizing plates is at least 2.0 but no greater than 8, and more preferably at least 2.5 but no greater than 7. A preferred range for a* of perpendicular transmitted light of two polarizing plates is at least −0.5 but no greater than 1.0, and more preferably at least 0 but no greater than 2. A preferred range for b* of perpendicular transmitted light of two polarizing plates is at least −2.0 but no greater than 2, and more preferably at least −1.5 but no greater than 0.5.

The hue may be evaluated in the chromaticity coordinates (x, y) calculated from the above-mentioned X, Y, and Z, and it is preferable that, for example, the chromaticity (xp, yp) of the parallel transmitted light and the chromaticity (xc, yc) of the perpendicular transmitted light of the two polarizing plates are in the range described in JP-A-2002-214436, JP-A-2001-166136, or JP-A-2002-169024, and the relationship between hue and absorbance is within the range described in JP-A-2001-311827.

### (3) Viewing Angle Characteristics

When the polarizing plates are arranged in the crossed Nicol configuration and light is incident at a wavelength of 550 nm, it is preferable that the transmittance ratio and the xy chromaticity difference between a case in which vertical light is incident and a case in which light is incident at an angle of 40 degrees relative to the normal from a direction of 45 degrees relative to the polarization axis are in ranges described in JP-A-2001-166135 or JP-A-2001-166137. Furthermore, it is also preferable that, as described in JP-A-10-068817, the ratio (T₆₀/T₀) of light transmittance (T₀) in a vertical direction of polarizing plates laminated in the crossed Nicol configuration and light transmittance (T₆₀) in a direction at an angle of 60° relative to the normal to the laminate is 10,000 or less; as described in JP-A-2002-139625, when natural light is incident at a given angle between the normal to the polarizing plate and an elevation angle of 80 degrees, in the wavelength region of 520 to 640 nm of the transmission spectrum, the difference in transmittance of the transmitted light among wavelengths within a 20 nm range is 6% or less; and as described in JP-A-08-248201, the difference in luminance of the transmitted light between any positions that are 1 cm apart from each other on the film is within 30%.

### (4) Durability

### (4-1) Humidity and Heat Durability

It is preferable that percentage changes in the light transmittance and the degree of polarization between that before and that after standing under an atmosphere at 60° C. and 95% RH for 500 hours are 3% or less on an absolute value basis. In particular, the percentage change in the light transmittance is preferably 2% or less, and the percentage change in the degree of polarization is preferably 1.0% or less on an absolute value basis. Furthermore, as described in JP-A-07-077608, the degree of polarization after standing at 80° C. and 90% RH for 500 hours is preferably 95% or greater, and the single plate transmittance is preferably 38% or greater.

### (4-2) Dry Durability

It is also preferable that percentage changes in the light transmittance and the degree of polarization between that before and that after standing in a dry atmosphere at 80° C. for 500 hours are 3% or less on an absolute value basis. In particular, the percentage change in the light transmittance is preferably 2% or less, and the percentage change in the degree of polarization is preferably 1.0% or less on an absolute value basis, and more preferably 0.1% or less.

### (4-3) Other Durability

Furthermore, as described in JP-A-06-167611, it is preferable that the shrinkage after standing at 80° C. for 2 hours is 0.5% or less, a value x and a value y after allowing the polarizing plate laminates placed in the crossed Nicol configuration on either side of a glass plate to stand in an atmosphere at 69° C. for 750 hours is within a range described in JP-A-10-068818, and the change in spectrum strength ratio between 105 cm⁻¹ and 157 cm⁻¹ by Raman spectroscopy after standing in an atmosphere at 80° C. and 90% RH for 200 hours is in a range described in JP-A-08-094834 or JP-A-09-197127.

### (5) Degree of Alignment

The higher the degree of alignment of the PVA, the higher the polarization performance obtained, and a preferred range for an order parameter value calculated by means such as polarized Raman scattering or polarized FT-IR is 0.2 to 1.0. Furthermore, it is preferable that, as described in JP-A-59-133509, the difference between an alignment coefficient of a macromolecular segment and an alignment coefficient (0.75 or greater) of an occupying molecule in all amorphous regions of the polarizer is at least 0.15 and, as described in JP-A-04-204907, the alignment coefficient of the amorphous region of the polarizer is 0.65 to 0.85 or the degree of alignment of higher order iodine ion such as I₃⁻ or I₅⁻ is 0.8 to 1.0 as an order parameter value.

(6) F type curl value

The F type curl value can be measured in accordance with a measurement method defined by the American National Standards Institute (ANSI/ASCPH1.29-1985). Specifically, the polarizing plate is cut to 50 mm in the longitudinal direction and 2 mm in the width direction, conditioned under environments of 25° C. and 10% RH, 25° C. and 60% RH, and 25° C. and 80% RH for 24 hours, and the F type curl value of the polarizing plate is measured using a curvature scale. When the curl is convex toward a polarizing plate protective film 1 side, the curl is defined as negative.

It is preferable that, with regard to the polarizing plate of the present invention, the F type curl value at 25° C. and 60% RH is at least −1.0 but no greater than 1.0, and the difference between the F type curl value at 25° C. and 10% RH and the F type curl value at 25° C. and 80% RH is 2.0 or less. It is more preferably 1.0 or less. It is preferable if the F type curl value is in the above-mentioned range since, when the polarizing plate is laminated to a liquid crystal cell, it can easily be laminated uniformly without being affected by contamination with bubbles, etc.

### (7) Other Properties

It is also preferable that, as described in JP-A-2002-006133, a shrinkage force per unit width in a direction of the absorption axis when heated at 80° C. for 30 min is 4.0 N/cm or less, as described in JP-A-2002-236213 when the polarizing plate is allowed to stand under conditions of heating at 70° C. for 120 hours, the percentage change in dimension in a direction of the absorption axis of the polarizing plate and the percentage change in dimension in a direction of the polarization axis are both within ±0.6% and, as described in JP-A-2002-090546, the water content of the polarizing plate is 3 wt % or less. Furthermore, it is also preferable that, as described in JP-A-2000-249832, the surface roughness in a direction perpendicular to the stretching axis is 0.04 μm or less on the basis of the center line average roughness, as described in JP-A-10-268294 the refractive index no in a direction of the transmission axis is greater than 1.6, and the relationship between the thickness of the polarizing plate and the thickness of the protective film is in a range described in JP-A-10-111411.

### <Functionalization of Polarizing Plate>

The polarizing plate of the present invention is preferably used as a functionalized polarizing plate that is combined with an LCD viewing angle increasing film, a retardation film such as a λ/4 plate for application to a reflective LCD, an anti-reflection film for improving display viewability, a luminance improving film, or an optical film having a functional layer such as a hardcoat layer, a forward scattering layer, or an anti-glare layer.

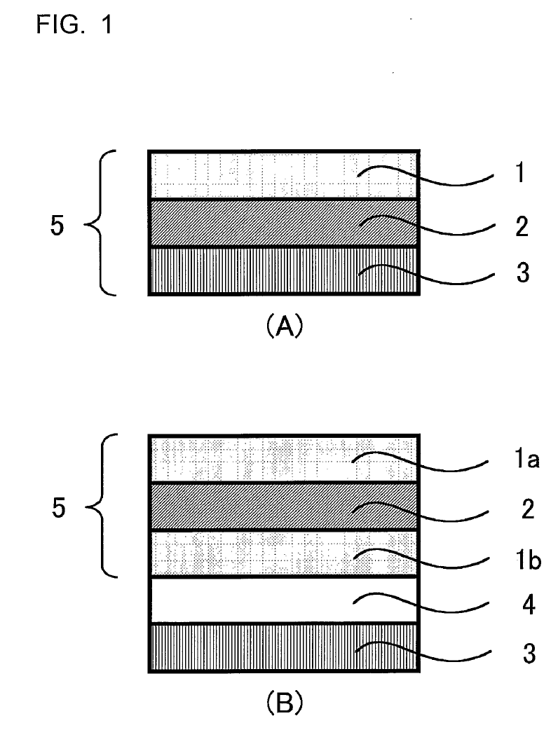

Examples of configurations in which the polarizing plate of the present invention and the above-mentioned functional optical films are combined are shown in FIG. 1. As a protective film on one side of a polarizing plate 5, a functional optical film 3 and a polarizer 2 may be laminated via a pressure sensitive adhesive layer (FIG. 1 (A)), or the functional optical film 3 may be bonded via the pressure sensitive adhesive layer 4 to the polarizing plate 5 in which both sides of the polarizer 2 are provided with protective films 1a and 1b (FIG. 1 (B)). In the former case, as the other protective film 1 any transparent protective film may be used. Furthermore, in the polarizing plate of the present invention, it is preferable to achieve the configuration of FIG. 1 (A) by laminating the protective film and the optical functional layer via the pressure sensitive adhesive layer so as to form the functional optical film 3. It is preferable that the peel strength between layers such as the functional layer and the protective film is 4.0 N/25 mm or greater, which is described in JP-A-2002-311238. It is preferable that, according to an intended function, the functional optical film is disposed on the side of a liquid crystal module or on the side opposite to the liquid crystal module, that is, on the display side or the backlight side.

### (Functional Optical Film)

The functional optical films that are used in combination with the polarizing plate of the present invention are explained below.

### (1) Viewing Angle Increasing Film

The polarizing plate of the present invention can be used in combination with a viewing angle increasing film that has been proposed for a display mode such as TN (Twisted Nematic), IPS (In-Plane Switching), OCB (Optically Compensatory Bend), VA (Vertically Aligned), or ECB (Electrically Controlled Birefringence).

As the viewing angle increasing film for the TN mode, a WV film (manufactured by Fuji Photo Film Co., Ltd.) described in the Journal of the Japanese Society for Printing Science and Technology, Vol. 36, No. 3 (1999) p. 40 to 44, the monthly publication ‘Disupurei’ (Display) August (2002) p. 20 to 24, JP-A-4-229828, JP-A-6-75115, JP-A-6-214116, JP-A-8-50206, etc. is preferably used.

A preferred configuration of the viewing angle increasing film for the TN mode comprises, on the above-mentioned transparent polymer film, an alignment layer and an optically anisotropic layer in that order. The viewing angle increasing film may be used by being laminated to the polarizing plate via a pressure sensitive adhesive, but it is particularly preferable from the viewpoint of reducing the thickness that, as described in SID'00 Dig., p. 551 (2000), it is used so as to serve also as one of the protective films of the polarizer.

The alignment layer can be provided by means such as a rubbing treatment of an organic compound (preferably a polymer), oblique vapor deposition of an inorganic compound, or formation of a layer having a micro group. Furthermore, an alignment layer that generates an alignment function by application of an electric field, a magnetic field, or light is known, but an alignment layer formed by the rubbing treatment of a polymer is particularly preferable. The rubbing treatment is preferably carried out by rubbing the surface of a polymer layer in a certain direction by means of paper or cloth several times. It is preferable that the absorption axis direction of the polarizer and the rubbing direction are substantially parallel. With regard to the type of polymer used in the alignment layer, polyimide, polyvinyl alcohol, a polymer having a polymerizable group described in JP-A-9-152509, etc. can preferably be used. The thickness of the alignment layer is preferably 0.01 to 5 μm, and more preferably 0.05 to 2 μm.

The optically anisotropic layer preferably contains a liquid crystal compound. The liquid crystal compound used in the present invention is particularly preferably a discotic compound (discotic liquid crystal). A discotic liquid crystal molecule has a structure in which side chains extend radially from a disc-shaped core part. Furthermore, in order to impart aging stability, it is preferable to further incorporate a group that reacts by means of heat, light, etc. Preferred examples of the above-mentioned discotic liquid crystal are described in JP-A-8-50206.

The discotic liquid crystal molecule is aligned substantially parallel to the film plane with a pretilt angle in the rubbing direction in the vicinity of the alignment layer, and has a standing alignment on the opposite air side with a shape in which the discotic liquid crystal molecule is nearly vertical to the plane. The discotic liquid crystal layer as a whole takes a hybrid alignment, and this layer structure can achieve an increase in the viewing angle of the TFT-LCD in the TN mode.

The above-mentioned optically anisotropic layer is generally obtained by coating the top of the alignment layer with a solution in which a discotic compound and another compound (additionally, for example, a polymerizable monomer, a photopolymerization initiator) are dissolved in a solvent, followed by drying, heating to a discotic nematic phase formation temperature, then polymerization by application of UV light, etc. and further cooling. The discotic nematic liquid crystal phase-solid phase transition temperature of the discotic liquid crystal compound used in the present invention is preferably 70° C. to 300° C., and particularly preferably 70° C. to 170° C.

Furthermore, with regard to a compound, other than the discotic compound, that is added to the above-mentioned optically anisotropic layer, any compound can be used as long as it has compatibility with the discotic compound and it can give a preferable tilt angle to the liquid crystal discotic compound or it does not interfere with the alignment. Among these, a polymerizable monomer (for example, a compound having a vinyl group, a vinyloxy group, an acryloyl group, or a methacryloyl group), an additive for controlling alignment on the air interface side such as a fluorine-containing triazine compound, a polymer such as cellulose acetate, cellulose acetate propionate, hydroxylpropyl cellulose, or cellulose acetate butyrate, etc. can be cited. These compounds are added in an amount of generally 0.1 to 50 wt % relative to the discotic compound, and preferably 0.1 to 30 wt %.

The thickness of the optically anisotropic layer is preferably 0.1 to 10 μm, and more preferably 0.5 to 5 μm.

A preferred embodiment of the viewing angle increasing film comprises a cellulose acylate film as the transparent substrate film, an alignment layer provided thereon, and an optically anisotropic layer formed from a discotic liquid crystal on the alignment layer, and the optically anisotropic layer is crosslinked by irradiation with of UV light.

Furthermore, other than the above-mentioned, when the viewing angle increasing film and the polarizing plate of the present invention are combined, it is preferable that, for example, as described in JP-A-07-198942 they are laminated with a retardation plate having an optical axis in a direction intersecting a plate face and showing anisotropic birefringence and, as described in JP-A-2002-258052, the percentage change in the dimensions of the protective film and the optically anisotropic layer are substantially the same. Furthermore, it is preferable that, as described in JP-A-12-258632, the water content of the polarizing plate laminated with the viewing angle increasing film is 2.4% or less and, as described in JP-A-2002-267839, the contact angle between the viewing angle increasing film surface and water is 70° or less.

The viewing angle increasing film for an IPS mode liquid crystal cell is used for improving, when displaying black with no electric field applied, the optical compensation of a liquid crystal molecule aligned parallel to a substrate surface and the viewing angle characteristics of the perpendicular transmittance of the polarizing plate. In the IPS mode, when no electric field is applied, black is displayed, and transmission axes of a pair of upper and lower polarizing plates are perpendicular to each other. However, when viewed obliquely, the intersection angle of the transmission axes deviates from 90°, light leakage occurs, and the contrast is degraded. When the polarizing plate of the present invention is used in an IPS mode liquid crystal cell, in order to suppress the light leakage, it is preferably used in combination with a viewing angle increasing film such as one described in JP-A-10-54982, in which the in-plane retardation is close to 0 and it has retardation in the thickness direction.

The viewing angle increasing film for an OCB mode liquid crystal cell is used in order to carry out optical compensation of a liquid crystal layer in which perpendicular alignment in a middle part of the liquid crystal layer and oblique alignment in the vicinity of the interface with a substrate are achieved by application of an electric field, so as to improve the viewing angle characteristics of black display. When the polarizing plate of the present invention is used for the OCB mode liquid crystal cell, it is preferably used in combination with a viewing angle increasing film as described in U.S. Pat. No. 5,805,253, in which a disc-shaped liquid crystal compound is hybrid aligned.

The viewing angle increasing film for a VA mode liquid crystal cell improves the viewing angle characteristics of black display in a state in which a liquid crystal molecule is aligned vertical to a substrate face with no electric field applied. Such a viewing angle increasing film is preferably used in combination with a film as described in Japanese Registered Patent No. 2866372 in which the in-plane retardation is close to 0 and it has retardation in the thickness direction, a film in which a disc-shaped compound is aligned in parallel to the substrate, a film in which stretched films having the same in-plane retardation value are laminated so that their phase retardation axes are perpendicular to each other, or a laminate of a film formed from a rod-shaped compound such as a liquid crystal molecule in order to prevent the perpendicular transmittance in a direction oblique to the polarizing plate from deteriorating.

(2) Retardation film

The polarizing plate of the present invention preferably has a retardation layer. As the retardation layer of the present invention, a λ/4 plate is preferable, and by laminating the polarizing plate of the present invention and the λ/4 plate it can be used as a circularly polarizing plate. The circularly polarizing plate has a function of converting incoming light into circularly polarized light, and is preferably utilized in a reflective liquid crystal display device, a semi-transmissive type liquid crystal display device such as an ECB mode, an organic EL device, etc.

The λ/4 plate used in the present invention is preferably a retardation film having a retardation (Re) that is substantially ¼ of the wavelength in the visible light wavelength region in order to obtain substantially perfect circularly polarized light in the visible light wavelength region. The ‘retardation of substantially ¼ in the visible light wavelength region’ referred to here means that for wavelengths of 400 to 700 nm the longer the wavelength the greater the retardation; a retardation value (Re₄₅₀) measured at a wavelength of 450 nm is 80 to 125 nm, and a retardation value (Re₅₉₀) measured at a wavelength of 590 nm is 120 to 160 nm. It is more preferable that Re₅₉₀−Re₄₅₀≧5 nm, and it is particularly preferable that Re₅₉₀−Re₄₅₀≧10 nm.

The λ/4 plate used in the present invention is not particularly limited as long as the above-mentioned conditions are satisfied, and a known λ/4 plate can be used such as, for example, a λ/4 plate described in JP-A-5-27118, JP-A-10-68816, or JP-A-10-90521 in which a plurality of polymer films are laminated, a λ/4 plate described in WO0/65384 or WO0/26705 in which one polymer film is stretched, or a λ/4 plate described in JP-A-2000-284126 or JP-A-2002-31717 in which at least one optically anisotropic layer is provided on a polymer film. Furthermore, the direction of the phase retardation axis of the polymer film or the alignment direction of the optically anisotropic layer may be determined freely according to the liquid crystal cell.

In the circularly polarizing plate, the phase retardation axis of the λ/4 plate and the transmission axis of the above-mentioned polarizer can intersect at any angle, but they preferably intersect at an angle in the range of 45°±20°. However, the phase retardation axis of the λ/4 plate and the transmission axis of the above-mentioned polarizer may intersect at an angle other than the above-mentioned range.

When the λ/4 plate is formed by laminating a λ/4 plate and a λ/2 plate, it is preferable that, as described in Japanese Registered Patent No. 3236304 or JP-A-10-68816, they are laminated so that angles formed between the in-plane phase retardation axes of the λ/4 plate and λ/2 plate and the transmission axis of the polarizing plate are substantially 75° and 15°.

(3) Anti-reflection film

The polarizing plate of the present invention can be used in combination with an anti-reflection film. The anti-reflection film can be either a film to which a single layer of a low refractive index material such as a fluorine-based polymer is simply added and which has a reflectivity of about 1.5%, or a film that utilizes multilayer interference of a thin film and has a reflectivity of 1% or less. In the present invention, a configuration in which, on top of a transparent support, a low refractive index layer, and at least one layer having a refractive index higher than that of the low refractive index layer (that is, a high refractive index layer, a medium refractive index layer) are layered is employed. Furthermore, an anti-reflection film described in Nitto Giho, Vol. 38, No. 1, May, 2000, pp. 26 to 28, JP-A-2002-301783, etc. can also preferably be used.

The refractive indices of the layers satisfy the relationship below.

Refractive index of high refractive index layer>refractive index of medium refractive index layer>refractive index of transparent support>refractive index of low refractive index layer

The transparent support used in the anti-reflection film can preferably employ a transparent polymer film used in the protective film of the above-mentioned polarizer.

The refractive index of the low refractive index layer is 1.20 to 1.55, and preferably 1.30 to 1.50. The low refractive index layer is preferably used as an outermost layer having scratch resistance and contamination resistance. In order to improve the scratch resistance, it is preferable to impart slip to the surface by using a material containing a silicone group or fluorine.

With regard to a fluorine-containing compound, for example, compounds described in paragraph Nos. [0018] to [0026] of the specification of JP-A-9-222503, paragraph Nos. [0019] to [0030] of the specification of JP-A-11-38202, paragraph Nos. [0027] to [0028] of the specification of JP-A-2001-40284, JP-A-2000-284102, etc. can preferably be used.

As a silicone-containing compound, a compound having a polysiloxane structure is preferable, and a reactive silicone (for example, Silaplane (manufactured by Chisso Corporation)), a polysiloxane containing silanol groups at both ends (JP-A-11-258403), etc. can also be used. An organometallic compound such as a silane coupling agent and a silane coupling agent containing a particular fluorine-containing hydrocarbon group may be cured by a condensation reaction in the presence of a catalyst (compounds described in JP-A-58-142958, JP-A-58-147483, JP-A-58-147484, JP-A-9-157582, JP-A-11-106704, JP-A-2000-117902, JP-A-2001-48590, and JP-A-2002-53804, etc.).

It is preferable to add to the low refractive index layer, as an additive other than the above-mentioned additives, a filler (for example, a low refractive index inorganic compound having an average primary particle diameter of 1 to 150 nm such as silicon dioxide (silica) and fluorine-containing particles (magnesium fluoride, calcium fluoride, or barium fluoride), fine organic particles described in paragraph Nos. [0020] to [0038] of the specification of JP-A-11-3820, etc.), a silane coupling agent, a lubricant, a surfactant, etc.

The low refractive index layer may be formed by a gas phase method (a vacuum vapor deposition method, a sputtering method, an ion plating method, a plasma CVD method, etc.), but it is preferable to form it by a coating method since it can be produced at low cost. Preferred examples of the coating method include a dip coating method, an air knife coating method, a curtain coating method, a roller coating method, a wire bar coating method, gravure coating, and a microgravure method.

The film thickness of the low refractive index layer is preferably 30 to 200 nm, more preferably 50 to 150 nm, and most preferably 60 to 120 nm.

The medium refractive index layer and the high refractive index layer preferably have a configuration in which high refractive index superfine inorganic compound particles having an average particle size of 100 nm or less are dispersed in a matrix material. As the high refractive index fine inorganic compound particles, an inorganic compound having a refractive index of 1.65 or greater can preferably be used, and examples thereof include oxides of Ti, Zn, Sb; Sn, Zr, Ce, Ta, La, In, etc. and composite oxides containing these metal atoms.

Such superfine particles can be used in a form in which the surface of the particles is coated with a surface treatment agent (a silane coupling agent, etc.: JP-A-11-295503, JP-A-11-153703, and JP-A-2000-9908, an anionic compound or an organometallic coupling agent: JP-A-2001-310432, etc.), in the form of a core-shell structure having the high refractive index particles as the core (JP-A-2001-166104, etc.), in a form in which a particular dispersant is used in combination therewith (for example, JP-A-11-153703, U.S. Pat. No. 6,210,858, JP-A-2002-277609, etc.), etc.

As the matrix material, a conventionally known thermoplastic resin, curable resin coating, etc. can be used, and a curable film obtained from a polyfunctional material described in JP-A-2000-47004, JP-A-2001-315242, JP-A-2001-31871, JP-A-2001-296401, etc., or a metal alkoxide composition described in JP-A-2001-293818, etc. can also be used.

The refractive index of the high refractive index layer is preferably 1.70 to 2.20. The thickness of the high refractive index layer is preferably 5 nm to 10 μm, and more preferably 10 nm to 1 μm.

The refractive index of the medium refractive index layer is adjusted so that it is a value between the refractive index of the low refractive index layer and the refractive index of the high refractive index layer. The refractive index of the medium refractive index layer is preferably 1.50 to 1.70.

The haze of the anti-reflection film is preferably 5% or less, and more preferably 3% or less. The strength of the film is preferably H or greater in a pencil hardness test in accordance with JIS K5400, more preferably 2H or greater, and most preferably 3H or greater.

### (4) Luminance Improving Film

The polarizing plate of the present invention can be used in combination with a luminance improving film. The luminance improving film has a function of separating circularly polarized light and linearly polarized light, is disposed between the polarizing plate and a backlight, and back-reflects or back-scatters either the circularly polarized light or the linearly polarized light toward the backlight side. Light re-reflected from the backlight part has a partially changed polarized state, and is partially transmitted when re-entering the luminance improving film and the polarizing plate; by repeating this process the light utilization rate increases, and the front luminance increases by about 1.4 times. As the luminance improving film, an anisotropic reflection system and an anisotropic scattering system are known, and both can be used in combination with the polarizing plate of the present invention.

In the anisotropic reflection system, a luminance improving film having anisotropic reflectivity and transmittance as a result of laminating a uniaxially stretched film and an unstretched film as multiple layers, and increasing a difference in refractive index in the stretching direction is known, and a multilayer film system employing a dielectric mirror principle (described in the specifications of WO95/17691, WO95/17692, and WO95/17699) and a cholesteric liquid crystal system (described in the specification of European Patent No. 606940A2 and JP-A-8-271731) are known. As a luminance improving film of the multilayer system employing the dielectric mirror principle, DBEF-E, DBEF-D, and DBEF-M (all manufactured by 3M) are preferably used, and as a luminance improving film of the cholesteric liquid crystal system NIPOCS (manufactured by Nitto Denko Corporation) is preferably used in the present invention. With regard to NIPOCS, Nitto Giho, Vol. 38, No. 1, May, 2000, pp. 19 to 21, etc. can be referred to.

Furthermore, in the present invention, the combined use of a luminance improving film of an anisotropic scattering system formed by blending and uniaxially stretching a polymer having positive intrinsic birefringence and a polymer having negative intrinsic birefringence, described in the specifications of WO97/32223, WO97/32224, WO97/32225, and WO97/32226, JP-A-9-274108, and 11-174231, is also preferable. As the anisotropic scattering system luminance improving film, DRPF—H (manufactured by 3M) is preferable.

It is preferable that the polarizing plate of the present invention and the luminance improving film are used in a configuration in which they are laminated via a pressure sensitive adhesive or in an integral form in which one of the protective films of the polarizing plate is the luminance improving film.

### (5) Other Functional Optical Films

The polarizing plate of the present invention may preferably be used in further combination with a functional optical film provided with a hardcoat layer, a forward scattering layer, an anti-glare layer, a gas barrier layer, a slip layer, an antistatic layer, an undercoat layer, a protective layer, etc. Furthermore, these functional layers may also preferably be used by being combined, within the same layer, together with the anti-reflection layer of the above-mentioned anti-reflection film, the optically anisotropic layer of the viewing angle compensation film, etc. These functional layers may be provided on one surface on either the polarizer side or the side opposite to the polarizer (face closer to the air side), or on both surfaces.

### (5-1) Hardcoat Layer

The polarizing plate of the present invention is preferably used in combination with a functional optical film in which a hardcoat layer is provided on the surface of a transparent support in order to impart mechanical strength such as scratch resistance. When the hardcoat layer is used by applying it to the above-mentioned anti-reflection film, it is particularly preferable to provide it between the transparent support and the high refractive index layer.

The hardcoat layer is preferably formed by a crosslinking reaction or a polymerization reaction of a curable compound by means of light and/or heat. With regard to a curable functional group, a photopolymerizable functional group is preferable and, furthermore, with regard to a crosslinker, a hydrolyzable functional group-containing organometallic compound is preferable, and an organoalkoxysilyl compound is more preferable. With regard to specific compositions of the hardcoat layer, for example, those described in JP-A-2002-144913, JP-A-2000-9908, WO0/46617, etc. may preferably be used.

The film thickness of the hardcoat layer is preferably 0.2 to 100 μm.

The strength of the hardcoat layer is preferably H or greater in a pencil hardness test in accordance with JIS K5400, more preferably 2H or greater, and most preferably 3H or greater. Furthermore, in a Taber test in accordance with JIS K5400, the smaller the amount of abrasion of a test piece during the test, the more preferable it is.

As a material forming the hardcoat layer, an ethylenically unsaturated group-containing compound or a ring-opening polymerizable group-containing compound may be used, and these compounds may be used singly or in combination. Preferred examples of the ethylenically unsaturated group-containing compound include polyacrylates of polyols such as ethylene glycol diacrylate, trimethylolpropane triacrylate, ditrimethylolpropane tetraacrylate, pentaerythritol triacrylate, pentaerythritol tetraacrylate, dipentaerythritol pentaacrylate, and dipentaerythritol hexaacrylate; epoxy acrylates such as a diacrylate of bisphenol A diglycidyl ether and a diacrylate of hexanediol diglycidyl ether; and urethane acrylates obtained by a reaction between a polyisocyanate and a hydroxyl group-containing acrylate such as hydroxylethyl acrylate.

Examples of commercial compounds include EB-600, EB-40, EB-140, EB-1150, EB-1290K, IRR214, EB-2220, TMPTA, and TMPTMA (all manufactured by Daicel-UCB Co., Ltd.), and UV-6300 and UV-1700B (both manufactured by The Nippon Synthetic Chemical Industry Co., Ltd.).

Furthermore, preferred examples of the ring-opening polymerizable group-containing compound include glycidyl ethers such as ethylene glycol diglycidyl ether, bisphenol A diglycidyl ether, trimethylolethane triglycidyl ether, trimethylolpropane triglycidyl ether, glycerol triglycidyl ether, triglycidyltrishydroxylethyl isocyanurate, sorbitol tetraglycidyl ether, pentaerythritol tetraglycidyl ether, a polyglycidyl ether of a cresol novolac resin, and a polyglycidyl ether of a phenol novolac resin, alicyclic epoxies such as Celloxide 2021P, Celloxide 2081, Epolead GT-301, Epolead GT-401, and EHPE3150CE (all manufactured by Daicel Chemical Industries, Ltd.), a polycyclohexyl epoxy methyl ether of a phenol novolac resin, and oxetanes such as OXT-121, OXT-221, OX-SQ, and PNOX-1009 (all manufactured by Toagosei Co., Ltd.). In addition, a polymer of glycidyl (meth)acrylate, or a copolymer with a monomer that can be copolymerized with glycidyl (meth)acrylate can be used in the hardcoat layer.

In order to suppress curing shrinkage of the hardcoat layer, improve the intimacy of contact with a substrate, and suppress the curl of a hardcoat-treated product of the present invention, the hardcoat layer may preferably contain particles of silicon, titanium, zirconium, aluminum, etc. oxide, crosslinked particles of polyethylene, polystyrene, poly(meth)acrylic acid ester, or polydimethylsiloxane, or crosslinked particles of organic particles, including crosslinked rubber particles such as SBR or NBR. The average particle size of these crosslinked particles is preferably 1 nm to 20,000 nm. The shape of the crosslinked particles is not particularly limited, and spherical, rod-shaped, acicular, tabular, etc. may be used. The amount of crosslinked particles added is preferably 60 vol % or less of the cured hardcoat layer, and more preferably 40 vol % or less.

When the above-mentioned inorganic particles are added, since the compatibility with a binder polymer is generally poor, it is preferable to carry out a surface treatment using a surface treatment agent containing a metal such as silicon, aluminum, or titanium and having a functional group such as an alkoxide group, a carboxylic acid group, a sulfonic acid group, or a phosphonic acid group.

The hardcoat layer is preferably cured using heat or actinic radiation; it is more preferable to use actinic radiation such as radiation, a gamma beam, an alpha beam, an electron beam, or ultraviolet rays, and it is particularly preferable to use an electron beam or ultraviolet rays from the viewpoint of safety and productivity. When heat is used for curing, while taking into consideration the heat resistance of a plastic itself, the heating temperature is preferably 140° C. or less, and more preferably 100° C. or less.

### (5-2) Forward Scattering Layer

The forward scattering layer is used in order to improve viewing angle characteristics (hue and luminance distribution) in the vertical and lateral directions when the polarizing plate of the present invention is applied to a liquid crystal display device. In the present invention, it is preferable to employ a configuration in which particles having different refractive indices are dispersed in a binder and, for example, a configuration such as that of JP-A-11-38208 in which the forward scattering coefficient is specified, JP-A-2000-199809 in which the relative refractive index between a transparent resin and particles is specified, or JP-A-2002-107512 in which the haze value is set at 40% or greater may be employed. Furthermore, in order to control the haze viewing angle characteristics, it is also preferable to use the polarizing plate of the present invention in combination with ‘Lumisty’, which is described in the Sumitomo Chemical Technical Report ‘Photofunctional Films’ pp. 31 to 39.

### (5-3) Anti-Glare Layer

The anti-glare layer is used in order to scatter reflected light and prevent glare. An anti-glare function can be obtained by forming irregularities on the outermost surface (on the display side) of a liquid crystal display device. The haze of an optical film having an anti-glare function is preferably 3% to 30%, more preferably 5% to 20%, and most preferably 7% to 20%.

With regard to a method for forming irregularities on the film surface, for example, a method in which microparticles are added so as to form irregularities on a film surface (for example, JP-A-2000-271878, etc.), a method in which a small amount (0.1 to 50 wt %) of relatively large particles (particle size 0.05 to 2 μm) is added to form a film with an irregular surface (for example, JP-A-2000-281410, JP-A-2000-95893, JP-A-2001-100004, JP-A-2001-281407, etc.), a method in which an irregular shape is physically transferred to a film surface (for example, an embossing method described in JP-A-63-278839, JP-A-11-183710, JP-A-2000-275401, etc.), etc. may preferably be used.

### (Liquid Crystal Display Device Using Polarizing Plate)

A liquid crystal display device in which the polarizing plate of the present invention is used is now explained.

The liquid crystal display device of the present invention comprises a liquid crystal cell and two polarizing plates disposed on either side thereof, at least one of the polarizing plates being the polarizing plate of the present invention.

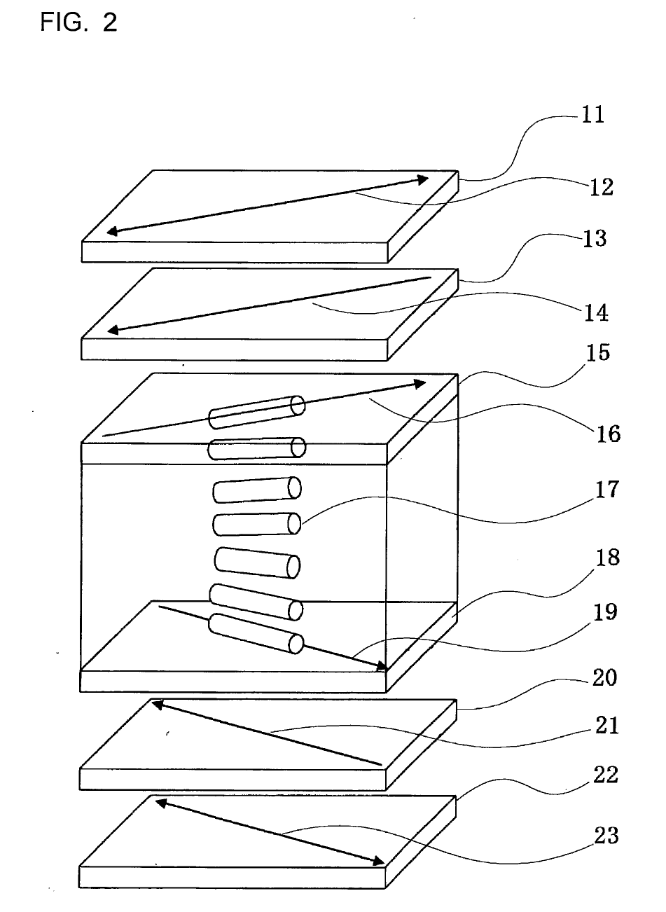

FIG. 2 is one example of the liquid crystal display device in which the polarizing plate of the present invention is used.

The liquid crystal display device shown in FIG. 2 comprises a liquid crystal cell (15 to 19), and an upper side polarizing plate 11 and a lower side polarizing plate 22 disposed so as to sandwich the liquid crystal cell (15 to 19). The polarizing plate is formed from a polarizer and a pair of transparent protective films between which the polarizer is held, but in FIG. 2 it is shown as an integrated polarizing plate, reference numerals in FIG. 2 denoting the following. 11: upper polarizing plate, 12: upper polarizing plate absorption axis, 13: upper optically anisotropic layer, 14: upper optically anisotropic layer alignment control direction, 15: liquid crystal cell upper electrode substrate, 16: upper substrate alignment control direction, 17: liquid crystal molecules, 18: liquid crystal cell lower electrode substrate, 19: lower substrate alignment control direction, 20: lower optically anisotropic layer, 21: lower optically anisotropic layer alignment control direction, 22: lower polarizing plate, and 23: lower polarizing plate absorption axis. The liquid crystal cell comprises the upper side substrate 15, the lower side substrate 18, and a liquid crystal layer formed from the liquid crystal molecules 17 held therebetween. Liquid crystal cells are classified into display modes such as TN (Twisted Nematic), IPS (In-Plane Switching), OCB (Optically Compensatory Bend), VA (Vertically Aligned), and ECB (Electrically Controlled Birefringence) according to an alignment state of liquid crystal molecules carrying out ON/OFF display, and the polarizing plate of the present invention can be used in both transmissive and reflective types and in any display mode.

An alignment film (not illustrated) is formed on surfaces of the substrates 15 and 18 that are in contact which the liquid crystal molecules 17 (hereinafter, also called ‘inner faces’), and the alignment of the liquid crystal molecules 17 in a state in which no electric field is applied or a state in which a low electric field is applied is controlled by a rubbing treatment, etc. applied to the alignment film. Furthermore, a transparent electrode (not illustrated) is formed on the inner faces of the substrates 15 and 18, the transparent electrodes being capable of applying an electric field to the liquid crystal layer comprising the liquid crystal molecules 17.

Rubbing directions for the TN mode are perpendicular to each other for the upper and lower substrates, and the magnitude of the tilt angle can be controlled by the strength and the number of times of rubbing, etc. The alignment film is formed by applying a polyimide film, followed by calcining. The magnitude of the twist angle of the liquid crystal layer is determined by the angle of intersection of the rubbing directions for the upper and lower substrates and by a chiral agent added to the liquid crystal material. Here, a chiral agent having a pitch of about 60 μm is added so as to achieve a twist angle of 90°.

The twist angle is set to be in the vicinity of 90° (850 to 950) for a liquid crystal display device for a laptop or desktop personal computer monitor or a television, and 0° to 70° for a reflective display device for a mobile telephone, etc. For the IPS mode and ECB mode, the twist angle is 0°. For the IPS mode, an electrode is disposed on the lower side substrate 8 alone, and an electric field that is parallel to the substrate face is applied. Furthermore, for the OCB mode, there is no twist angle and the tilt angle is made large, and for the VA mode the liquid crystal molecules 17 are aligned vertical to the upper and lower substrates.

Here, the magnitude of a product Δnd between a thickness d of the liquid crystal layer and a refractive index anisotropy Δn affects the brightness when white is displayed. Because of this, in order to maximize the brightness, the range for the magnitude is set for each display mode.

A high contrast is generally obtained when the intersection angle between the absorption axis 12 of the upper side polarizing plate 11 and the absorption axis 23 of the lower side polarizing plate 22 is substantially a right angle. Although the intersection angle between the absorption axis 12 of the upper side polarizing plate 11 of the liquid crystal cell and the rubbing direction for the upper side substrate 15 depends on the liquid crystal display mode, in the TN and IPS modes they are generally set to be parallel or perpendicular to each other. In the OCB and ECB modes, it is often set at 45°. However, in order to adjust the tone of the display color and the viewing angle, the optimum value varies for each display mode, and it is not limited to the above-mentioned range.

The liquid crystal display device in which the polarizing plate of the present invention is used is not limited to the configuration of FIG. 2, and another member may be included. For example, a color filter may be disposed between the liquid crystal cell and the polarizer. Furthermore, the above-mentioned viewing angle increasing film may additionally be disposed between the liquid crystal cell and the polarizing plate. The polarizing plate and the viewing angle increasing film may be arranged in the form of a laminate stuck together with a pressure sensitive adhesive, or may be arranged as a so-called integral elliptically polarizing plate in which one protective film on the liquid crystal cell side is used for increasing the viewing angle.

When the liquid crystal display device in which the polarizing plate of the present invention is used is of a transmission type, a cold cathode, a hot cathode fluorescent tube, or a backlight employing as the light source a light emitting diode, a field emission device, or an electroluminescent device can be disposed on the rear side. Furthermore, the liquid crystal display device in which the polarizing plate of the present invention is used may be of a reflection type, and in such a case, only one polarizing plate needs to be disposed on a viewing side, and a reflective film is placed on the rear face of the liquid crystal cell or the inner face of the lower side substrate of the liquid crystal cell. It is of course also possible to provide a front light employing the above-mentioned light source on the viewing side of the liquid crystal cell.

In the liquid crystal display device of the present invention, it is preferable that the protective film on the liquid crystal cell side relative to the polarizer (the protective film on the cell side) is a cycloolefin-based polymer film, and the protective film on the side opposite to the liquid crystal cell relative to the polarizer (the protective film on the air interface side) is a cellulose acylate film. This configuration is preferable since it can suppress the occurrence of display unevenness due to changes of application temperature and humidity.

### EXAMPLES

‘Parts’ in the Examples below denotes ‘parts by weight’.

<Synthesis of Resin a-1>

A reaction vessel flushed with nitrogen was charged with 227 parts of 8-methyl-8-methoxycarbonyltetracyclo[4.4.0.1^{2,5}.1^{7,10}]-3-dodecene as particular monomer d, 26 parts of 5-methoxycarbonylbicyclo[2.2.1]hept-2-ene as particular monomer e, 17 parts of 1-hexene as a molecular weight adjusting agent, and 753 parts of toluene as a solvent, and this solution was heated to 60° C. Subsequently, to the solution within the reaction vessel was added 0.62 parts of a toluene solution containing 1.5 mol/L of triethylaluminum as a polymerization catalyst, and 3.8 parts of a toluene solution (concentration 0.05 mol/L) containing t-butanol- and methanol-modified tungsten hexachloride (t-butanol:methanol:tungsten=0.35 mol:0.3 mol: 1 mol), and this system was heated and stirred at 85° C. for 3 hours so as to carry out a ring-opening copolymerization reaction, thus giving a ring-opened copolymer solution.

The degree of polymerization conversion in this polymerization reaction was 96%, and the inherent viscosity (ηᵢₙₕ) of the ring-opened copolymer forming the ring-opened copolymer solution thus obtained was measured in chloroform at 30° C. and found to be 0.64 dl/g.

4,000 parts of the ring-opened copolymer solution thus obtained was placed in an autoclave, 0.48 parts of carbonylchlorohydridotris(tri phenylphosphine)ruthenium: RuHCl (CO)[P(C₆H₅)₃]₃ was added to this ring-opened copolymer solution, and the mixture was heated and stirred at a hydrogen gas pressure of 100 kg/cm² and a reaction temperature of 165° C. for 3 hours so as to carry out a hydrogenation reaction.

The reaction mixture thus obtained (hydrogenated polymer solution) was cooled, and the hydrogen gas was then released. This reaction mixture was poured into a large amount of methanol, and an aggregate was separated, collected, and dried to give a hydrogenated polymer (hereinafter, ‘resin (a-1)’).

The degree of hydrogenation of the resin (a-1) thus obtained was measured using ¹H-NMR spectroscopy (400 MHz), and found to be 99.9%.

The proportion of a structural unit e derived from 5-methoxycarbonylbicyclo[2.2.1]hept-2-ene in the resin (a-1) was measured using ¹H-NMR spectroscopy (400 MHz), and was found to be 19.5% when calculation was carried out using an absorption peak appearing in the vicinity of about 3.7 ppm due to methyl protons of the methyl ester of a structural unit d derived from 8-methyl-8-methoxycarbonyltetracyclo[4.4.0.1^{2,5}.1^{7,10}]-3-dodecene and an absorption peak appearing at 0.15 to 3 ppm due to protons of the alicyclic structure of the structural unit d and the structural unit e. Furthermore, a fraction having a weight-average molecular weight Mw, calculated using polystyrene as a standard, not exceeding 10,000, a fraction in the range of over 10,000 but not exceeding 30,000, and a fraction exceeding 30,000 were collected by gel permeation chromatography (GPC), and when the proportion of the structural unit e in each sample was checked by ¹H-NMR spectroscopy (400 MHz), variation from a value of 19.5%, which was the proportion for the entire resin (a-1), was within 15% for all samples.

(Preparation of Polarizing Plate Protective Film a-1)

The resin (a-1) was dissolved in toluene so as to give a concentration of 30%. The solution viscosity at room temperature of the solution thus obtained was 30,000 mPa·s.

Pentaerythrityltetrakis[3-(3,5-di-t-butyl-4-hydroxyphenyl)propionate] was added as an antioxidant to this solution at 0.1 parts by weight relative to 100 parts by weight of the resin (a-1), and the solution thus obtained was filtered using a sintered metal fiber filter having a pore size of 5 μm manufactured by Nihon Pall Ltd. while controlling the flow rate of the solution so that a pressure difference was within 0.4 MPa, and was then applied to a 100 μm thick PET film (‘Lumirror U94’ manufactured by Toray Industries, Inc.) that had been hydrophilized (adhesion promoted) with an acrylic acid-based surface treatment agent using an ‘INVEX Labcoater’ manufactured by Inoue Kinzoku Kogyo Co., Ltd. placed in a class 1000 cleanroom.

Subsequently, the liquid layer thus obtained was subjected to a primary drying treatment at 50° C., then a secondary drying treatment at 90° C., and then peeled off from the PET film to give an 80 μm thick polarizing plate protective film (A-1). The film (A-1) thus obtained had a residual solvent level of 0.5 wt % and a light transmittance of 93% or greater.

<Synthesis of Resin a-2>

A reaction vessel flushed with nitrogen was charged with 225 parts of 8-methyl-8-methoxycarbonyl-9-methoxycarbonyltetracyclo[4.4.0.1^{2,5}.1^{7,10}]-3-dodecene as particular monomer d, 25 parts of bicyclo[2.2.1]hept-2-ene as particular monomer e, 18 parts of 1-hexene as a molecular weight adjusting agent, and 753 parts of toluene as a solvent, and this solution was heated to 60° C. Subsequently, to the solution within the reaction vessel was added 0.62 parts of a toluene solution containing 1.5 mol/L of triethylaluminum as a polymerization catalyst, and 3.8 parts of a toluene solution containing a 0.05 mol/L concentration of t-butanol- and methanol-modified tungsten hexachloride (t-butanol:methanol:tungsten=0.35 mol: 0.3 mol: 1 mol), and this system was heated and stirred at 85° C. for 3 hours so as to carry out a ring-opening copolymerization reaction, thus giving a ring-opened copolymer solution.

The degree of polymerization conversion in this polymerization reaction was 95%, and the inherent viscosity (ηᵢₙₕ) of the ring-opened copolymer forming the ring-opened copolymer solution thus obtained was measured in chloroform at 30° C. and found to be 0.68 dl/g.

4,000 parts of the ring-opened copolymer solution thus obtained was placed in an autoclave, 0.48 parts of carbonylchlorohydridotris(triphenylphosphine)ruthenium: RuHCl (CO)[P(C₆H₅)₃]₃ was added to this ring-opened copolymer solution, and the mixture was heated and stirred at a hydrogen gas pressure of 100 kg/cm² and a reaction temperature of 165° C. for 3 hours so as to carry out a hydrogenation reaction.

The reaction mixture thus obtained (hydrogenated polymer solution) was cooled, and the hydrogen gas was then released. This reaction mixture was poured into a large amount of methanol, and an aggregate was separated, collected, and dried to give a hydrogenated polymer (hereinafter, ‘resin (a-2)’).

The degree of hydrogenation of the resin (a-2) thus obtained was measured using ¹H-NMR spectroscopy (400 MHz), and found to be 99.9%.

The proportion of a structural unit e derived from bicyclo[2.2.1]hept-2-ene in the resin (a-2) was measured using ¹H-NMR spectroscopy (400 MHz), and was found to be 19.4% when calculation was carried out using an absorption peak appearing in the vicinity of about 3.7 ppm due to methyl protons of the methyl ester of a structural unit d derived from 8-methyl-8-methoxycarbonyl-9-methoxycarbonyltetracyclo[4.4.0.1^{2,5}.1^{7.10}]-3-dodecene and an absorption peak appearing at 0.15 to 3 ppm due to protons of the alicyclic structure of the structural unit d and the structural unit e. Furthermore, a fraction having a weight-average molecular weight Mw, calculated using polystyrene as a standard, not exceeding 10,000, a fraction in the range of over 10,000 but not exceeding 30,000, and a fraction exceeding 30,000 were collected by gel permeation chromatography (GPC), and when the proportion of the structural unit e in each sample was checked by ¹H-NMR spectroscopy (400 MHz), the variation from a value of 19.4%, which was the proportion for the entire resin (a-2), was within 15% for all samples.

### (Preparation of Polarizing Plate Protective Film A-2)

A resin film (a-2) having a residual solvent level of 0.4 wt % was prepared in the same manner as for the polarizing plate protective film A-1 except that the resin (a-2) was used instead of the resin (a-1).

Furthermore, the resin film (a-2) was heated to 120° C. (Tg+10° C.) within a tenter and stretched by 1.05 times in the lengthwise film in-plane direction at a stretching speed of 300%/min, then stretched 1.3 times in the sideways film in-plane direction, subsequently cooled under an atmosphere at 90° C. (Tg−20° C.) for 1 minute while maintaining this state, further cooled to room temperature, and taken out of the tenter to give a polarizing plate protective film (A-2). The thickness was 64 μm.

(Preparation of Resin a-3)

A 2,000 mL reaction vessel was charged under nitrogen with, as monomers, 750 mmol (70.5 g) of 5,6-di(methoxycarbonyl)-bicyclo[2.2.1]hept-2-ene, 475 mmol (63.6 g) of tricyclo[5.2.1.0^{2,6}]dec-8-ene having an endo content of 95%, and 25 mmol (6.4 g) of 5-triethoxysilyi-bicyclo[2.2.1]hept-2-ene, as solvents, 562 g of cyclohexane and 141 g of methylene chloride, and as a molecular weight adjusting agent 15.0 mmol of styrene. As Ni atom, 0.25 mmol of a hexafluoroantimonic acid-modified Ni octanoate formed by reacting a hexane solution of Ni octanoate and hexafluoroantimonic acid at −10° C. at a molar ratio of 1:1 in advance, removing a precipitated Ni (SbF₆)₂ by-product, and diluting with a toluene solution, 2.50 mmol of triethylaluminum, and 0.75 mmol of boron trifluoride ethyl etherate were charged and polymerization was carried out. Polymerization was carried out at 25° C. for 3 hours and terminated using methanol. The degree of conversion of the monomers into copolymer was 80%.

660 mL of water and 47.5 mmol of lactic acid were added to the copolymer solution, stirred and mixed, and reacted with a catalyst component, and allowed to stand so as to separate a copolymer solution and water. A copolymer solution obtained by removing the aqueous phase, which contained a reaction product of the catalyst component, was poured into 3 L of isopropyl alcohol so as to solidify the copolymer, and unreacted monomer and catalyst residue were removed. The solidified copolymer was dried to give a copolymer A.

From gas chromatographic analysis of unreacted monomer in the copolymer solution, it was found that the proportion of a structural unit derived from tricyclo[5.2.1.0^{2,6}]dec-8-ene was 32 mol % in the copolymer A. The proportion of a structural unit derived from 5-triethoxysilyl-bicyclo[2.2.1]hept-2-ene was 2.0 mol %.

The number-average molecular weight (Mn), calculated using polystyrene as a standard, of the copolymer A was 142,000, the weight-average molecular weight (Mw) was 284,000, and Mw/Mn was 2.0. The glass transition temperature of the copolymer A was 390° C. The copolymer A could be dissolved in cyclohexane at 25° C., but could not be dissolved in n-heptane.

### (Preparation of Polarizing Plate Protective Film A-3)

10 g of the copolymer A was dissolved in a mixed solvent of cyclohexane (45 mL), which was a good solvent, and n-heptane (5 mL), which was a poor solvent; as antioxidants 0.6 parts by weight each, relative to 100 parts by weight of the polymer, of pentaerythrityl-tetrakis[3-(3,5-di-t-butyl-4-hydroxyphenyl) propionate] and tris(2,4-di-t-butylphenyl) phosphite, and as a crosslinking agent 0.05 parts by weight, relative to 100 parts by weight of the polymer, of tributyl phosphite were added to the solution. This polymer solution was filtered using a membrane filter having a pore size of 10 μm so as to remove foreign bodies, and then cast at 25° C., the temperature of the atmosphere was gradually increased up to 50° C. so as to evaporate the mixed solvent, and after the residual solvent in the film became 2%, it was exposed to steam at 150° C. for 3 hours to crosslink the film. Subsequently, it was dried in vacuum at 100° C. for 30 min so as to remove water from the surface to give a resin film a-3.

The resin film (a-3) was heated to 125° C. within a tenter, stretched 1.05 times in the lengthwise film in-plane direction at a stretching speed of 300%/min while maintaining a constant width in the sideways direction, then cooled under an atmosphere at 90° C. for about 1 min while maintaining this state, further cooled to room temperature, and taken out of the tenter to give a polarizing plate protective film (A-3). The thickness was 79 μm.

(Synthesis of Resin a-4)

A reaction vessel flushed with nitrogen was charged with 225 parts of 8-methyl-8-methoxycarbonyltetracyclo[4.4.0.1^{2,5}.1^{7,10}]-3-dodecene as particular monomer d, 25 parts of bicyclo[2.2.1]hept-2-ene as particular monomer e, 18 parts of 1-hexene as a molecular weight adjusting agent, and 750 parts of toluene as a solvent, and this solution was heated to 60° C. Subsequently, the solution within the reaction vessel was mixed with 0.62 parts of a toluene solution containing 1.5 mol/L of triethylaluminum as polymerization catalyst, and 3.7 parts of a toluene solution containing a 0.05 mol/L concentration of t-butanol- and methanol-modified tungsten hexachloride (t-butanol:methanol:tungsten=0.35 mol:0.3 mol: 1 mol), and this system was heated and stirred at 80° C. for 3 hours so as to carry out a ring-opening copolymerization reaction, thus giving a ring-opened copolymer solution.

The degree of polymerization conversion in this polymerization reaction was 97%, and the inherent viscosity (ηᵢₙₕ) of the ring-opened copolymer forming the ring-opened copolymer solution thus obtained was measured in chloroform at 30° C. and found to be 0.65 dl/g.

4,000 parts of the ring-opened copolymer solution thus obtained was placed in an autoclave, 0.48 parts of carbonylchlorohydridotris(triphenyl phosphine)ruthenium: RuHCl(CO)[P(C₆H₅)₃]₃ was added to this ring-opened copolymer solution, and the mixture was heated and stirred at a hydrogen gas pressure of 100 kg/cm² and a reaction temperature of 165° C. for 3 hours so as to carry out a hydrogenation reaction.

The reaction mixture thus obtained (hydrogenated polymer solution) was cooled, and the hydrogen gas was then released. This reaction mixture was poured into a large amount of methanol, and an aggregate was separated, collected, and dried to give a hydrogenated polymer (hereinafter, also called ‘resin (a-4)’).

The degree of hydrogenation of the resin (a-4) thus obtained was measured using ¹H-NMR spectroscopy (400 MHz), and found to be 99.9%.

The proportion of a structural unit e derived from bicyclo[2.2.1]hept-2-ene in the resin (a-4) was measured using ¹H-NMR spectroscopy (400 MHz), and was found to be 20.1% when calculation was carried out using an absorption peak appearing in the vicinity of about 3.7 ppm due to methyl protons of the methyl ester of a structural unit d derived from 8-methyl-8-methoxycarbonyltetracyclo[4.4.0.1^{2,5}.1^{7,10}]-3-dodecene and an absorption peak appearing at 0.15 to 3 ppm due to protons of the alicyclic structure of the structural unit d and the structural unit e.

Furthermore, a fraction having a weight-average molecular weight Mw, calculated using polystyrene as a standard, not exceeding 10,000, a fraction in the range of over 10,000 but not exceeding 30,000, and a fraction exceeding 30,000 were collected by gel permeation chromatography (GPC), and when the proportion of the structural unit e in each sample was checked by ¹H-NMR spectroscopy (400 MHz), the variation from a value of 20.1%, which was the proportion for the entire resin (a-4), was within 15% for all samples.

### (Preparation of Polarizing Plate Protective Film A-4)

The resin (a-4) was dissolved in toluene so as to give a concentration of 30%. The solution viscosity at room temperature of the solution thus obtained was 30,000 mPa·s.

Pentaerythrityltetrakis[3-(3,5-di-t-butyl-4-hydroxyphenyl) propionate] was added as an antioxidant to this solution at 0.1 parts by weight relative to 100 parts by weight of the resin (a-4), and the solution thus obtained was filtered using a sintered metal fiber filter having a pore size of 5 μm manufactured by Nihon Pall Ltd. while controlling the flow rate of the solution so that a pressure difference was within 0.4 MPa, and was then applied to a 100 μm thick PET film (‘Lumirror U94’ manufactured by Toray Industries, Inc.) that had been hydrophilized (adhesion promoted) with an acrylic acid-based surface treatment agent using an ‘INVEX Labcoater’ manufactured by Inoue Kinzoku Kogyo Co., Ltd. placed in a class 1000 cleanroom.

Subsequently, the liquid layer thus obtained was subjected to a primary drying treatment at 50° C., then a secondary drying treatment at 90° C., and then peeled off from the PET film to give a 99 μm thick resin film (hereinafter, also called ‘resin film (a-4)’). The resin film (a-4) thus obtained had a residual solvent level of 0.5 wt % and a light transmittance of 93% or greater.

(Preparation of Resin a-5)

A 2,000 mL reaction vessel was charged under nitrogen with, as monomers, 750 mmol (70.5 g) of bicyclo[2.2.1]hept-2-ene, 475 mmol (63.6 g) of tricyclo[5.2.1.0^{2,6}]dec-8-ene having an endo content of 95%, and 25 mmol (6.4 g) of 5-triethoxysilyl-bicyclo[2.2.1]hept-2-ene, as solvents, 562 g of cyclohexane and 141 g of methylene chloride, and as a molecular weight adjusting agent 15.0 mmol of styrene. As Ni atom, 0.25 mmol of a hexafluoroantimonic acid-modified Ni octanoate formed by reacting a hexane solution of Ni octanoate and hexafluoroantimonic acid at −10° C. at a molar ratio of 1:1 in advance, removing a precipitated Ni (SbF₆)₂ by-product, and diluting with a toluene solution, 2.50 mmol of triethylaluminum, and 0.75 mmol of boron trifluoride ethyl etherate were charged and polymerization was carried out. The polymerization was carried out at 25° C. for 3 hours and terminated using methanol. The degree of conversion of the monomers into copolymer was 80%.

660 mL of water and 47.5 mmol of lactic acid were added to the copolymer solution, stirred and mixed, reacted with a catalyst component, and allowed to stand so as to separate a copolymer solution and water. A copolymer solution obtained by removing the aqueous phase, which contained a reaction product of the catalyst component, was poured into 3 L of isopropyl alcohol so as to solidify the copolymer, and unreacted monomer and catalyst residue were removed. The solidified copolymer was dried to give a copolymer A.

From gas chromatographic analysis of unreacted monomer in the copolymer solution, it was found that the proportion of a structural unit derived from tricyclo[5.2.1.0^{2,6}]dec-8-ene was 35 mol % in the copolymer A. The proportion of a structural unit derived from 5-triethoxysilyl-bicyclo[2.2.1]hept-2-ene was 2.0 mol %.

The number-average molecular weight (Mn), calculated using polystyrene as a standard, of the copolymer A was 142,000, the weight-average molecular weight (Mw) was 284,000, and Mw/Mn was 2.0. The glass transition temperature of the copolymer A was 390° C. The copolymer A could be dissolved in cyclohexane at 25° C., but could not be dissolved in n-heptane.

### (Preparation of Polarizing Plate Protective Film A-5)

10 g of the copolymer A was dissolved in a mixed solvent of cyclohexane (45 mL), which was a good solvent, and n-heptane (5 mL), which was a poor solvent; as antioxidants 0.6 parts by weight each, relative to 100 parts by weight of the polymer, of pentaerythrityl-tetrakis[3-(3,5-di-t-butyl-4-hydroxyphenyl) propionate] and tris(2,4-di-t-butylphenyl) phosphite, and as a crosslinking agent 0.05 parts by weight, relative to 100 parts by weight of the polymer, of tributyl phosphite were added to the solution. This polymer solution was filtered using a membrane filter having a pore size of 10 μm so as to remove foreign bodies, and then cast at 25° C., the temperature of the atmosphere was gradually increased up to 50° C. so as to evaporate the mixed solvent, and after the residual solvent in the film became 2%, it was exposed to steam at 150° C. for 3 hours to crosslink the film. Subsequently, it was dried in vacuum at 100° C. for 30 min so as to remove water from the surface to give a resin film a-5.

The resin film (a-5) was heated to 130° C. within a tenter, stretched 1.15 times in the lengthwise film in-plane direction at a stretching speed of 300%/min, then stretched 1.4 times in the sideways direction, further cooled under an atmosphere at 90° C. for about 1 min while maintaining this state, further cooled to room temperature, and taken out of the tenter to give a polarizing plate protective film (A-5). The thickness was 84 μm.

(Preparation of Polarizing Plate Protective Film B-1)

The composition below was charged into a mixing tank and stirred while heating so as to dissolve each component to give a cellulose acylate solution A.

### <Cellulose Acylate Solution a Composition>

| | | |
|---|---|---|
| Cellulose acetate having a degree of | 100 | parts by weight |
| acetylation of 61.0% | | |
| Methylene chloride (first solvent) | 250 | parts by weight |
| Ethanol (second solvent) | 80 | parts by weight |
| Hydrophobicizing agent (C-7) | 4 | parts by weight |
| Hydrophobicizing agent (I-2) | 6 | parts by weight |

### <Preparation of Matting Agent Solution>

The composition below was charged into a disperser and stirred so as to dissolve each component to give a matting agent solution.

Matting agent solution composition

| | | |
|---|---|---|
| Silica particles having an average particle | 2.0 | parts by weight |
| size of 16 nm (AEROSIL R972, | | |
| manufactured by Nippon Aerosil Co., Ltd.) | | |
| Methylene chloride (first solvent) | 76.3 | parts by weight |
| Methanol (second solvent) | 11.4 | parts by weight |
| Cellulose acylate solution A | 10.3 | parts by weight |

### <Preparation of Ultraviolet Absorbing Agent Solution B>

The composition below was charged into another mixing tank and stirred while heating so as to dissolve each component to give an ultraviolet absorbing agent solution B.

### <Ultraviolet Absorbing Agent Solution B Composition>

| | |
|---|---|
| Methylene chloride | 64 parts by weight |
| Ethanol | 16 parts by weight |
| Ultraviolet absorbing agent (1) | 3 parts by weight |
| Ultraviolet absorbing agent (2) | 6 parts by weight |

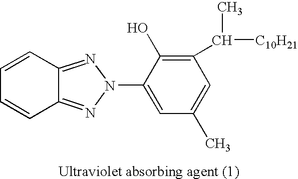

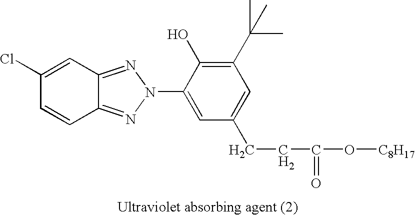

94.6 parts by weight of the cellulose acylate solution A, 1.3 parts by weight of the matting agent solution, and 4.1 parts by weight of the ultraviolet absorbing agent solution (B) were each filtered, then mixed, and cast using a band casting machine. When the residual solvent level was 40%, the film was peeled off from the band, and a film having a residual solvent level of 13 wt % was stretched sideways at a stretching ratio of 4% using a tenter at 100° C., and held at 140° C. for 30 sec while maintaining the width after stretching. Subsequently, clips were removed, and drying at 130° C. was carried out for 40 min to give a cellulose acetate film. The residual solvent level of the resulting cellulose acetate film was 0.15%, and the film thickness was 80 μm.

### (Preparation of Polarizing Plate Protective Film B-2)<

### <Cellulose Acylate Solution C Composition>

| | | |
|---|---|---|
| Cellulose acetate having a degree of | 50 | parts by weight |
| acetylation of 61.2% | | |
| Cellulose acetate having a degree of | 50 | parts by weight |
| acetylation of 60.6% | | |
| Hydrophobicizing agent (C-1) | 7.5 | parts by weight |
| Hydrophobicizing agent (I-2) | 7.5 | parts by weight |
| Methylene chloride (first solvent) | 300 | parts by weight |
| Methanol (second solvent) | 54 | parts by weight |
| 1-Butanol | 11 | parts by weight |

The composition below was charged into another mixing tank and stirred while heating so as to dissolve each component to give an ultraviolet absorbing agent solution D.

### <Ultraviolet Absorbing Agent Solution D Composition>

| | |
|---|---|
| Methylene chloride | 80 parts by weight |
| Methanol | 20 parts by weight |
| Ultraviolet absorbing agent (3) | 2 parts by weight |
| Ultraviolet absorbing agent (4) | 4 parts by weight |

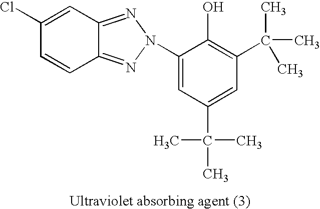

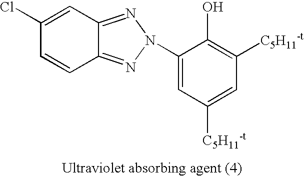

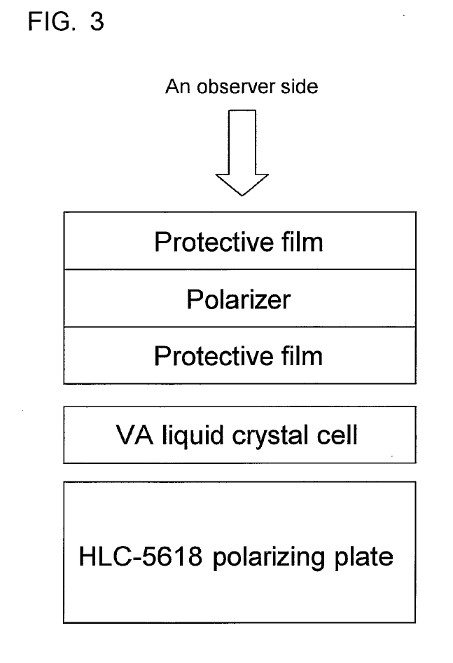

40 parts by weight of the ultraviolet absorbing agent solution D was added to 474 parts by weight of the cellulose acylate solution C, and the mixture was stirred well to give a dope. The dope was cast via a casting aperture onto a drum cooled to 0° C. It was peeled off when the solvent content was 50 wt %, opposite edges in the width direction of the film were fixed by means of a pin tenter (a pin tenter described in FIG. 3 of JP-A-4-1009), and dried at 80° C. until the solvent content became 5 wt % while maintaining a gap that gave a stretching ratio of 4% in the sideways direction (a direction perpendicular to the machine direction) (drying step 1). Subsequently, by feeding between rollers of a thermal treatment machine, it was dried at 140° C. to give a 70 μm thick polarizing plate protective film (B-2).

### (Preparation of Polarizing Plate Protective Film B-3)

40 parts by weight of the ultraviolet absorbing agent solution D was added to 474 parts by weight of the cellulose acylate solution C, and the mixture was stirred well to give a dope. The dope was cast via a casting aperture onto a drum cooled to 0° C. It was peeled off when the solvent content was 80 wt %, opposite edges in a width direction of the film were fixed by means of a pin tenter (a pin tenter described in FIG. 3 of JP-A-4-1009), and dried at 120° C. until the solvent content became 5 wt % while maintaining a gap that gave a stretching ratio of 4% in the sideways direction (a direction perpendicular to the machine direction) (drying step 1). Subsequently, by feeding between rollers of a thermal treatment machine, it was dried at 140° C. to give an 80 μm thick polarizing plate protective film (B-3).

### (Preparation of Polarizing Plate Protective Film B-4)<

### Preparation of Cellulose Acylate Solution E>

The composition below was charged into a mixing tank and stirred so as to dissolve each component to give a cellulose acylate solution E.

### Cellulose Acylate Solution E Composition

### Cellulose Acetate Having a Degree of Acetylation of 60.7%

| | | |
|---|---|---|
| Cellulose acetate having a degree of acetylation of 60.7% | 100.0 | parts by weight |
| Hydrophobicizing agent (C-6) | 8.0 | parts by weight |
| Hydrophobicizing agent (I-2) | 2.0 | parts by weight |
| Retardation increasing agent 1 (plasticizer) | 4.0 | parts by weight |
| Methylene chloride (first solvent) | 402.0 | parts by weight |
| Methanol (second solvent) | 60.0 | parts by weight |

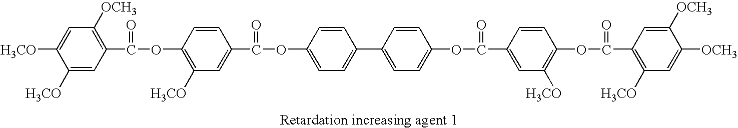

### <Preparation of Matting Agent Solution>

The composition below was charged into a disperser and stirred so as to dissolve each component to give a matting agent solution.

### Matting Agent Solution Composition

| | | |
|---|---|---|
| Silica particles having an average particle | 2.0 | parts by weight |
| size of 20 nm (AEROSIL R972, | | |
| manufactured by Nippon Aerosil Co., Ltd.) | | |
| Methylene chloride (first solvent) | 75.0 | parts by weight |
| Methanol (second solvent) | 12.7 | parts by weight |
| Cellulose acylate solution E | 10.3 | parts by weight |

<Preparation of retardation increasing agent solution>

The composition below was charged into a mixing tank and stirred while heating so as to dissolve each component to give a retardation increasing agent solution.

Retardation increasing agent solution F composition

| | | |
|---|---|---|
| Retardation increasing agent 1 | 20.0 | parts by weight |
| Methylene chloride (first solvent) | 58.4 | parts by weight |
| Methanol (second solvent) | 8.7 | parts by weight |
| Cellulose acylate solution E | 12.8 | parts by weight |

1.3 parts by weight of the matting agent solution and 2.9 parts by weight of the retardation increasing agent solution F were each filtered and then mixed using an in-line mixer, 96.1 parts by weight of the cellulose acylate solution E was further added thereto and mixed using the in-line mixer and casting was carried out using a band casting machine. When the residual solvent content became 48%, the film was peeled off from the band, and the film was stretched sideways up to 120% using a tenter at an atmosphere temperature of 140° C., and held at 140° C. for 30 sec. The residual solvent content when stretching started was 23%. Subsequently, clips were removed, and drying was carried out at 130° C. for 40 min to give a cellulose acylate film. The residual solvent level of the resulting cellulose acylate film was 0.1%, and the film thickness was 95 μm.

### (Preparation of Polarizing Plate Protective Film B-5)

### <Preparation of Cellulose Acylate Solution G>

The composition below was charged into a mixing tank and stirred so as to dissolve each component to give a cellulose acylate solution G.

Cellulose acylate solution G composition

| | | |
|---|---|---|
| Cellulose acetate having a degree of | 100.0 | parts by weight |
| acetylation of 60.0% | | |
| Hydrophobicizing agent (C-7) | 7.0 | parts by weight |
| Hydrophobicizing agent (C-1) | 2.0 | parts by weight |
| Retardation increasing agent 1 (plasticizer) | 4.0 | parts by weight |
| Methylene chloride (first solvent) | 402.0 | parts by weight |
| Methanol (second solvent) | 60.0 | parts by weight |

### <Preparation of Matting Agent Solution>

The composition below was charged into a disperser and stirred so as to dissolve each component to give a matting agent solution.

Matting agent solution composition

| | | |
|---|---|---|
| Silica particles having an average particle | 2.0 | parts by weight |
| size of 20 nm (AEROSIL R972, | | |
| manufactured by Nippon Aerosil Co., Ltd.) | | |
| Methylene chloride (first solvent) | 75.0 | parts by weight |
| Methanol (second solvent) | 12.7 | parts by weight |
| Cellulose acylate solution G | 10.3 | parts by weight |

### <Preparation of Retardation Increasing Agent Solution H>

The composition below was charged into a mixing tank and stirred while heating so as to dissolve each component to give a retardation increasing agent solution.

Retardation increasing agent solution H composition

| | | |
|---|---|---|
| Retardation increasing agent 1 | 20.0 | parts by weight |
| Methylene chloride (first solvent) | 58.4 | parts by weight |
| Methanol (second solvent) | 8.7 | parts by weight |
| Cellulose acylate solution G | 12.8 | parts by weight |

1.3 parts by weight of the matting agent solution and 4.9 parts by weight of the retardation increasing agent solution H were each filtered and then mixed using an in-line mixer, 94.1 parts by weight of the cellulose acylate solution A was further added thereto and mixed using the in-line mixer and casting was carried out using a band casting machine. When the residual solvent content became 48%, the film was peeled off from the band, and the film was stretched sideways up to 125% using a tenter at an atmosphere temperature of 145° C., and held at 145° C. for 30 sec. The residual solvent content when stretching started was −29%. Subsequently, clips were removed, and drying was carried out at 130° C. for 40 min to give a cellulose acylate film. The residual solvent level of the resulting cellulose acylate film was 0.1%, and the film thickness was 95 μm.

### (Preparation of Polarizing Plate Protective Film B-6)

<Cellulose acylate solution I composition>

| | | |
|---|---|---|
| Cellulose acetate having a degree of | 50 | parts by weight |
| acetylation of 61.2% | | |
| Cellulose acetate having a degree of | 50 | parts by weight |
| acetylation of 60.6% | | |
| Triphenyl phosphate (hydrophobicizing agent) | 7.8 | parts by weight |
| Biphenyldiphenyl phosphate | 3.9 | parts by weight |
| (hydrophobicizing agent) | | |
| Methylene chloride (first solvent) | 300 | parts by weight |
| Methanol (second solvent) | 54 | parts by weight |
| 1-Butanol | 11 | parts by weight |

The composition below was charged into another mixing tank and stirred while heating so as to dissolve each component to give an ultraviolet absorbing agent solution J.

### <Ultraviolet Absorbing Agent Solution J Composition>

| | |
|---|---|
| Methylene chloride | 80 parts by weight |
| Methanol | 20 parts by weight |
| Ultraviolet absorbing agent (3) | 2 parts by weight |
| Ultraviolet absorbing agent (4) | 4 parts by weight |

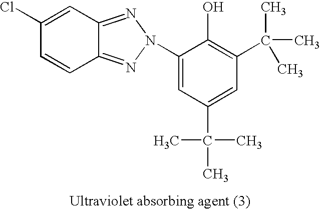

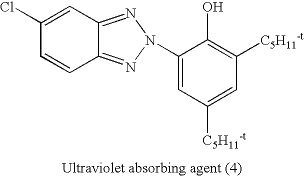

40 parts by weight of the ultraviolet absorbing agent solution J was added to 474 parts by weight of the cellulose acylate solution 1, and the mixture was stirred well to give a dope. The dope was cast via a casting aperture onto a drum cooled to 0° C. It was peeled off when the solvent content was 50 wt %, opposite edges in the width direction of the film were fixed by means of a pin tenter, and dried at 80° C. until the solvent content became 5 wt % while maintaining a gap that gave a stretching ratio of 4% in the sideways direction (a direction perpendicular to the machine direction). Subsequently, by feeding between rollers of a thermal treatment machine, it was further dried at 140° C. to give an 80 μm thick polarizing plate protective film B-6.

### {Measurement of Film Physical Properties}

### (Measurement of Optical Properties)

Re and Rth were measured using an automated birefringence meter (KOBRA-21ADH, manufactured by Oji Scientific Instruments) at 25° C. and 60% RH. The measurement wavelength was 590 nm. The results are shown in Table 1.

### (Measurement of Moisture Permeability)

Moisture permeability at 60° C. and 95% RH over 24 hr was measured in accordance with JIS Z-0208.

### (Measurement of Modulus of Elasticity)

A sample was conditioned under an environment of 25° C. and 60% RH for 24 hr, and the modulus of elasticity was measured in accordance with a method described in JIS K7127. A Tensilon tensile tester manufactured by A & D Co., Ltd. was used, a sample was 50 mm×10 mm, a clip distance was 30 mm, and a test speed was 30 mm/min.

### (Crystallinity)

The crystallinity of polarizing plate protective films B-1 to B-6 was measured by the method below.

A diffraction pattern of a sample was measured using a JDX-11RA manufactured by JEOL Co., Ltd. The sum of values obtained by subtracting a diffraction strength at a Bragg angle 2θ=14° from a measured diffraction peak was defined as the crystallinity. A scanning range was 2θ=5° to 35°.

Measurement results of the film physical properties are given in Table 1.

TABLE 1

| | | | | MD (Transport direction) | | TD (Width direction) | |
|---|---|---|---|---|---|---|---|
| | | | | Modulus of | Modulus of | Modulus of | Modulus of |
| | | | | elasticity at | elasticity at | elasticity at | elasticity at |
| Sample | Thickness | Re | Rth | 25° C./10% RH | 25° C./80% RH | 25° C./10% RH | 25° C./80% RH |
| No. | (μm) | (μm) | (μm) | (kgf/mm²) | (kgf/mm²) | (kgf/mm²) | (kgf/mm²) |
| A-1 | 80 | 4 | 8 | 234 | 226 | 235 | 224 |
| A-2 | 64 | 52 | 126 | 222 | 210 | 292 | 270 |
| A-3 | 79 | 15 | 51 | 227 | 206 | 297 | 271 |
| A-4 | 99 | 5 | 40 | 229 | 230 | 226 | 229 |
| A-5 | 84 | 71 | 211 | 221 | 224 | 293 | 289 |
| B-1 | 80 | 4 | 150 | 450 | 430 | 440 | 425 |
| B-2 | 70 | 5 | 55 | 520 | 489 | 400 | 385 |
| B-3 | 80 | 1 | 68 | 545 | 530 | 460 | 445 |
| B-4 | 95 | 40 | 145 | 400 | 392 | 499 | 489 |
| B-5 | 92 | 63 | 192 | 395 | 387 | 486 | 475 |
| B-6 | 80 | 4 | 48 | 480 | 412 | 365 | 330 |

| | |
|---|---|
| Average | 60° C./95% |

| | Modulus of | Modulus of | Ratio of modulus | RH/24 hr | | |
|---|---|---|---|---|---|---|
| | elasticity at | elasticity at | of elasticity | moisture | | |
| Sample | 25° C./10% RH | 25° C./80% RH | (25° C. 10% RH/ | permeability | Average | |
| No. | (kgf/mm²) | (kgf/mm²) | 25° C. 80% RH) | (g/m²) | log P | Crystallinity |
| A-1 | 235 | 225 | 1.04 | 354 | 4.1 | — |
| A-2 | 257 | 240 | 1.07 | 489 | 3.8 | — |
| A-3 | 262 | 239 | 1.10 | 681 | 3.3 | — |
| A-4 | 228 | 230 | 0.99 | 240 | 4.3 | — |
| A-5 | 257 | 257 | 1.00 | 35 | 4.5 | — |
| B-1 | 445 | 428 | 1.04 | 1050 | — | 3400 |
| B-2 | 460 | 437 | 1.05 | 950 | — | 3400 |
| B-3 | 503 | 488 | 1.03 | 840 | — | 4700 |
| B-4 | 450 | 441 | 1.02 | 700 | — | 4100 |
| B-5 | 441 | 431 | 1.02 | 724 | — | 4900 |
| B-6 | 423 | 371 | 1.14 | 1350 | — | 2400 |

### (Preparation of Polarizing Plate)

### (Film Alkali Treatment)

Polarizing plate protective films A-1 to A-5 and B-1 to B-6 were immersed in a 2.3 N aqueous solution of sodium hydroxide at 55° C. for 2 min. They were washed in a water bath at room temperature, and neutralized using 0.1 N sulfuric acid at 30° C. They were washed again in a water bath at room temperature, and dried by hot blowing at 100° C.

### (Formation of Polarizer)

A 39 μm thick polyvinyl alcohol film having a degree of polymerization of 1,700 was swollen in a water bath at 30° C. and then stretched about 4 times in a dyeing bath at 30° C. containing an aqueous solution of iodine and potassium iodide. Subsequently, it was stretched by a total stretching ratio of 5.5 times in a crosslinking bath at 50° C. containing boric acid and potassium iodide, and crosslinked. This was immersed in a potassium iodide aqueous solution at 35° C. for 10 sec so as to adjust the hue. It was further washed with water and dried to give a 18 μm thick polarizer. The water content of this polarizer was 14%. The birefringence (Δn) at a wavelength of 900 nm was 0.0482, the transmittance was 43%, and the degree of polarization was 99.9%.

The birefringence was obtained by determining a retardation value (And) using a parallel Nicol rotation method using light at a wavelength of 900 nm, and dividing it by a thickness d (nm).

The transmittance was measured using a spectrophotometer (DOT-3, manufactured by Murakami Color Research Laboratory), and obtained as a value Y after luminosity correction by means of JIS Z8701 2 degree field of view (C light source).

The degree of polarization was determined from the equation below by measuring a transmittance (HO) when the same two polarizers were superimposed so that their polarization axes were parallel to each other and a transmittance (H90) for them perpendicular to each other in accordance with the above-mentioned measurement of transmittance. The transmittance (HO) and the perpendicular transmittance (H90) of polarized light were values Y, which were luminosity-corrected.

Degree of polarization(%)=[{(H0−H90)/(H0+H90)}×100]^{1/2}

### (Preparation of Adhesive)

A solution was prepared by dissolving 10 parts of polyester-based urethane (Takelac XW-74-C154, manufactured by Mitsui Takeda Chemicals, Inc.) and 1 part of an isocyanate-based crosslinking agent (Takenate WD-725, manufactured by Mitsui Takeda Chemicals, Inc.) in water to give a solids content of 20%. This was used as an adhesive.

### Preparation of Polarizing Plate 1

### Example 1

Both faces of the above-mentioned polarizer were coated with the above-mentioned adhesive solution, and the polarizing plate protective films A-1 and B-1 prepared above were laminated so as to sandwich the polarizer, dried, and cured in an oven at 40° C. for 72 hours to give a polarizing plate 1 having a total thickness of 178 μm. The transmittance of the polarizing plate thus obtained was 42%, and the degree of polarization was 99.9%.

### Preparation of Polarizing Plates 2 to 10

### Examples 2 to 8 and Comparative Examples 1 and 2

Polarizing plates 2 to 10 were prepared in the same manner as in Example 1 except that the combination of polarizing plate protective films was changed as shown in Table 2.

### (Measurement of Curl)

A polarizing plate was cut to 50 mm in the longitudinal direction and 2 mm in the width direction, conditioned under environments of 25° C. and 10% RH, 25° C. and 60% RH, and 25° C. and 80% RH for 24 hours, and a curl value of the polarizing plate was measured using a curvature scale. When the curl was convex toward the polarizing plate protective film 1 side, the curl was defined as being negative.

The results are given in Table 2.

### (Evaluation of Durability Under High Temperature and High Humidity)

The polarizing plate was aged at 60° C. and 95% RH for 1,000 hr, and a change in the degree of polarization between that before and that after the aging was measured.

TABLE 2

| | | | | | | | | Decrease in | |
|---|---|---|---|---|---|---|---|---|---|
| | | | | Sum of 60° | Difference in | | | degree of | |
| | | | | C./95% RH/24 | 60° C./95% | | | polarization | |
| | Polarizing | Polarizing | \|E1(10% RH)/ | hr moisture | RH/24 hr moisture | | | by aging at | |
| | plate | plate | E1(80% RH)- | permeability | permeability of | F type curl value | | 60° C. and | |
| | protective | protective | E2(10% RH)/ | of two protec- | two protective | | Δ(10% RH- | 95% RH for | |
| Sample No. | film 1 | film 2 | E2(80% RH)\| | tive films | films | 60% RH | 80% RH) | 1,000 hr (%) | Note |
| Polarizing | B-1 | A-1 | 0.00 | 1404 | 696 | 0.1 | 0 | −0.9 | This |
| plate1 | | | | | | | | | invention |
| Polarizing | B-2 | A-2 | 0.04 | 1439 | 461 | 0.3 | 0.4 | −1.0 | This |
| plate2 | | | | | | | | | invention |
| Polarizing | B-6 | A-3 | 0.02 | 2031 | 669 | −0.5 | 0.2 | −2.4 | This |
| plate3 | | | | | | | | | invention |
| Polarizing | B-4 | A-4 | 0.03 | 940 | 460 | −0.5 | 0.4 | −0.7 | This |
| plate4 | | | | | | | | | invention |
| Polarizing | B-5 | A-5 | 0.02 | 759 | 689 | −0.7 | 0.3 | −0.3 | This |
| plate5 | | | | | | | | | invention |
| Polarizing | B-3 | A-4 | 0.04 | 718 | 600 | −0.6 | 0.5 | −0.3 | This |
| plate6 | | | | | | | | | invention |
| Polarizing | B-6 | A-2 | 0.07 | 1839 | 861 | −0.4 | 0.7 | −2.0 | This |
| plate7 | | | | | | | | | invention |
| Polarizing | B-6 | A-1 | 0.10 | 1704 | 996 | −0.6 | 0.9 | −1.8 | This |
| plate8 | | | | | | | | | invention |
| Polarizing | B-6 | A-4 | 0.17 | 1590 | 1110 | −1.3 | 2.2 | −1.5 | Comparative |
| plate9 | | | | | | | | | Example |
| Polarizing | B-6 | A-5 | 0.19 | 1385 | 1315 | −1.6 | 3 | −1.0 | Comparative |
| plate10 | | | | | | | | | Example |

From the results in Table 2, it can be seen that the polarizing plate of the present invention has suppressed humidity dependence of curl, which is preferable. Moreover, from the results of the polarizing plate of the present invention in Table 2, when the sum of 60° C./95% RH/24 hr moisture permeabilities of the first protective film and the second protective film is at least 600 g/m² but no greater than 1,600 g/m², degradation of the polarization performance when stored under high temperature and high humidity is suppressed, which is preferable.

### Example 9

### Preparation and Evaluation of VA Liquid Crystal Display Device 1

1 wt % of octadecyldimethylammonium chloride (coupling agent) was added to a 3 wt % aqueous solution of polyvinyl alcohol. This was applied on top of an ITO electrode-equipped glass substrate by spin coating, thermally treated at 160° C., and then subjected to a rubbing treatment to give a vertically aligned film. The rubbing treatment was carried out so that the directions were opposite for two glass substrates. The two glass substrates faced each other across a cell gap (d) of 5 μm. A liquid crystal compound (Δn: 0.08) containing an ester system and an ethane system as main components was poured into the cell gap to give a vertically aligned liquid crystal cell. The product of Δn and d was 400 nm.

After the polarizing plate 2 prepared above was conditioned in advance under temperature and humidity conditions of 25° C. and 60% RH, it was wrapped in a bag that had been subjected to a moisture-proofing treatment and allowed to stand for 3 days. The bag was made of a wrapping material having a layer structure of polyethylene terephthalate/aluminum/polyethylene, and the moisture permeability was 1×10⁻⁵ g/m² Day or less.

The polarizing plate 2 was taken out under an environment of 25° C. and 60% RH, and by laminating it, using a pressure sensitive sheet, to both faces of the vertically aligned liquid crystal cell prepared above so that the polarizing plate protective film A-2 side was on the cell side, a liquid crystal display device 1 was prepared.

It can be seen that the liquid crystal display device employing the polarizing plate of the present invention did not cause display unevenness or light leakage even when continuously switched on under high humidity, which is preferable.

### Example 10

### Preparation and Evaluation of VA Liquid Crystal Display Device 2

A liquid crystal display device of FIG. 3 was prepared. That is, going from the viewing direction (top), an upper side polarizing plate, a VA mode liquid crystal cell (an upper substrate, a liquid crystal layer, a lower substrate), and a lower side polarizing plate were laminated, and a backlight light source was arranged. In an example below, a commercial polarizing plate (HLC2-5618) was used as the upper side polarizing plate, and the polarizing plate of the present invention was used as the lower side polarizing plate.

### <Preparation of Liquid Crystal Cell>

A liquid crystal cell was prepared by setting a cell gap between substrates at 3.6 μm, pouring dropwise a liquid crystal material (‘MLC6608’, manufactured by Merck) having a negative anisotropic permittivity between the substrates, and sealing so as to form a liquid crystal layer between the substrates. The retardation of the liquid crystal layer (that is, the product Δn·d of a thickness d (μm) and an anisotropic refractive index Δn of the liquid crystal layer) was 303 nm. The liquid crystal material was vertically aligned.

A commercial super high contrast product (HLC2-5618, manufactured by Sanritz Corporation) was laminated on the upper side polarizing plate of the liquid crystal display device (FIG. 3) employing the above-mentioned vertical alignment type liquid crystal cell, and one of the polarizing plates 5 prepared above was laminated on the lower side polarizing plate on each of the viewing side and the backlight side via a pressure sensitive adhesive so that the polarizing plate protective film A-5 was on the liquid crystal cell side. A liquid crystal display device 2 was prepared in a crossed Nicol configuration so that the transmission axis of the polarizing plate on the viewing side was in the vertical direction and the transmission axis of the polarizing plate on the backlight side was in the lateral direction.

It can be seen that the liquid crystal display device employing the polarizing plate of the present invention did not cause display unevenness or light leakage even when continuously switched on under high humidity, which is preferable.

1. A polarizing plate comprising a first protective film, a polarizer, and a second protective film laminated in that order,
an average of the modulus of elasticity in transport and width directions of the first protective film and an average of the modulus of elasticity in transport and width directions of the second protective film satisfying the relationship (A) below;

|E1(10%RH)/E1(80%RH)−E2(10%RH)/E2(80%RH)|≦0.1 (A)
wherein Ei (a % RH) denotes an average modulus of elasticity at a relative humidity a % RH of an (i)th protective film.

2. The polarizing plate according to claim 1, wherein the sum of 60° C./95% RH/24 hr moisture permeabilities of the first protective film and the second protective film is at least 600 g/m² but no greater than 1,600 g/m².

3. The polarizing plate according to claim 1, wherein the difference in 60° C./95% RH/24 hr moisture permeabilities between the first protective film and the second protective film is at least 0 g/m² but no greater than 1,000 g/m².

4. The polarizing plate according to claim 1, wherein at least one of the protective films is a cellulose acylate film.

5. The polarizing plate according to claim 1, wherein at least one of the protective films is a cycloolefin-based polymer film.

6. The polarizing plate according to claim 1, wherein an F type curl value at 25° C. and 60% RH is at least −1.0 but no greater than 1.0, and the difference between an F type curl value at 25° C. and 10% RH and an F type curl value at 25° C. and 80% RH is 2.0 or less.

7. A liquid crystal display device comprising a liquid crystal cell and two polarizing plates disposed on either side of the liquid crystal cell,
at least one polarizing plate being the polarizing plate according to claim 1.

8. The liquid crystal display device according to claim 7, wherein a protective film on the liquid crystal cell side relative to a polarizer is a cycloolefin-based polymer film, and a protective film on the side opposite to the liquid crystal cell relative to the polarizer is a cellulose acylate film.
